(19) United States
(12) Patent Application Publication
(10) Pub. No.: US 2015/0027306 A1
(43) Pub. Date: Jan. 29, 2015

(54) GAS-SELECTIVE POLYMER DERIVED CERAMIC MEMBRANES, GAS SEPARATION SYSTEMS, AND METHODS

(71) Applicant: Melior Innovations, Inc., Houston, TX (US)

(72) Inventors: Yi Tan, Houston, TX (US); Walter Sherwood, Glenville, NY (US); Andrew R. Hopkins, Houston, TX (US)

(21) Appl. No.: 14/514,257

(22) Filed: Oct. 14, 2014

Related U.S. Application Data
(63) Continuation-in-part of application No. 14/268,150, filed on May 2, 2014.
Application No. 14/268,150 is a continuation-in-part of application No. 14/212,896, filed on Mar. 14, 2014.
(60) Provisional application No. 61/890,808, filed on Oct. 14, 2013.
(60) Provisional application No. 61/946,598, filed on Feb. 28, 2014.
(60) Provisional application No. 61/818,906, filed on May 2, 2013.
(60) Provisional application No. 61/818,981, filed on May 3, 2013.
(60) Provisional application No. 61/788,632, filed on Mar. 15, 2013.

(51) Int. Cl. B01D 53/22; B01D 71/04; B01D 67/00

(52) U.S. Cl. CPC B01D 53/228; B01D 67/0067; B01D 71/04; B01D 2323/12; B01D 2323/06; B01D 2323/21; B01D 2325/02
USPC 95/55; 96/4

(57) ABSTRACT

There is provided polymer derived ceramic materials, to make porous polymeric derived ceramic membranes. These polymeric derived ceramic membranes are useful for separating gas and in particular for the generation of hydrogen. Hydrogen separation devices and power generation devices use the present polymeric derived ceramic membranes.

This application: (i) claims under 35 U.S.C. §119(e)(1) the benefit of the filing date of Oct. 14, 2013 of U.S. provisional application Ser. No. 61/890,808; (ii) claims under 35 U.S.C. §119(e)(1) the benefit of the filing date of Feb. 28, 2014 of U.S. provisional application Ser. No. 61/946,598; (iii) is a continuation in part of U.S. patent application Ser. No. 14/268,150 filed May 2, 2014, which claims, under 35 U.S.C. §119(e)(1), the benefit of the filing date of May 2, 2013 of U.S. provisional application Ser. No. 61/818,906 and the benefit of the filing date of May 3, 2013 of U.S. provisional application Ser. No. 61/818,981; and, (iv) is a continuation-in-part of U.S. patent application Ser. No. 14/212,896 filed Mar. 14, 2014, which claims under 35 U.S.C. §119(e)(1) the benefit of the filing date of Mar. 15, 2013 of U.S. provisional application Ser. No. 61/788,632, the entire disclosures of each of which are incorporated herein by reference.

### BACKGROUND OF THE INVENTION

### Field of the Invention

The present inventions relate to polyorganic compositions, methods, structures and materials; polymer derived preceramic and ceramic materials and methods; and in particular polysilocarb compositions, methods, structures and materials. The present inventions relate generally to gas separation technologies, and in particular polymer derived ceramic porous materials, such as membranes, screens and filter materials for gas separation, such as hydrogen separation and hydrogen-selective membranes. Polysilocarb materials and methods of making those materials are disclosed and taught in U.S. patent application Ser. Nos. 14/212,896, 14/324,056, 14/268,150 and 61/946,598, the entire disclosures of each of which are incorporated herein by reference.

Current hydrogen production methods are both energy intensive, and emit excessive carbon into the atmosphere. Thus, there is a long-standing need for hydrogen-separation membrane technologies to reduce the cost, and improve the efficiency of massive-scale hydrogen production.

Hydrogen is not only an important industrial feedstock for chemical, petrochemicals, metallurgical industries and fertilizers, but is also becoming a significant and strategic alternative clean-energy carrier to replace fossil fuels.

The Department of Energy has set the national goal for sustainable energy development and to reduce greenhouse gas emissions by 80% by 2050 and eliminate dependence on imported fuels. Thus, to meet this goal hydrogen will become a major alternative energy carrier. It is believed that hydrogen-selective membranes will play a crucial role in future hydrogen production. Desirable characteristics of hydrogen-separation membranes include high flux, operability at high pressures and temperatures, tolerance to chemicals, and low cost.

It is believed that current hydrogen separation technologies cannot meet these increased needs for hydrogen. These technologies are too expensive, unreliable and energy dependent. Polymeric membranes do not fit such requirements and do not meet the present or future needs for hydrogen production. Thus, for example, polymer membrane systems are susceptible to chemical damage, for example, from Hydrogen Sulfide (H₂S) and aromatics, as well as having a limited operational temperature range that restricts their applications. Inorganic membrane technologies, appear to suffer from several inherent weaknesses, such as, high cost, poor strength and hydrothermal stability. Further, it is believed that inorganic hydrogen-separation membranes still face significant barriers, which include high production cost, membrane structural integrity, hydrothermal stability, and membrane module development. High production cost: currently most progress is derived from efforts on Palladium (Pd) based, dense membranes that indicate promising hydrogen selectivity performance, some of which have entered pilot trials. However, in addition to embrittlement issues, the cost of Pd-based membranes is unlikely to decrease, rather it is likely that its costs will increase over time. As a rare resource, the supply of Palladium will become a bottleneck, and is unlikely to have the ability to support commercial expansion and deployment of Pd-based membranes. Membrane structural integrity: Inorganic membranes are typically formed on a ceramic substrate with a multi-layer structure. Defects often form on the membrane surface, body of each layer, or interfaces between the layers that create poor membrane quality, general weakness and decreased integrated strength, all of which prevent inorganic membranes from widespread adoption and application. Hydrothermal stability: the long-term stability and resistance of inorganic membranes to the corrosive nature of water vapor and other chemicals at high operation temperatures and pressures is lacking and unacceptable for commercial utilization. Membrane module development: conventional ceramic membranes, in general, are fragile and relatively intolerant to temperature and pressure shocks due to the inherent ceramic crystalline structure.

Thus, neither of these membrane technologies have or appear to be able to meet the current and anticipated needs of hydrogen production.

Though hydrogen can be produced by electrolysis of water using alternative energy sources such as nuclear, solar, geothermal, and/or hydraulic means, these are longer-term solutions not yet practical at large commercial scale. It is well known that hydrogen is currently produced most commonly via Water Gas Shift (WGS) reaction combined with either steam reformation of natural gas, or gasification of biomass or coal. A critical step in such processes is to separate and purify hydrogen from other gaseous mixtures, such as Carbon Dioxide, Nitrogen, Helium, Hydrogen Sulfide, hydrocarbon gases, or solid impurities such as tar, slag, ash, silt, etc. Current processes for hydrogen separation and purification are based on conventional chemical technologies, such as pre-separation to remove impurities like H₂S, liquids and solid particles. The gaseous mixture then passes through a series of cryogenic distillation columns (Cold Box, or Selexol) or pressure swing adsorption units (PSA), either of which is highly energy intensive and costly process.

The application of membranes for hydrogen separation and purification has the potential to allow for significantly decreased energy utilization (separation without phase change) and processing costs (moderate operation temperature and pressure range), giving it the potential to be an effective and competitive alternative energy solution; provided that a suitable membrane technology is developed that can meet the processing and operating requirements and conditions.

Thus, among other things, there is a long-standing need for a low-cost and robust porous material for hydrogen separation, with the ability to operate in a harsh processing environment. For example, the report Hydrogen Production Facilities Plant Performance and Cost Comparisons, Final Report March 2002 (DOE, National Energy Technology Laboratory), the entire disclosure of which is incorporated herein by reference, identifies inorganic membrane hydrogen separation devices and system. Such systems can be greatly improved, and it is believed may be made operable, and commercially viable, with the use of embodiments of the polymer derived ceramic membranes of the present inventions.

Materials made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O) are known. These general types of materials have great, but unrealized promise; and have failed to find large-scale applications or market acceptance. Instead, their use has been relegated to very narrow, limited, low volume, high priced and highly specific applications, such as a ceramic component in a rocket nozzle, or a patch for the space shuttle. Thus, they have failed to obtain wide spread use as ceramics, and it is believed they have obtained even less acceptance and use, if any, as a plastic material, e.g., cured but not pyrolized.

To a greater or lesser extent all of these materials and the process used to make them suffer from one or more failings, including for example: they are exceptionally expensive and difficult to make, having costs in the thousands and tens-of-thousands of dollars per pound; they require high and very high purity starting materials; the process in general fails to produce materials having high purity; the process requires hazardous organic solvents such as toluene, tetrahydrofuran (THF), and hexane; the materials are incapable of making non-reinforced structures having any usable strength; the process produces undesirable and hazardous byproducts, such as hydrochloric acid and sludge, which may contain magnesium; the process requires multiple solvent and reagent based reaction steps coupled with curing and pyrolizing steps; the materials are incapable of forming a useful prepreg; and their overall physical properties are mixed, e.g., good temperature properties but highly brittle.

As a result, although believed to have great promise, these types of materials have failed to find large-scale applications or market acceptance and have remained essentially scientific curiosities.

As used herein, unless stated otherwise, room temperature is 25° C. And, standard temperature and pressure is 25° C. and 1 atmosphere.

Generally, the term “about” as used herein unless specified otherwise is meant to encompass a variance or range of ±10%, the experimental or instrument error associated with obtaining the stated value, and preferably the larger of these.

### SUMMARY

There has been a long standing need for improved systems that can provide safe and effective gas separation technologies, porous media, and in particular, for hydrogen gas separation technologies, and low-cost and robust porous materials for hydrogen separation, with the ability to operate in harsh processing environments and conditions. The present inventions, among other things, solve these and other needs by providing the articles of manufacture, devices and processes taught herein.

Thus, there is provided herein a hydrogen separation device, the device having: a pressure vessel having a gas inlet and a gas outlet; the pressure vessel defining a chamber, in fluid communication with the gas inlet and gas outlet; and, the chamber containing a porous polymeric derived ceramic media.

Yet further there is provided systems, methods and devices having one or more of the following features: wherein, the porous polymeric derived ceramic media comprises a material resulting from the pyrolysis of a polymeric precursor having a backbone having the formula-R₁—Si—C—C—Si—O—Si—C—C—Si—R₂—, where R₁ and R₂ comprise materials selected from the group consisting of methyl, hydroxyl, vinyl and allyl; wherein, the porous polymeric derived ceramic media comprises a filler selected from the group consisting of metal powders, carbide pellets, nanostructures, silica fume, silica, fumed silica, fly ash, cenospheres, aluminum oxide (Al₂O₃), SiC, and polymer derived ceramics; wherein, the porous polymeric derived ceramic media is made from a polysilocarb batch having a precursor selected from the group consisting of methyl hydrogen, siloxane backbone additive, vinyl substituted and vinyl terminated polydimethyl siloxane, vinyl substituted and hydrogen terminated polydimethyl siloxane, allyl terminated polydimethyl siloxane, silanol terminated polydimethyl siloxane, hydrogen terminated polydimethyl siloxane, vinyl terminated diphenyl dimethyl polysiloxane, hydroxyl terminated diphenyl dimethyl polysiloxane, hydride terminated diphenyl dimethyl polysiloxane, styrene vinyl benzene dimethyl polysiloxane, and tetramethyltetravinylcyclotetrasiloxane; wherein, the porous polymeric derived ceramic media is made from a condensation reaction of functionalized monomers; and, wherein the functionalized monomers are selected from the group consisting of triethoxy methyl, diethoxy methyl phenyl silane, diethoxy methyl hydride silane, diethoxy methyl vinyl silane, dimethyl ethoxy vinyl silane, diethoxy dimethyl silane, ethoxy dimethyl phenyl silane, diethoxy dihydride silane, triethoxy phenyl silane, diethoxy hydride trimethyl siloxane, diethoxy methyl trimethyl siloxane, trimethyl ethoxy silane, diphenyl diethoxy silane, and dimethyl ethoxy hydride siloxane.

Still further there is provided systems, methods and devices having one or more of the following features: wherein, the porous polymer derived ceramic media is made from a precursor having a means for creating a porosity; wherein, the means for creating a porosity comprises a precursor having a material having functional groups selected from the group consisting of methyl, vinyl, hydride, and OH substitution, whereby the functional group at least in part determines a porosity characteristic of the media; wherein, the means for creating a porosity comprises a gas generation means; wherein, the means for creating a porosity comprises a gas generation means, whereby a gas selected from the group consisting water vapor, methane, and ethane is generated during a curing process; wherein, the means for creating a porosity comprises a gas generation means, whereby a vaporized organic is generated during a curing process; and wherein, the means for creating a porosity comprises a gas generation means, whereby a vaporized organic is generated during a pyrolysis process.

Additionally, there is provided systems, methods and devices having one or more of the following features: wherein, the means for creating a porosity comprises a gas generation means, whereby a vaporized organic is generated during a curing and pyrolysis processes; wherein, the means for creating a porosity comprises a material for the generation of a gas, whereby a vaporized organic selected from the group consisting of polyethylene, polypropylene, and acrylic is generated during a curing process; and, wherein, the means for creating a porosity comprises a material for the generation of a gas, whereby a vaporized organic selected from the group consisting of polyethylene, polypropylene, and acrylic is generated during a pyrolysis process.

Now further there is provided systems, methods and devices having one or more of the following features: wherein, the means for creating a porosity comprises a high carbon content polymer, whereby regions of graphite are oxidized away to create small pores; wherein the regions of graphite are less than about 10 nanometers³; wherein the regions of graphite are less than about 5 nanometers³; wherein the regions of graphite are less than about 1 nanometers³; wherein the high carbon content polymer is made from a material having a substitutional group selected from the group consisting of phenyl groups, allyl groups, acetylene groups, ethynyl groups, and propargyl groups; and, wherein the high carbon content polymer contains is made from a material selected from the group consisting of styrene, dicyclopentadiene, butatiene, chlorsilanes, ethoxy silanes and silicon containing reactive precursors.

Moreover, there is provided a porous polymeric derived ceramic material having a ceramized polymer derived from a precursor, and having an open pour structure having a pour size of less than about 1 nanometer.

Still further there is provided a porous polymeric derived ceramic material having a ceramized polymer derived from a precursor, and having an open pour structure having a pour size of less than about 0.5 nanometers.

Furthermore, there is provided a porous polymeric derived ceramic material having a ceramized polymer derived from a precursor, and having an open pour structure having a pour size of less than about 0.4 nanometers.

Yet further there is provided a porous polymeric derived ceramic material having a ceramized polymer derived from a precursor, and having an open pour structure having a pour size of less than about 0.3 nanometers.

In addition there is provided a porous polymeric derived ceramic material having a ceramized polymer derived from a precursor, and having an open pour structure having a pour size of less than about 0.33 nanometers.

Still further, there is provided porous polymeric derived ceramic materials of claims wherein the material is hydrogen selective.

Yet additionally, there is provided porous polymeric derived ceramic materials of wherein the material is nitrogen selective.

Furthermore, there is provided porous polymeric derived ceramic materials of wherein the material is carbon dioxide selective.

Moreover, there is provided a porous polymeric derived ceramic material having a ceramized polymer derived from a precursor, and having an open pour structure having a pour size of less than about 1 nanometer and the ceramized polymer comprises a material resulting from the pyrolysis of a polymeric precursor having a backbone having the formula-R₁—Si—C—C—Si—O—Si—C—C—Si—R₂—, where R₁ and R₂ comprise materials selected from the group consisting of methyl, hydroxyl, vinyl and allyl.

Still further there is provided systems, methods and devices having one or more of the following features: wherein the pour size of less than about 0.8 nanometer; wherein the pour size is less than about 0.5 nanometers; wherein the pour size is less than about 0.4 nanometers; wherein the pour size is less than about 0.3 nanometers; wherein the pour size is less than about 0.33 nanometers; wherein material is hydrogen selective; wherein material, is nitrogen selective; and wherein material is carbon dioxide selective.

Additionally there is provided systems, methods and devices having one or more of the following features: means for creating porosity, wherein the means is present before pyrolysis and absent after pyrolysis; means for creating porosity, wherein the means is present before pyrolysis and after pyrolysis; wherein the precursor comprises the means for creating a porosity; wherein the means for creating a porosity comprises a precursor having a material having functional groups selected from the group consisting of methyl, vinyl, hydride, and OH substitution, whereby the functional group at least in part determines a porosity characteristic of the media; and wherein the means for creating a porosity comprises a gas generation means.

Still further there is provided systems, methods and devices having one or more of the following features: wherein the means for creating a porosity comprises a high carbon content polymer, whereby regions of graphite are oxidized away to create small pores; wherein wherein the regions are less than about 10 nanometers³; wherein the regions are less than about 5 nanometers³; wherein the regions are less than about 1 nanometers³; wherein the regions are less than about 0.5 nanometers³; wherein the regions are less than about 0.3 nanometers³; and, wherein the regions are less than about 0.2 nanometers³.

Yet further there is provided a porous polymeric derived ceramic material wherein the high carbon content polymer is made from a material having a substitutional group selected from the group consisting of phenyl groups, allyl groups, acetylene groups, ethynyl groups, and propargyl groups.

Yet still further there is provided a porous polymeric derived ceramic material wherein the high carbon content polymer contains is made from a material selected from the group consisting of styrene, dicyclopentadiene, butatiene, chlorsilanes, ethoxy silanes and silicon containing reactive precursors.

Moreover there is provided a porous polymeric derived ceramic material having a ceramized polymer derived from a precursor, and having an open pour structure having a pour size of less than about 0.5 nanometers and wherein the precursor is selected from the group consisting of methyl hydrogen, siloxane backbone additive, vinyl substituted and vinyl terminated polydimethyl siloxane, vinyl substituted and hydrogen terminated polydimethyl siloxane, allyl terminated polydimethyl siloxane, silanol terminated polydimethyl siloxane, hydrogen terminated polydimethyl siloxane, vinyl terminated diphenyl dimethyl polysiloxane, hydroxyl terminated diphenyl dimethyl polysiloxane, hydride terminated diphenyl dimethyl polysiloxane, styrene vinyl benzene dimethyl polysiloxane, and tetramethyltetravinylcyclotetrasiloxane.

Still further there is provided a porous polymeric derived ceramic material having a ceramized polymer derived from a precursor, and having an open pour structure having a pour size of less than about 0.5 nanometers and the precursor having a material having the formula:

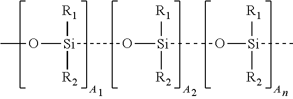

wherein A₁, is about 0% to about 100% of the total chain, wherein A₂ is about 0% to about 100% of the total chain, and wherein Aₙ is about 0% to about 100% of the total chain, and wherein n is an integer from 0 to 15, and wherein A₁, A₂ and Aₙ, and Aₙ₊₁ are different structures, and wherein R₁ and R₂ are selected from the group consisting of triethoxy methyl, diethoxy methyl phenyl silane, diethoxy methyl hydride silane, diethoxy methyl vinyl silane, dimethyl ethoxy vinyl silane, diethoxy dimethyl silane, ethoxy dimethyl phenyl silane, diethoxy dihydride silane, triethoxy phenyl silane, diethoxy hydride trimethyl siloxane, diethoxy methyl trimethyl siloxane, trimethyl ethoxy silane, diphenyl diethoxy silane, and dimethyl ethoxy hydride siloxane.

Still further there is provided systems, methods and devices having one or more of the following features: wherein the gas separation temperature is at least about 500° C.; wherein the temperature is at least about 600° C.; wherein the temperature is at least about 700° C.; wherein the temperature is at least about 800° C.; wherein the pressure is at least about 500 psi; wherein the pressure is at least about 600 psi; wherein the pressure is at least about 800 psi; wherein the pressure is at least about 1000 psi; wherein the flux is at least about 200 scft/ft² h; wherein the flux is at least about 200 scft/ft² h; wherein the flux is at least about 150 scft/ft² h; wherein the flux is at least about 100 scft/ft² h; wherein the flux is at least about 300 scft/ft² h; and wherein the flux is at least about 400 scft/ft² h.

Still further there is provided a method of separating a hydrogen gas from a mixture of gases, the method having passing the mixture for gases at an inlet temperature and at an inlet pressure through a hydrogen separation device.

### BRIEF DESCRIPTION OF THE DRAWINGS

FIG. 1 is a schematic flow diagram of an embodiment of a hydrogen separation Device (HSD) in accordance with the present invention.

FIG. 2 is a flow diagram of an embodiment of a hydrogen separation system in accordance with the present invention.

FIG. 3 is a detailed schematic of the system of FIG. 2.

FIG. 4 is a flow diagram of an embodiment of a hydrogen separation system in accordance with the present invention.

FIG. 5 is a detailed schematic of the system of FIG. 4.

FIG. 6 is a flow diagram of an embodiment of a hydrogen separation system in accordance with the present invention.

FIG. 7 is a detailed schematic of the system of FIG. 6.

FIG. 8 is a flow diagram of an embodiment of a hydrogen separation system in accordance with the present invention.

FIG. 9 is a detailed schematic of the system of FIG. 8.

FIG. 10 is a chemical formula for an embodiment of a methyl terminated hydride substituted polysiloxane precursor material in accordance with the present inventions.

FIG. 11 is a chemical formula for an embodiment of a methyl terminated vinyl polysiloxane precursor material in accordance with the present inventions.

FIG. 12 is a chemical formula for an embodiment of a vinyl terminated vinyl polysiloxane precursor material in accordance with the present inventions.

FIG. 13 is a chemical formula for an embodiment of a hydride terminated vinyl polysiloxane precursor material in accordance with the present inventions.

FIG. 14 is a chemical formula for an embodiment of an allyl terminated dimethyl polysiloxane precursor material in accordance with the present inventions.

FIG. 15 is a chemical formula for an embodiment of a vinyl terminated dimethyl polysiloxane precursor material in accordance with the present inventions.

FIG. 16 is a chemical formula for an embodiment of a hydroxy terminated dimethyl polysiloxane precursor material in accordance with the present inventions.

FIG. 17 is a chemical formula for an embodiment of a hydride terminated dimethyl polysiloxane precursor material in accordance with the present inventions.

FIG. 18 is a chemical formula for an embodiment of a hydroxy terminated vinyl polysiloxane precursor material in accordance with the present inventions.

FIG. 19 is a chemical formula for an embodiment of a phenyl terminated polysiloxane precursor material in accordance with the present inventions.

FIG. 20 is a chemical formula for an embodiment of a phenyl and methyl terminated polysiloxane precursor material in accordance with the present inventions.

FIG. 21 is a chemical formula for an embodiment of a methyl terminated dimethyl diphenyl polysiloxane precursor material in accordance with the present inventions.

FIG. 22 is a chemical formula for an embodiment of a vinyl terminated dimethyl diphenyl polysiloxane precursor material in accordance with the present inventions.

FIG. 23 is a chemical formula for an embodiment of a hydroxy terminated dimethyl diphenyl polysiloxane precursor material in accordance with the present inventions.

FIG. 24 is a chemical formula for an embodiment of a hydride terminated dimethyl diphenyl polysiloxane precursor material in accordance with the present inventions.

FIG. 25 is a chemical formula for an embodiment of a methyl terminated phenylethyl polysiloxane precursor material in accordance with the present inventions.

FIG. 26 is a chemical formula for an embodiment of a tetravinyl cyclosiloxane in accordance with the present inventions.

FIG. 27 is chemical formula for an embodiment of a trivinyl cyclosiloxane in accordance with the present inventions.

FIG. 28 is a chemical formula for an embodiment of a divinyl cyclosiloxane in accordance with the present inventions.

FIG. 29 is a chemical formula for an embodiment of a trivinyl hydride cyclosiloxane in accordance with the present inventions.

FIG. 30 is a chemical formula for an embodiment of a divinyl dihydride cyclosiloxane in accordance with the present inventions.

FIG. 31 is a chemical formula for an embodiment of a dihydride cyclosiloxane in accordance with the present inventions.

FIG. 32 is a chemical formula for an embodiment of a dihydride cyclosiloxane in accordance with the present inventions.

FIG. 33 is a chemical formula for an embodiment of a silane in accordance with the present inventions.

FIG. 34 is a chemical formula for an embodiment of a silane in accordance with the present inventions.

FIG. 35 is a chemical formula for an embodiment of a silane in accordance with the present inventions.

FIG. 36 is a chemical formula for an embodiment of a silane in accordance with the present inventions.

FIG. 37 is a chemical formula for an embodiment of a methyl terminated dimethyl ethyl methyl phenyl silyl silane polysiloxane precursor material in accordance with the present inventions.

FIG. 38 is chemical formulas for an embodiment of a polysiloxane precursor material in accordance with the present inventions.

FIG. 39 is chemical formulas for an embodiment of a polysiloxane precursor material in accordance with the present inventions.

FIG. 40 is chemical formulas for an embodiment of a polysiloxane precursor material in accordance with the present inventions.

FIG. 41 is a chemical formula for an embodiment of an ethyl methyl phenyl silyl-cyclosiloxane in accordance with the present inventions.

FIG. 42 is a chemical formula for an embodiment of a cyclosiloxane in accordance with the present inventions.

FIG. 43 is a chemical formula for an embodiment of a siloxane precursor in accordance with the present inventions.

FIGS. 43A to 43D are chemical formula for embodiments of the E₁ and E₂ groups in the formula of FIG. 43.

FIG. 44 is a chemical formula for an embodiment of an orthosilicate in accordance with the present inventions.

FIG. 45 is a chemical formula for an embodiment of a polysiloxane in accordance with the present inventions.

FIG. 46 is a chemical formula for an embodiment of a triethoxy methyl silane in accordance with the present inventions.

FIG. 47 is a chemical formula for an embodiment of a diethoxy methyl phenyl silane in accordance with the present inventions.

FIG. 48 is a chemical formula for an embodiment of a diethoxy methyl hydride silane in accordance with the present inventions.

FIG. 49 is a chemical formula for an embodiment of a diethoxy methyl vinyl silane in accordance with the present inventions.

FIG. 50 is a chemical formula for an embodiment of a dimethyl ethoxy vinyl silane in accordance with the present inventions.

FIG. 51 is a chemical formula for an embodiment of a diethoxy dimethyl silane in accordance with the present inventions.

FIG. 52 is a chemical formula for an embodiment of an ethoxy dimethyl phenyl silane in accordance with the present inventions.

FIG. 53 is a chemical formula for an embodiment of a diethoxy dihydride silane in accordance with the present inventions.

FIG. 54 is a chemical formula for an embodiment of a triethoxy phenyl silane in accordance with the present inventions.

FIG. 55 is a chemical formula for an embodiment of a diethoxy hydride trimethyl siloxane in accordance with the present inventions.

FIG. 56 is a chemical formula for an embodiment of a diethoxy methyl trimethyl siloxane in accordance with the present inventions.

FIG. 57 is a chemical formula for an embodiment of a trimethyl ethoxy silane in accordance with the present inventions.

FIG. 58 is a chemical formula for an embodiment of a diphenyl diethoxy silane in accordance with the present inventions.

FIG. 59 is a chemical formula for an embodiment of a dimethyl ethoxy hydride siloxane in accordance with the present invention.

FIGS. 60A to 60F are chemical formulas for starting materials in accordance with the present inventions.

FIG. 61 is a cross sectional schematic view of an embodiment of a membrane configuration in accordance with the present inventions.

### DESCRIPTION OF THE PREFERRED EMBODIMENTS

In general, the present inventions relate to gas separation technologies that utilize porous materials in one or more steps or process of the gas separation technology; and, in particular, the present inventions relate to polymer derived ceramic porous media, including membranes and filters, and the gas separation technologies that utilize them. More particularly, and by way of example, the present inventions relate to polymer derived ceramic formations, nanoporous membranes, and hydrogen selective membranes and processes, devices and systems utilizing these.

Although the present specification focuses primarily on hydrogen gas separation and membranes, the porous media technologies of the present inventions should not be so limited, and find broad applications in, for example: CO₂ separation membranes; CO₂ capture and removal from syngas; natural gas processing, and more preferably without strict pretreatment requirements; hydrocarbon gases separation in harsh processing environments, such as refineries, petrochemical processes, as well as oil & gas exploration and production sites; membrane dehydration of biofuels processing; and, for pervaporation in desalination applications.

The polymer derived ceramic formulations and processes for membranes provide nanoporous structures having good and preferably superior properties such as, high hydrothermal stability, high strength, high porosity and a predictable and narrow pore distribution. The ability to customize and control the process for forming polymer derived ceramic membranes provides for very uniform membranes and porous coatings, essentially defect-free membranes and porous coating, and preferably defect-free membranes and porous coatings. This ability to customize and control the formation process preferably leads to nanoporous membranes that are hydrogen selective.

Polymer derived ceramic membranes may have pours sized from about 0.1 nanometers to about 2 millimeters, from about 0.2 nanometers to about 0.5 nanometers, less than about 100 nanometers, and less than about 50 nanometers, less than about 1 nanometer, less than about 0.3 nanometer, and other larger and smaller pour sizes are contemplated. The pour size distribution for a particular membrane, membrane system, or unit may be about less than 2%, less than about 5% and less than about 10% of the intended pour size. The pour size distribution may be about less than 5 nanometers, about less than 10 nanometers and about less than 20 nanometers.

The polymer derived ceramic porous media may be used as a coating or otherwise as a part of an existing ceramic, metal, inorganic membrane or system. In this manner the failings of the existing membranes or system, may be overcome or otherwise enhanced by the polymer derived ceramic porous media. Thus, for example, a mesoporous membrane substrate (from either polymer derived ceramic material, or other material) may have a coating of the polymer derived ceramic nanoporous membrane precursor applied onto this substrate to form a single material asymmetric membrane, which may be a composite or an integral structure. Such steps will enhance and preferably significantly enhance the substrate membrane's strength, thermal stability and allowable flux.

Embodiments of the present nanoporous membrane technology, will not only provide for hydrogen separation membranes, but also enable the ability to develop, among other things, robust CO₂ separation membranes for CO₂ capture and removal from syngas, and natural gas processing (without strict pretreatment requirements). Embodiments of such a membrane technology can be applied to current and newly developed hydrocarbon gases separation in harsh processing environments, such as refineries, petrochemical processes, as well as oil & gas exploration and production sites. Embodiments of this membrane technology are also applicable for membrane dehydration of biofuels processing, and even for pervaporation in desalination applications.

The present polymer derived ceramic membranes can be utilized in for example large scale membrane and membrane reactor applications, nanoporous ceramics will allow for the maximization of pore surface area, while well-controlled pore structure and hydrothermal stable materials formation processes will enable the development of low-cost membrane module/sealing/potting materials, for use in high-temperature, high-pressure, corrosive and embrittlement operating conditions, especially, for example, in high-purity hydrogen production.

Polymer derived ceramic (PDC) membranes have for example the ability to be formulated to provide the advantages of, for example, high chemical purity, homogeneous element distribution, low sintering temperatures, and the absence of sintering additives, and combinations and various of these and other advantages. In addition, PDCs enable complex-shaping methods to produce ceramic fibers, coatings, membranes, and bulk components in relatively easy manner. Following this route, ceramic materials, such as amorphous SiOC, SiCN, SiBCN, SiC etc., can be synthesized by properly formulated precursors and through pyrolysis in relatively low temperature ranges from 900 to 1300° C., which is not possible for a conventional ceramic synthesis.

For example, PDC synthesis generally involves three steps: a specially designed formulation with composition and process methodology is used for preparation of PDCs precursor; the precursor is formed in a desired shape in a specific programmed curing (polymerization) process in a temperature range of about 100 to 300° C., the cured solid component is further passed through a pyrolysis process in either an inert, or specific gas environment at a temperature range up to 1300° C. For example, and depending upon the particular formulation, in the pyrolysis temperature range from 400 to 800° C., the component will experience a polymer-to-ceramic phase transformation or ceramization process, which involves thermolysis and volatilization of organic fragments, such as CH₄, silanes, and H₂, and then finally forms a desired amorphous ceramic. The evolution of gases during ceramization leads to generation of pores in the ceramic matrix. Through specifically designed formulation of precursor and specifically programmed pyrolysis conditions (heating ramps, pressure ramps and specific gaseous environment), a porous ceramic component with a predetermined and controlled pore structure will be developed, providing for the formation of nanoporous membranes.

An embodiment of the present process to make polymer derived ceramic materials for gas separation membranes preferably have well-controlled pore size and distribution ranges, which can be based upon the precursor preparation, the membrane formation process, and other factors. The present polymer derived ceramic membranes meet one of challenges for gas separation by addressing the small differences of kinetic diameters of mixed gases in a feed stream, for example, diameters of common gas components include, but are not limited to: He—0.26 nm, H₂—0.289 nm, O₂—0.346 nm, N₂—0.364 nm, CO—0.376 nm, CO₂—0.33 nm, CH₄—0.38 nm, C₃H₆—0.45 nm, H₂O—0.265 nm, H₂S—0.36 nm. Any deviation in pore size distribution, or micro-cracks generated in the membrane separation layer during formation will lead to a significant drop in permselectivity, which can be avoided by the present processes and formulations for polymer derived ceramic membranes.

Embodiments of the present polymer derived ceramics have the ability to form a strong and high-porosity membrane layer that will preferably provide a membrane that is able to withstand high temperatures and pressures, as well as, provide a high flux and reduced process pressure drop to enhance membrane process efficiency and economic performance. Thus, for example there are provided high integrity multi-layer membranes that resist, essentially prevent and prevent any cracking or peel-off in high-thermal and pressure shock operation environments.

Membrane permselectivity, in general, can be described by following equation:

□_{□□}=(D_{A}·S_{A})/(D_{B}·S_{B})

Where □_{□□} is defined as membrane separation factor of gas A to gas B; D_{A} and D_{B} are diffusion coefficients of gas A and B; the ratio of (D_{A}/D_{B}) can be viewed as the mobility selectivity, which indicates the relative motion of individual gas molecules of components A and B inside the pores; the mobility selectivity is proportional to the ratio of the molecular size of the two permeates. S_{A} and S_{B} are sorption coefficients of gas A and B; the ratio of (S_{A}/S_{B}) indicates the relative concentration of components A and B inside pores, and it is correlated to the membrane material, gas molecule properties, membrane pore surface properties, morphology and operation conditions. In general, it can be described as:

S=S₀e^{-ΔH}^{_{S}}^{/RT}

Where, ΔHs is the enthalpy of sorption of the gas on the inner surface of the pores. The sorption coefficient of gas is a measurement of the energy required for the gas to be sorbed by the material and correlated to material and gas properties, as well process conditions. For nanoporous membranes, the separation mechanisms mainly involve surface diffusion, capillary condensation, and activated diffusion. But in most cases, it follows hybrid mechanism. For surface and capillary diffusion, separation generally increases as the condensability increases; while the gas condensability depends on its molecule structure and properties, also affected by process temperatures and pressures. For activated diffusion, it will relate to material interface properties, pore morphology, as well as operation conditions. By adjusting process conditions, the permselectivity of membranes to certain gases can preferrably be optimized.

In general, embodiments of the present inventions relate to the porous media, such as membranes, membrane packs, porous coatings, filters, mesh and the like, that are made from precursors to preceramic materials, inorganic polymers, inorganic semi-organic polymers, mixtures of such precursors, preceramic materials, cured preceramic materials, cured mixtures of precursors, cured inorganic polymers, cured inorganic semi-organic polymers, ceramic materials, and methods and processes for making these precursors, inorganic polymers, inorganic semi-organic polymers, mixtures, preceramic materials, cured materials and ceramic materials. In particular, and preferably, the present inventions include polymer derived ceramic membrane materials, polymer derived cured preceramic membrane materials and methods and processes relating to these materials.

Preferably, embodiments of the present inventions use, or are based in whole or in part upon, “polysilocarb” materials, e.g., material containing silicon (Si), oxygen (O) and carbon (C). Polysilocarb materials may also contain other elements. Polysilocarb materials are made from one or more polysilocarb precursor formulation or precursor formulation. The polysilocarb precursor formulation contains one or more functionalized silicon polymers, or monomers, as well as, potentially other ingredients, such as for example, inhibitors, catalysts, initiators, modifiers, dopants, and combinations and variations of these and other materials and additives. Silicon oxycarbide materials, or SiOC compositions and similar terms, unless specifically stated otherwise, refer to polysilocarb materials that have been cured into a plastic, or solid material containing Si, O and C, and polysilocarb materials that have been pyrolized into a ceramic material containing Si, O and C.

Typically, and preferably, the polysilocarb precursor formulation is initially a liquid. This liquid polysilocarb precursor formulation is then cured to form a solid or semi-sold material, e.g., a plastic. The polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon its intended use and purpose. For example, in some situations the end cure and the hard cure may be the same.

The curing may be done at standard ambient temperature and pressure (“SATP”, 1 atmosphere, 25° C.), at temperatures above or below that temperature, at pressures above or below that pressure, and over varying time periods (both continuous and cycled, e.g., heating followed by cooling and reheating), from less than a minute, to minutes, to hours, to days (or potentially longer), and in air, in liquid, or in a preselected atmosphere, e.g., Argon (Ar) or nitrogen (N₂).

The polysilocarb precursor formulations can be made into non-reinforced, non-filled, composite, reinforced, and filled structures, intermediates and end products, and combinations and variations of these and other types of materials. Further, these structures, intermediates and end products can be cured (e.g., green cured, end cured, or hard cured), uncured, pyrolized to a ceramic, and combinations and variations of these (e.g., a cured material may be filled with pyrolized beads derived from the same polysilocarb as the cured material).

The precursor formulations may be used to form a “neat” material, (by “neat” material it is meant that all, and essentially all of the structure is made from the precursor material or unfilled formulation; and thus, there are no fillers or reinforcements). They may be used to form composite materials, e.g., reinforced products. They may be used to form non-reinforced materials, which are materials that are made of primarily, essentially, and preferably only from the precursor materials, for example a pigmented polysiloxane structure having only precursor material and a colorant would be considered non-reinforced material.

In making the polysilocarb precursor formulation into a structure, part, intermediate, or end product, the polysilocarb formulation can be, for example, sprayed, flowed, polymer emulsion processed, thermal sprayed, painted, molded, formed, extruded, spun, dropped, injected or otherwise manipulated into essentially any volumetric shape, including planer shape (which still has a volume, but is more akin to a coating, skin, film, or even a counter top, where the thickness is significantly smaller, if not orders of magnitude smaller, than the other dimensions), and combinations and variations of these.

The polysilocarb precursor formulations may be used with reinforcing materials to form a composite material. Thus, for example, the formulation may be flowed into, impregnated into, absorbed by or otherwise combined with a reinforcing material, such as carbon fibers, glass fiber, woven fabric, non-woven fabric, copped fibers, metal powdered, metal foams, ceramic foams, fibers, rope, braided structures, ceramic powders, glass powders, carbon powders, graphite powders, ceramic fibers, metal powders, carbide pellets or components, staple fibers, tow, nanostructures of the above, polymer derived ceramics, any other material that meets the temperature requirements of the process and end product, and combinations and variations of these. Thus, for example, the reinforcing materials may be any of the high temperature resistant reinforcing materials currently used, or capable of being used with, existing plastics and ceramic composite materials. Additionally, because the polysilocarb precursor formulation may be formulated for a lower temperature cure (e.g., SATP) or a cure temperature of for example about 100° F. to about 400° F., the reinforcing material may be polymers, organic polymers, such as nylons, polypropylene, and polyethylene, as well as aramid fibers, such as NOMEX or KEVLAR.

The reinforcing material may also be made from, or derived from the same material as the formulation that has been formed into a fiber and pyrolized into a ceramic, or it may be made from a different precursor formulation material, which has been formed into a fiber and pyrolized into a ceramic. In addition to ceramic fibers derived from the precursor formulation materials that may be used as reinforcing material, other porous, substantially porous, and non-porous ceramic structures derived from a precursor formulation material may be used.

The polysilocarb precursor formulation may be used to form a filled material. A filled material would be any material having other solid, or semi-solid, materials added to the polysilocarb precursor formulation. The filler material may be selected to provide certain features to the cured product, the ceramic product or both. These features may relate to or be aesthetic, tactile, thermal, density, radiation, chemical, magnetic, electric, and combinations and variations of these and other features. These features may be in addition to strength. Thus, the filler material may not affect the strength of the cured or ceramic material, it may add strength, or could even reduce strength in some situations.

The filler material could impart, regulate or enhance, for example, electrical resistance, magnetic capabilities, band gap features, p-n junction features, p-type features, n-type features, dopants, electrical conductivity, semiconductor features, anti-static, optical properties (e.g., reflectivity, refractivity and iridescence), chemical resistivity, corrosion resistance, wear resistance, abrasions resistance, thermal insulation, UV stability, UV protective, and other features that may be desirable, necessary, and both, in the end product or material.

Thus, filler materials could include copper lead wires, thermal conductive fillers, electrically conductive fillers, lead, optical fibers, ceramic colorants, pigments, oxides, dyes, powders, ceramic fines, polymer derived ceramic particles, pore-formers, carbosilanes, silanes, silazanes, silicon carbide, carbosilazanes, siloxane, metal powders, ceramic powders, metals, metal complexes, carbon, tow, fibers, staple fibers, boron containing materials, milled fibers, glass, glass fiber, fiber glass, and nanostructures (including nanostructures of the forgoing) to name a few. For example, crushed, polymer derived ceramic particles, e.g., fines or beads, can be added to a polysilocarb formulation and then cured to form a filled cured plastic material, which has significant fire resistant properties as a coating or structural material.

The polysilocarb formulation and products derived or made from that formulation may have metals and metal complexes. Thus, metals as oxides, carbides or silicides can be introduced into precursor formulations, and thus into a silica matrix in a controlled fashion. Thus, using organometallic, metal halide (chloride, bromide, iodide), metal alkoxide and metal amide compounds of transition metals and then copolymerizing in the silica matrix, through incorporation into a precursor formulation is contemplated.

For example, Cyclopentadienyl compounds of the transition metals can be utilized. Cyclopentadienyl compounds of the transition metals can be organized into two classes: Bis-cyclopentadienyl complexes; and Mono-cyclopentadienyl complexes. Cyclopentadienyl complexes can include C₅H₅, C₅Me₅, C₅H₄Me, CH₅R₅ (where R=Me, Et, Propyl, i-Propyl, butyl, Isobutyl, Sec-butyl). In either of these cases Si can be directly bonded to the Cyclopentadienyl ligand or the Si center can be attached to an alkyl chain, which in turn is attached to the Cyclopentadienyl ligand.

Cyclopentadienyl complexes, that can be utilized with precursor formulations and in products, can include: bis-cyclopentadienyl metal complexes of first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum); Lanthanide series (La, Ce, Pr, Nd, Pm, Sm, Eu, Gd, Tb, Dy, Ho); Actinide series (Ac, Th, Pa, U, Np).

Monocyclopentadienyl complexes may also be utilized to provide metal functionality to precursor formulations and would include monocyclopentadienyl complexes of: first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum) when preferably stabilized with proper ligands, (for instance Chloride or Carbonyl).

Alky complexes of metals may also be used to provide metal functionality to precursor formulations and products. In these alkyl complexes the Si center has an alkyl group (ethyl, propyl, butyl, vinyl, propenyl, butenyl) which can bond to transition metal direct through a sigma bond. Further, this would be more common with later transition metals such as Pd, Rh, Pt, Ir.

Coordination complexes of metals may also be used to provide metal functionality to precursor formulations and products. In these coordination complexes the Si center has an unsaturated alkyl group (vinyl, propenyl, butenyl, acetylene, butadienyl) which can bond to carbonyl complexes or ene complexes of Cr, Mo, W, Mn, Re, Fe, Ru, Os, Co, Rh, Ir, Ni. The Si center may also be attached to a phenyl, substituted phenyl or other aryl compound (pyridine, pyrimidine) and the phenyl or aryl group can displace carbonyls on the metal centers.

Metal alkoxides may also be used to provide metal functionality to precursor formulations and products. Metal alkoxide compounds can be mixed with the Silicon precursor compounds and then treated with water to form the oxides at the same time as the polymer, copolymerize. This can also be done with metal halides and metal amides. Preferably, this may be done using early transition metals along with Aluminum, Gallium and Indium, later transition metals: Fe, Mn, Cu, and alkaline earth metals: Ca, Sr, Ba, Mg.

Compounds where Si is directly bonded to a metal center which is stabilized by halide or organic groups may also be utilized to provide metal functionality to precursor formulations and products.

Additionally, it should be understood that the metal and metal complexes may be the continuous phase after pyrolysis, or subsequent heat treatment. Formulations can be specifically designed to react with selected metals to in situ form metal carbides, oxides and other metal compounds, generally known as cermets (e.g., ceramic metallic compounds). The formulations can be reacted with selected metals to form in situ compounds such as mullite, alumino silicate, and others. The amount of metal relative to the amount of silica in the formulation or end product can be from about 0.1 mole % to 99.9 mole %, about 1 mole % or greater, about 10 mole % or greater, about 20 mole percent or greater % and greater. The forgoing use of metals with the present precursor formulas can be used to control and provide predetermined stoichiometries.

The polysilocarb batch may also be used a binder in composite structures, such as a binder for metal, ceramic, and inorganic matrices.

Filled materials would include reinforced materials. In many cases, cured, as well as pyrolized polysilocarb filled materials can be viewed as composite materials. Generally, under this view, the polysilocarb would constitute the bulk or matrix phase, (e.g., a continuous, or substantially continuous phase), and the filler would constitute the dispersed (e.g., non-continuous), phase.

It should be noted, however, that by referring to a material as “filled” or “reinforced” it does not imply that the majority (either by weight, volume, or both) of that material is the polysilcocarb. Thus, generally, the ratio (either weight or volume) of polysilocarb to filler material could be from about 0.1:99.9 to 99.9:0.1. Smaller amounts of filler material or polysilocarb could also be present or utilized, but would more typically be viewed as an additive or referred to in other manners. Thus, the terms composite, filled material, polysilocarb filled materials, reinforced materials, polysilocarb reinforced materials, polysilocarb filled materials, polysilocarb reinforced materials and similar such terms should be viewed as non-limiting as to amounts and ratios of the material's constitutes, and thus in this context, be given their broadest possible meaning.

Depending upon the particular application, product or end use, the filler can be evenly distributed in the precursor formulation, unevenly distributed, a predetermined rate of settling, and can have different amounts in different formulations, which can then be formed into a product having a predetermined amounts of filler in predetermined areas, e.g., striated layers having different filler concentration.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

At various points during the manufacturing process, the polysilocarb structures, intermediates and end products, and combinations and variations of these, may be machined, milled, molded, shaped, drilled or otherwise mechanically processed and shaped.

The precursor formulations are preferably clear or are essentially colorless and generally transmissive to light in the visible wavelengths. They may, depending upon the formulation have a turbid, milky or clouding appearance. They may also have color bodies, pigments or colorants, as well as color filler (which can survive pyrolysis, for ceramic end products, such as those used in ceramic pottery glazes). The precursor may also have a yellow or amber color or tint, without the need of the addition of a colorant.

The precursor formulations may be packaged, shipped and stored for later use in forming products, e.g., structures or parts, or they may be used directly in these processes, e.g., continuous process to make a product. Thus, a precursor formulation may be stored in 55 gallon drums, tank trucks, rail tack cars, onsite storage tanks having the capable of holding hundreds of gals, and shipping totes holding 1,000 liters, by way of example. Additionally, in manufacturing process the formulations may be made and used in a continuous, and semi-continuous processes.

The present formulations, among other things, provide substantial flexibility in designing processes, systems, ceramics, having processing properties and end product performance features to meet predetermined and specific performance criteria. Thus, for example the viscosity of the precursor formulation may be predetermined by the formulation to match a particular morphology of the reinforcing material, the cure temperature of the precursor formulation may be predetermined by the formulation to enable a prepreg to have an extended shelf life. The viscosity of the of the precursor formulation may be established so that the precursor readily flows into the reinforcing material of the prepreg while at the same time being thick enough to prevent the precursor formulation from draining or running off of the reinforcing material. The formulation of the precursor formulation may also, for example, be such that the strength of a cured preform is sufficient to allow rough or initial machining of the preform, prior to pyrolysis.

Custom and predetermined control of when chemical reactions occur in the various stages of the process from raw material to final end product can provide for reduced costs, increased process control, increased reliability, increased efficiency, enhanced product features, increased purity, and combinations and variation of these and other benefits. The sequencing of when chemical reactions take place can be based primarily upon the processing or making of precursors, and the processing or making of precursor formulations; and may also be based upon cure and pyrolysis conditions. Further, the custom and predetermined selection of these steps, formulations and conditions, can provide enhanced product and processing features through chemical reactions, molecular arrangements and rearrangements, and microstructure arrangements and rearrangements, that preferably have been predetermined and controlled.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

Generally, the process form making the polysilocarb materials involves one or more steps. The starting materials are obtained, made or derived. Precursors are obtained or can be made from starting materials. The precursors are combined to form a precursor formulation. The precursor formulation is then shaped, dropped, extruded, sprayed, formed, molded, etc. into a desired form, which form is then cured, which among other things transforms the precursor formulation into a plastic like material. This cured plastic like material can then be pyrolized into a ceramic. It being understood, that these steps may not all be used, that some of these steps may be repeated, once, twice or several times, and that combinations and variations of these general steps may be utilized to obtain a desired product or result.

Generally, an embodiment of the manufacture of embodiments of small structures, fibers, bead like structures and particles, of polysilocarb derived SiOC and SiC a polysilocarb batch is formed into a preform. Depending upon the viscosity and other characteristics of the polysilocarb batch, and the intended shape, the preform may be made by techniques such as extruding, molding, drawing, spinning, dripping, spraying, vibrating, solution polymerization, polymer emulsion, emulsion polymerization, including micro-emulsion polymerization, capable of making a substantial range of sizes, e.g., from about 10 mesh to about 400 mesh, from about 20 mesh to about 200 mesh, from about 500 microns and less, from about 50 microns and less, from about 10 microns, from about less than 1, and less, and other techniques known to the arts to create small structures of a predetermined shape, and preferably in large volumes, preferably that are highly uniform and more preferably both. Further it is understood, that although it is presently preferred that the preform and the polysilocarb derived SiC and SiOC fibers, beads or particles be their approximate desired use size and shape upon cure, or prior to pyrolysis, the polysilocarb batch can be cured into a puck like structure, e.g., roughly the size and shape of a hockey puck, a brick like structure or other larger volumetric shape. This larger shape can be cured, hard cured, and pyrolized, and broken down into smaller sizes (preferably after pyrolysis). This process of later breaking down, typically, although not necessarily, results in a polysilocarb derived SiC and SiOC beads or particles that are not of uniform or consistent shape, size and both. These volumetric shapes, such as particles, fibers, etc. may than be combined, bound or formed into member structures, and filters, which for example a polysilocarb precursor being used as the binder.

General Processes for Obtaining a Polysilocarb Precursor

Polysilocarb precursor formulations can generally be made using two types of processes, although other processes and variations of these types of processes may be utilized. These processes generally involve combining precursors to form a polysilocarb precursor formulation. One type of process generally involves the mixing together of precursor materials in preferably a solvent free process with essentially no chemical reactions taking place, e.g., “the mixing process.” The other type of process generally involves chemical reactions to form specific, e.g., custom, polysilocarb precursor formulations, which could be monomers, dimers, trimers and polymers. Generally, in the mixing process essentially all, and preferably all, of the chemical reactions take place during subsequent processing, such as during curing, pyrolysis and both. It should be understood that these terms—reaction type process and the mixing type process—are used for convenience, e.g., a short hand reference, and should not be viewed as limiting. Further, it should be understood that combinations and variations of these two processes may be used in reaching a precursor formulation, and in reaching intermediate, end and final products. Depending upon the specific process and desired features of the product the precursors and starting materials for one process type can be used in the other. These processes provide great flexibility to create custom features for intermediate, end and final products, and thus, typically, either process type, and combinations of them, can provide a specific predetermined product. In selecting which type of process is preferable factors such as cost, controllability, shelf life, scale up, manufacturing ease, etc., can be considered.

The two process types are described in this specification, among other places, under their respective headings. It should be understood that the teachings for one process, under one heading, and the teachings for the other process, under the other heading, can be applicable to each other, as well as, being applicable to other sections and teachings in this specification, and vice versa. The starting or precursor materials for one type of process may be used in the other type of process. Further, it should be understood that the processes described under these headings should be read in context with the entirely of this specification, including the various examples.

Additionally, the formulations from the mixing type process may be used as a precursor, or component in the reaction type process. Similarly, a formulation from the reaction type process may be used in the mixing type process. Thus, and preferably, the optimum performance and features from either process can be combined and utilized to provide a cost effective and efficient process and end product.

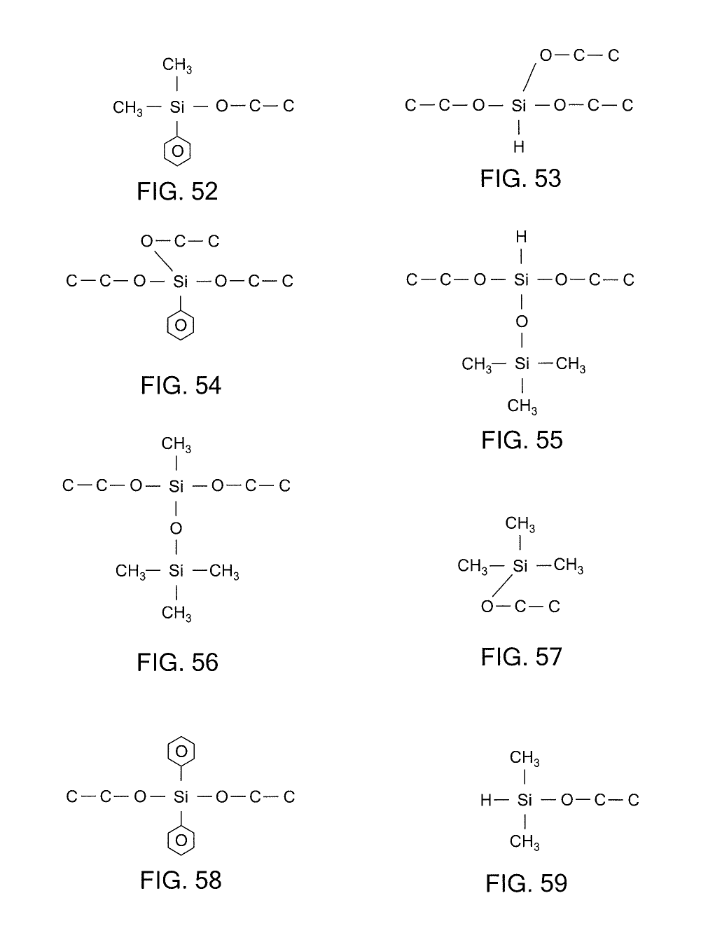

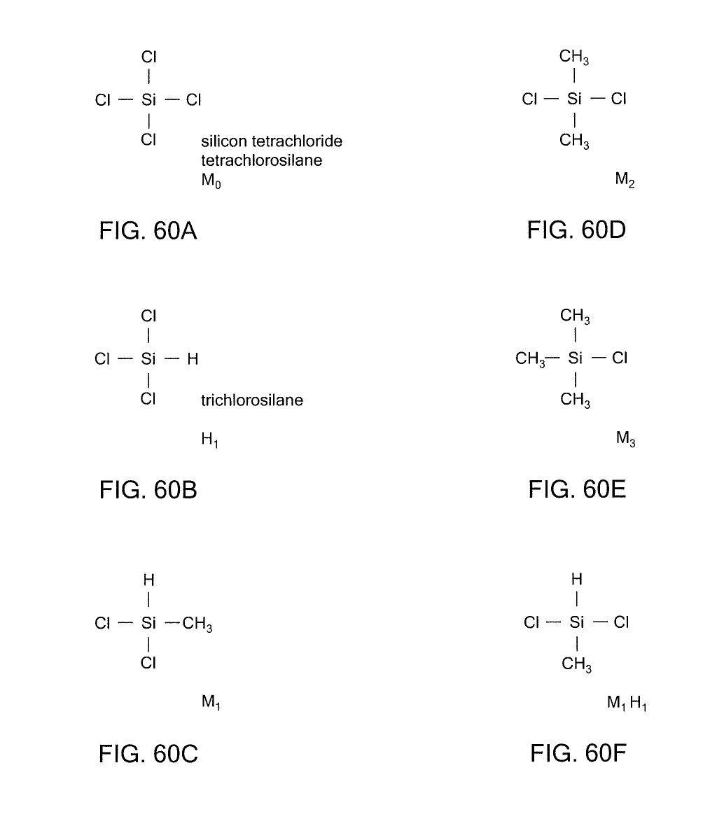

In addition to being commercially available the precursors may be made by way of an alkoxylation type, e.g., ethoxylation process. In this process chlorosilanes are reacted with ethanol in the presences of a catalysis, e.g., HCl, to provide the precursor materials, which materials may further be reacted to provide longer chain precursors. Other alcohols, e.g., Methanol may also be used. Thus, the compounds the formulas of FIGS. 60A to 60F are reacted with ethanol (C—C—OH) to form the precursors of FIGS. 46-59. In some of these reactions phenols may be the source of the phenyl group, which is substitute for a hydride group that has been placed on the silicon. One, two or more step reaction may need to take place.

The Mixing Type Process

Precursor materials may be methyl hydrogen, and substituted and modified methyl hydrogens, siloxane backbone additives, reactive monomers, reaction products of a siloxane backbone additive with a silane modifier or an organic modifier, and other similar types of materials, such as silane based materials, silazane based materials, carbosilane based materials, phenol/formaldehyde based materials, and combinations and variations of these. The precursors are preferably liquids at room temperature, although they may be solids that are melted, or that are soluble in one of the other precursors. (In this situation, however, it should be understood that when one precursor dissolves another, it is nevertheless not considered to be a “solvent” as that term is used with respect to the prior art processes that employ non-constituent solvents, e.g., solvents that do not form a part or component of the end product, are treated as waste products, and both.)

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or other time period, prior to being cured.

The precursors can be mixed under numerous types of atmospheres and conditions, e.g., air, inert, N₂, Argon, reduced pressure, elevated pressure, and combinations and variations of these. Preferably for making polysilocarb derived SiC the precursors can be mixed at about 1 atmosphere, in cleaned air.

Additionally, inhibitors such as cyclohexane, 1-Ethynyl-1-cyclohexanol (which may be obtained from ALDRICH), Octamethylcyclotetrasiloxane, tetramethyltetravinylcyclotetrasiloxane (which may act, depending upon amount and temperature as a reactant or a reactant retardant (i.e., slows down a reaction to increase pot life), e.g., at room temperature it is a retardant and at elevated temperatures it is a reactant), may be added to the polysilocarb precursor formulation, e.g., an inhibited polysilocarb precursor formulation. Other materials, as well, may be added to the polysilocarb precursor formulation, e.g., a filled polysilocarb precursor formulation, at this point in processing, including fillers such as SiC powder, polymer derived ceramic particles, pigments, particles, nano-tubes, whiskers, or other materials, discussed in this specification or otherwise known to the arts. Further, a formulation with both inhibitors and fillers would be considered an inhibited, filled polysilocarb precursor formulation.

Depending upon the particular precursors and their relative amounts in the polysilocarb precursor formulation, polysilocarb precursor formulations may have shelf lives at room temperature of greater than 12 hours, greater than 1 day, greater than 1 week, greater than 1 month, and for years or more. These precursor formulations may have shelf lives at high temperatures, for example, at about 90° F., of greater than 12 hours, greater than 1 day, greater than 1 week, greater than 1 month, and for years or more. The use of inhibitors may further extend the shelf life in time, for higher temperatures, and combinations and variations of these. As used herein the term “shelf life” should be given its broadest possible meaning unless specified otherwise, and would include the formulation being capable of being used for its intended purpose, or performing, e.g., functioning, for its intended use, at 100% percent as well as a freshly made formulation, at least about 90% as well as a freshly made formulation, at least about 80% as well as a freshly made formulation, and at about 70% as well as a freshly made formulation.

Precursors and precursor formulations are preferably non-hazardous materials. They have flash points that are preferably above about 70° C., above about 80° C., above about 100° C. and above about 300° C., and above. They may be noncorrosive. They may have as low vapor pressure, may have low or no odor, and may be non- or mildly irritating to the skin.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a preform.

The time period where the precursor formulation remains useful for curing after the catalysis is added is referred to as “pot life”, e.g., how long can the catalyzed formulation remain in its holding vessel before it should be used. Depending upon the particular formulation, whether an inhibitor is being used, and if so the amount being used, storage conditions, e.g., temperature, and potentially other factors, precursor formulations can have pot lives, for example of from about 5 minutes to about 10 days, about 1 day to about 6 days, about 4 to 5 days, about 1 hour to about 24 hours, and about 12 hours to about 24 hours.

The catalysis can be any platinum (Pt) based catalyst, which can for example be diluted to a range from: 1 part per million Pt to 200 parts per million (ppm) and preferably in the 5 ppm to 50 ppm range. It can be a peroxide based catalyst with a 10 hour half life above 90 C at a concentration of between 0.5% and 2%. It can be an organic based peroxide. It can be any organometallic catalyst capable of reacting with Si—H bond, Si—OH bonds, or unsaturated carbon bonds, these catalyst may include: dibutyltin dilaurate, zinc octoate, peroxides, and titanium organometallic compounds. Combinations and variations of these and other catalysts may be used. Such catalysts may be obtained from ARKEMA under the trade name LUPEROX, e.g., LUPEROX 231.

Further, custom and specific combinations of these and other catalysts may be used, such that they are matched to specific formulation formulations, and in this way selectively and specifically catalyze the reaction of specific constituents. Custom and specific combinations of catalysts may be used, such that they are matched to specific formulation formulations, and in this way selectively and specifically catalyze the reaction of specific constituents at specific temperatures. Moreover, the use of these types of matched catalyst-formulations systems may be used to provide predetermined product features, such as for example, pore structures, porosity, densities, density profiles, and other morphologies of cured structures and ceramics.

In this mixing type process for making a precursor formulation, preferably chemical reactions or molecular rearrangements only take place during the making of the precursors, the curing process of the preform, and in the pyrolizing process. Thus, chemical reactions, e.g., polymerizations, reductions, condensations, substitutions, take place or are utilized in the making of a precursor. In making a polysilocarb precursor formulation preferably no and essentially no, chemical reactions and molecular rearrangements take place. These embodiments of the present mixing type process, which avoid the need to, and do not, utilize a polymerization or other reaction during the making of a precursor formulation, provides significant advantages over prior methods of making polymer derived ceramics. Preferably, in the embodiments of these mixing type of formulations and processes, polymerization, crosslinking or other chemical reactions take place primarily, preferably essentially, and more preferably solely in the preform during the curing process.

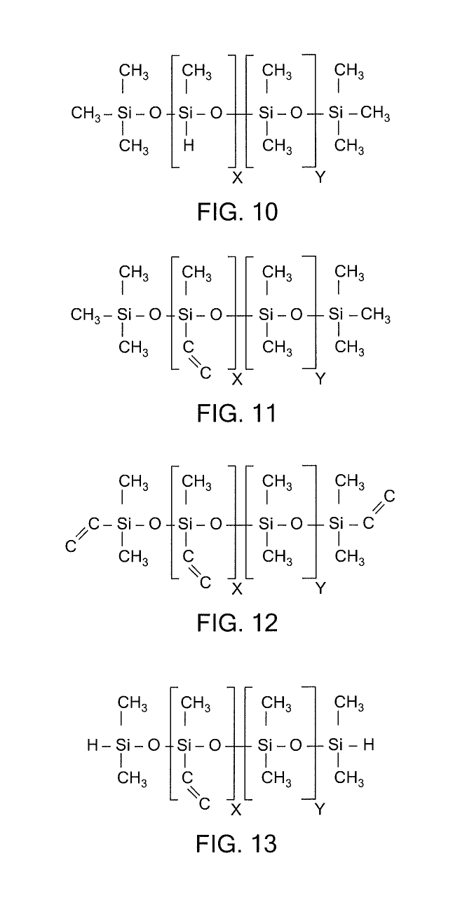

The precursor may be methyl hydrogen (MH), which formula is shown in FIG. 10. The MH may have a molecular weight (“mw” which can be measured as weight averaged molecular weight in amu or as g/mol) may be from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. Typically, methyl hydrogen fluid (MHF) has minimal amounts of “Y”, and more preferably “Y” is for all practical purposes zero.

The precursor may be a siloxane backbone additive, such as vinyl substituted polydimethyl siloxane, which formula is shown in FIG. 11. This precursor may have a molecular weight (mw) may be from about 400 mw to about 10,000 mw, and may have a viscosity preferably from about 50 cps to about 2,000 cps. The percentage of methylvinylsiloxane units “X” may be from 1% to 100%. The percentage of the dimethylsiloxane units “Y” may be from 0% to 99%. Preferably, X is 100%. This precursor may be used to decrease cross-link density and improve toughness, as well as, other features and characteristics to the cured preform and ceramic material.

The precursor may be a siloxane backbone additive, such as vinyl substituted and vinyl terminated polydimethyl siloxane, which formula is shown in FIG. 12. This precursor may have a molecular weight (mw) may be from about 500 mw to about 15,000 mw, and may preferably have a molecular weight from about 500 mw to 1,000 mw, and may have a viscosity preferably from about 10 cps to about 200 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be a siloxane backbone additive, such as vinyl substituted and hydrogen terminated polydimethyl siloxane, which formula is shown in FIG. 13. This precursor may have a molecular weight (mw) may be from about 300 mw to about 10,000 mw, and may preferably have a molecular weight from about 400 mw to 800 mw, and may have a viscosity preferably from about 20 cps to about 300 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

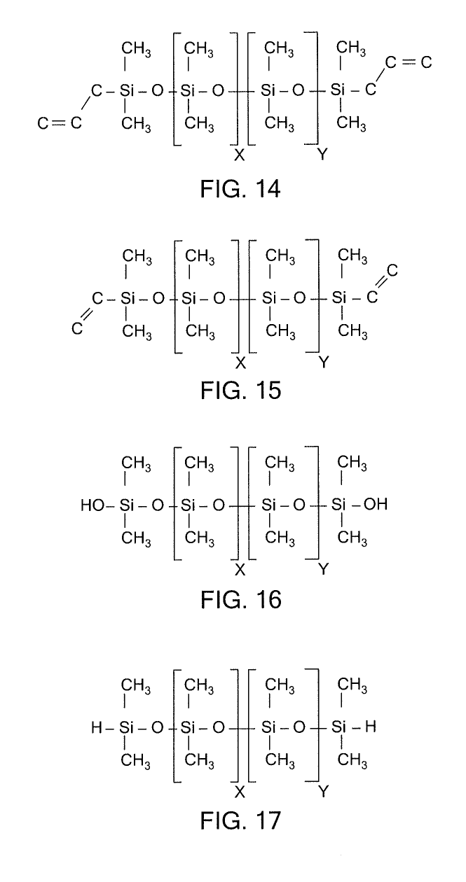

The precursor may be a siloxane backbone additive, such as allyl terminated polydimethyl siloxane, which formula is shown in FIG. 14. This precursor may have a molecular weight (mw) may be from about 400 mw to about 10,000 mw, and may have a viscosity preferably from about 40 cps to about 400 cps. The repeating units are the same. This precursor may be used to provide UV curability and to extend the polymeric chain, as well as, other features and characteristics to the cured preform and ceramic material.

The precursor may be a siloxane backbone additive, such as vinyl terminated polydimethyl siloxane, which formula is shown in FIG. 15. This precursor may have a molecular weight (mw) may be from about 200 mw to about 5,000 mw, and may preferably have a molecular weight from about 400 mw to 1,500 mw, and may have a viscosity preferably from about 10 cps to about 400 cps. The repeating units are the same. This precursor may be used to provide a polymeric chain extender, improve toughness and to lower cure temperature down to for example room temperature curing, as well as, other features and characteristics to the cured preform and ceramic material.

The precursor may be a siloxane backbone additive, such as silanol (hydroxy) terminated polydimethyl siloxane, which formula is shown in FIG. 16. This precursor may have a molecular weight (mw) may be from about 400 mw to about 10,000 mw, and may preferably have a molecular weight from about 600 mw to 1,000 mw, and may have a viscosity preferably from about 30 cps to about 400 cps. The repeating units are the same. This precursor may be used to provide a polymeric chain extender, a toughening mechanism, can generate nano- and micro-scale porosity, and allows curing at room temperature, as well as other features and characteristics to the cured preform and ceramic material.

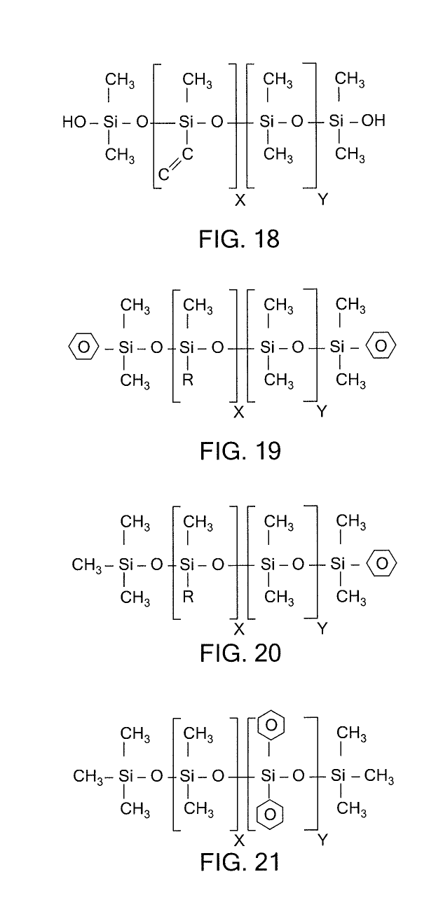

The precursor may be a siloxane backbone additive, such as silanol (hydroxy) terminated vinyl substituted dimethyl siloxane, which formula is shown in FIG. 18. This precursor may have a molecular weight (mw) may be from about 400 mw to about 10,000 mw, and may preferably have a molecular weight from about 600 mw to 1,000 mw, and may have a viscosity preferably from about 30 cps to about 400 cps. The percentage of methylvinylsiloxane units “X” may be from 1% to 100%. The percentage of the dimethylsiloxane units “Y” may be from 0% to 99%.

The precursor may be a siloxane backbone additive, such as hydrogen (hydride) terminated polydimethyl siloxane, which formula is shown in FIG. 17. This precursor may have a molecular weight (mw) may be from about 200 mw to about 10,000 mw, and may preferably have a molecular weight from about 500 mw to 1,500 mw, and may have a viscosity preferably from about 20 cps to about 400 cps. The repeating units are the same. This precursor may be used to provide a polymeric chain extender, as a toughening agent, and it allows lower temperature curing, e.g., room temperature, as well as, other features and characteristics to the cured preform and ceramic material.

The precursor may be a siloxane backbone additive, such as phenyl terminated siloxane, which formula is shown in FIG. 19, where R is a reactive group, such as vinyl, hydroxy, or hydride. This precursor may have a molecular weight (mw) may be from about 500 mw to about 2,000 mw, and may have a viscosity preferably from about 80 cps to about 300 cps. The repeating units are the same. This precursor may be used to provide a toughening agent, and to adjust the refractive index of the polymer to match the refractive index of various types of glass, to provide for example transparent fiberglass, as well as, other features and characteristics to the cured preform and ceramic material.

The precursor may be a siloxane backbone additive, such as methyl-phenyl terminated siloxane, which formula is shown in 20, where R is a reactive group, such as vinyl, hydroxy, or hydride. This precursor may have a molecular weight (mw) may be from about 500 mw to about 2,000 mw, and may have a viscosity preferably from about 80 cps to about 300 cps. The repeating units are the same. This precursor may be used to provide a toughening agent and to adjust the refractive index of the polymer to match the refractive index of various types of glass, to provide for example transparent fiberglass, as well as, other features and characteristics to the cured preform and ceramic material.

The precursor may be a siloxane backbone additive, such as diphenyl dimethyl polysiloxane, which formula is shown in FIG. 21. This precursor may have a molecular weight (mw) may be from about 500 mw to about 20,000 mw, and may have a molecular weight from about 800 to about 4,000, and may have a viscosity preferably from about 100 cps to about 800 cps. The percentage of dimethylsiloxane units “X” may be from 25% to 95%. The percentage of the diphenyl siloxane units “Y” may be from 5% to 75%. This precursor may be used to provide similar characteristics to the precursor of FIG. 20, as well as, other features and characteristics to the cured preform and ceramic material.

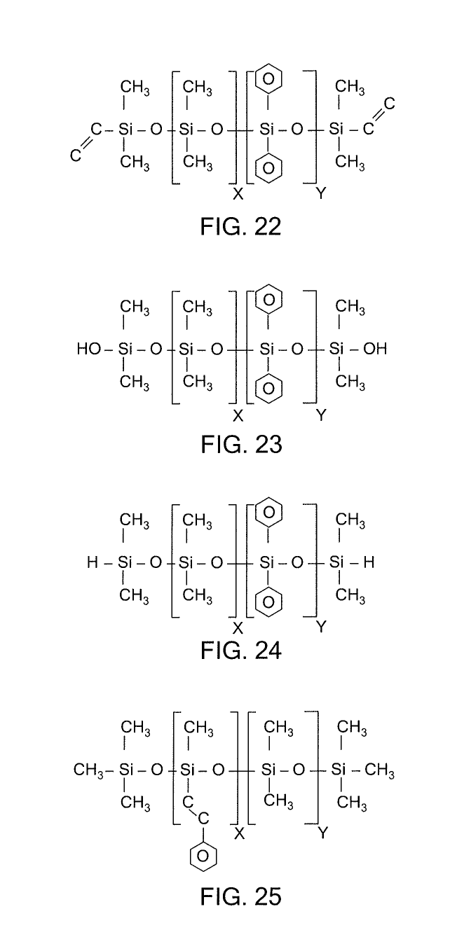

The precursor may be a siloxane backbone additive, such as vinyl terminated diphenyl dimethyl polysiloxane, which formula is shown in FIG. 22. This precursor may have a molecular weight (mw) may be from about 400 mw to about 20,000 mw, and may have a molecular weight from about 800 to about 2,000, and may have a viscosity preferably from about 80 cps to about 600 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, as well as, other features and characteristics to the cured preform and ceramic material.

The precursor may be a siloxane backbone additive, such as hydroxy terminated diphenyl dimethyl polysiloxane, which formula is shown in FIG. 23. This precursor may have a molecular weight (mw) may be from about 400 mw to about 20,000 mw, and may have a molecular weight from about 800 to about 2,000, and may have a viscosity preferably from about 80 cps to about 400 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, can generate nano- and micro-scale porosity, as well as other features and characteristics to the cured preform and ceramic material.

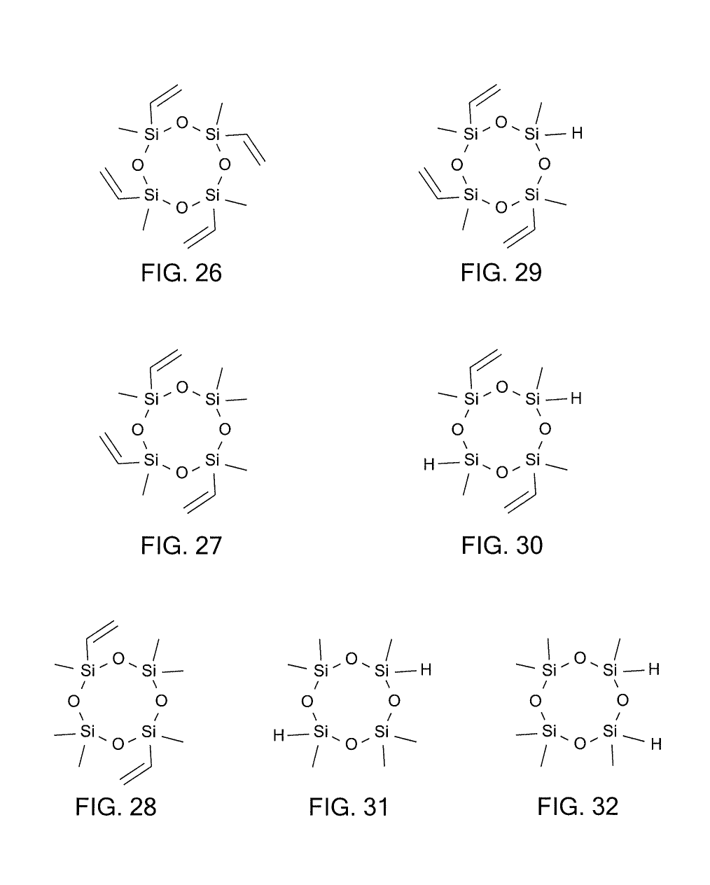

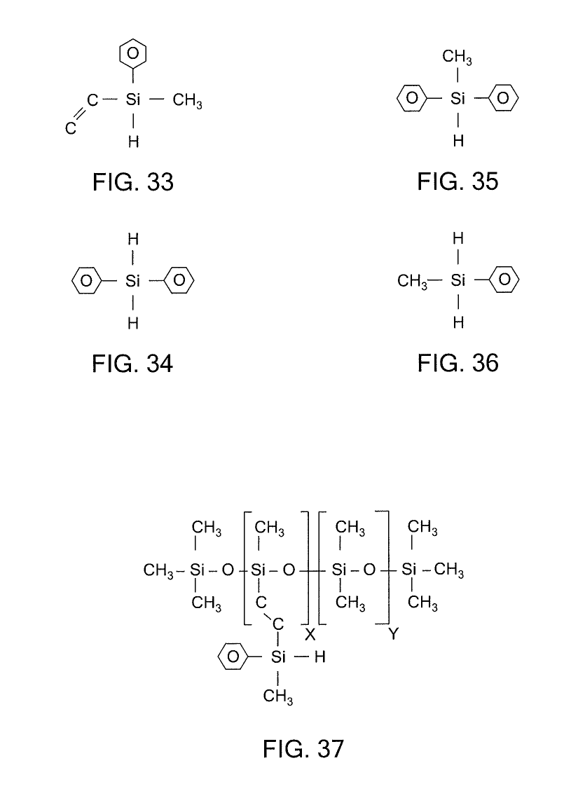

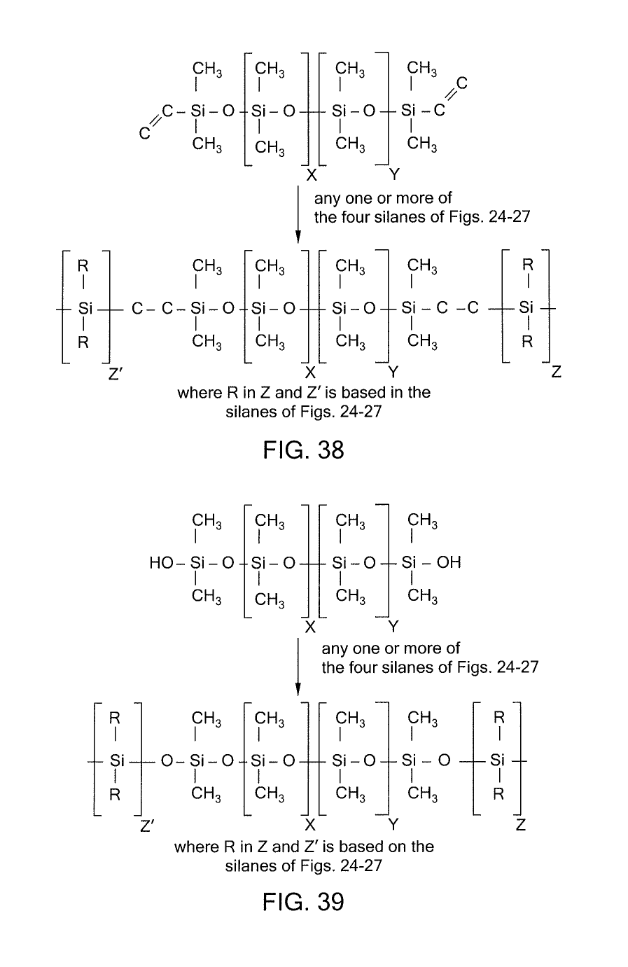

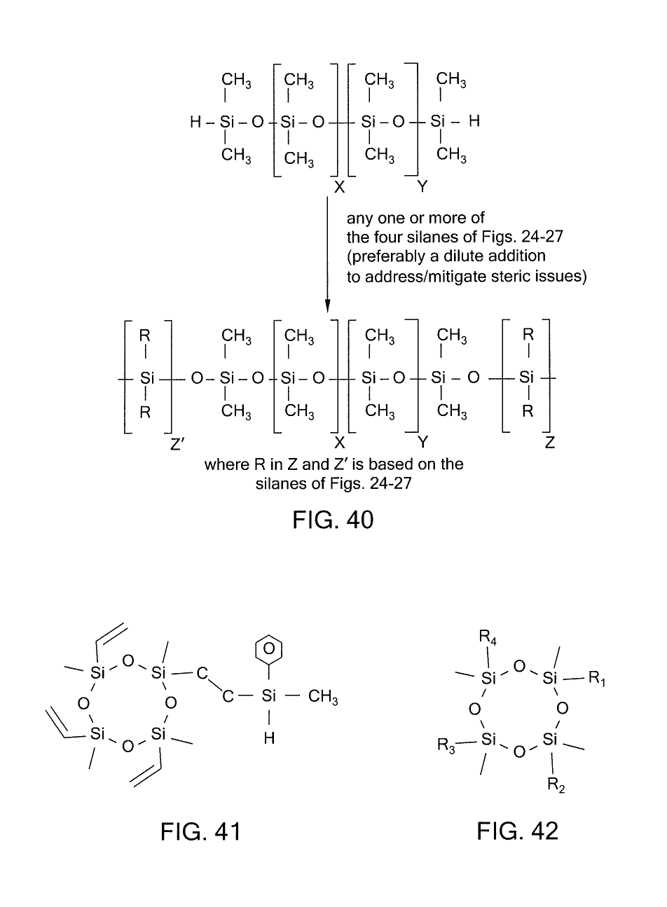

The precursor may be a siloxane backbone additive, such as hydride terminated diphenyl dimethyl polysiloxane, which formula is shown in FIG. 24. This precursor may have a molecular weight (mw) may be from about 400 mw to about 20,000 mw, and may have a molecular weight from about 800 to about 2,000, and may have a viscosity preferably from about 60 cps to about 300 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, as well as, other features and characteristics to the cured preform and ceramic material.

The precursor may be a siloxane backbone additive, such as styrene vinyl benzene dimethyl polysiloxane, which formula is shown in FIG. 25. This precursor may have a molecular weight (mw) may be from about 800 mw to at least about 10,000 mw to at least about 20,000 mw, and may have a viscosity preferably from about 50 cps to about 350 cps. The percentage of styrene vinyl benzene siloxane units “X” may be from 1% to 60%. The percentage of the dimethylsiloxane units “Y” may be from 40% to 99%. This precursor may be used to provide improved toughness, decreases reaction cure exotherm, may change or alter the refractive index, adjust the refractive index of the polymer to match the refractive index of various types of glass, to provide for example transparent fiberglass, as well as, other features and characteristics to the cured preform and ceramic material.

A variety of cyclosiloxanes can be used as reactive molecules in the formulation. They can be described by formula XX: DxD*y, where “D” represents a dimethyl siloxy unit and “D*” represents a substituted methyl siloxy unit, where the “*” group could be vinyl, allyl, hydride, hydroxy, phenyl, styryl, alkyl, or other organic group, X is from 0-8, Y is >=1, and X+Y is from 3-8.

The precursor batch may also contain non-silicon based cross linking agents, that are intended to, provide, the capability to cross-link during curing. For example, cross linking agents that can be used include DCPD-dicylcopentadiene, 1,4 butadiene, divnylbenzene, Isoprene, norbornadiene, propadiene, 4-vinylcyclohexene, 2-3 heptadiene 1,3 butadiene and cyclooctadiene. Generally, any hydrocarbon that contains two (or more) unsaturated, C═C bonds that can react with a Si—H, Si—OH, or other Si bond in a precursor, can be used as a cross linking agent. Some organic materials containing oxygen, nitrogen, and sulphur may also function as cross linking moieties.

The precursor may be a reactive monomer. These would include molecules, such as tetramethyltetravinylcyclotetrasiloxane (“TV”), which formula is shown in FIG. 26. This precursor may be used to provide a branching agent, a three-dimensional cross-linking agent, (and in certain formulations, e.g., above 2%, and certain temperatures (e.g., about from about room temperature to about 60° C., it acts as an inhibitor to cross-linking, e.g., in may inhibit the cross-linking of hydride and vinyl groups), as well as, other features and characteristics to the cured preform and ceramic material.

The precursor may be a reactive monomer, such as trivinyl cyclotetrasiloxane, which formula is shown in FIG. 27. The precursor may be a reactive monomer, such as divinyl cyclotetrasiloxane, which formula is shown in FIG. 28. The precursor may be a reactive monomer, such as monohydride cyclotetrasiloxane, which formula is shown in FIG. 29. The precursor may be a reactive monomer, such as dihydride cyclotetrasiloxane, which formula is shown in FIG. 30. The precursor may be a reactive monomer, such as hexamethyl cyclotetrasiloxane, which formula is shown in FIG. 31 and FIG. 32.

The precursor may be a silane modifier, such as vinyl phenyl methyl silane, which formula is shown in FIG. 33. The precursor may be a silane modifier, such as diphenyl silane, which formula is shown in FIG. 34. The precursor may be a silane modifier, such as diphenyl methyl silane, which formula is shown in FIG. 35 (which may be used as an end capper or end termination group). The precursor may be a silane modifier, such as phenyl methyl silane, which formula is shown in FIG. 36 (which may be used as an end capper or end termination group).

The precursors of FIGS. 33, 34 and 36 can provide chain extenders and branching agents. They also improve toughness, alter refractive index, and improve high temperature cure stability of the cured material, as well as improving the strength of the cured material, among other things. The precursor of FIG. 35 may function as an end capping agent, that may also improve toughness, alter refractive index, and improve high temperature cure stability of the cured material, as well as improving the strength of the cured material, among other things.

The precursor may be a reaction product of a silane modifier with a siloxane backbone additive, such as phenyl methyl silane substituted MH, which formula is shown in FIG. 35.

The precursor may be a reaction product of a silane modifier (e.g., FIGS. 33 to 36) with a vinyl terminated siloxane backbone additive (e.g., FIG. 15), which formula is shown in FIG. 38, where R may be the silane modifiers having the structures of FIGS. 33 to 36.

The precursor may be a reaction product of a silane modifier (e.g., FIGS. 33 to 36) with a hydroxy terminated siloxane backbone additive (e.g., FIG. 16), which formula is shown in FIG. 39, where R may be the silane modifiers having the structures of FIGS. 33 to 36.

The precursor may be a reaction product of a silane modifier (e.g., FIGS. 33 to 36) with a hydride terminated siloxane backbone additive (e.g., FIG. 17), which formula is shown in FIG. 40, where R may be the silane modifiers having the structures of FIGS. 33 to 36.

The precursor may be a reaction product of a silane modifier (e.g., FIGS. 33 to 36) with TV (e.g., FIG. 26), which formula is shown in FIG. 39.

The precursor may be a reaction product of a silane modifier (e.g., FIGS. 33 to 36) with a cyclosiloxane, examples of which formulas are shown in FIG. 26 (TV), FIG. 41, and in FIG. 3342, where R₁, R₂, R₃, and R₄ may be a methyl or the silane modifiers having the structures of FIGS. 33 to 36, taking into consideration steric hindrances.

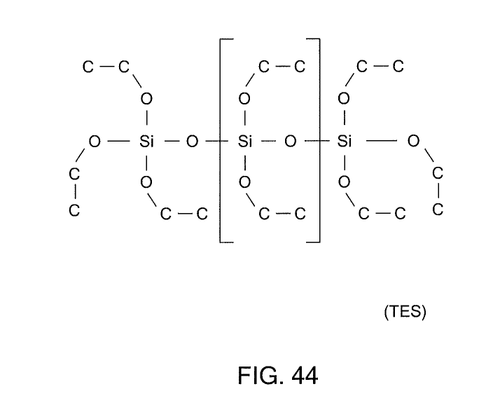

The precursor may be a partially hydrolyzed tertraethyl orthosilicate, which formula is shown in FIG. 44, such as TES 40 or Silbond 40.

The precursor may also be a methylsesquisiloxane such as SR-350 available from General Electric Company, Wilton, Conn. The precursor may also be a phenyl methyl siloxane such as 604 from Wacker Chemie AG. The precursor may also be a methylphenylvinylsiloxane, such as H62 C from Wacker Chemie AG.

The precursors may also be selected from the following: SiSiB® HF2020, TRIMETHYLSILYL TERMINATED METHYL HYDROGEN SILICONE FLUID 63148-57-2; SiSiB® HF2050 TRIMETHYLSILYL TERMINATED METHYLHYDROSILOXANE DIMETHYLSILOXANE COPOLYMER 68037-59-2; SiSiB® HF2060 HYDRIDE TERMINATED METHYLHYDROSILOXANE DIMETHYLSILOXANE COPOLYMER 69013-23-6; SiSiB® HF2038 HYDROGEN TERMINATED POLYDIPHENYL SILOXANE; SiSiB® HF2068 HYDRIDE TERMINATED METHYLHYDROSILOXANE DIMETHYLSILOXANE COPOLYMER 115487-49-5; SiSiB® HF2078 HYDRIDE TERMINATED POLY(PHENYLDIMETHYLSILOXY) SILOXANE PHENYL SILSESQUIOXANE, HYDROGEN-TERMINATED 68952-30-7; SiSiB® VF6060 VINYLDIMETHYL TERMINATED VINYLMETHYL DIMETHYL POLYSILOXANE COPOLYMERS 68083-18-1; SiSiB® VF6862 VINYLDIMETHYL TERMINATED DIMETHYL DIPHENYL POLYSILOXANE COPOLYMER 68951-96-2; SiSiB® VF6872 VINYLDIMETHYL TERMINATED DIMETHYL-METHYLVINYL-DIPHENYL POLYSILOXANE COPOLYMER; SiSiB® PC9401 1,1,3,3-TETRAMETHYL-1,3-DIVINYLDISILOXANE 2627-95-4; SiSiB® PF1070 SILANOL TERMINATED POLYDIMETHYLSILOXANE (OF1070) 70131-67-8; SiSiB® OF1070 SILANOL TERMINATED POLYDIMETHYSILOXANE 70131-67-8; OH-ENDCAPPED POLYDIMETHYLSILOXANE HYDROXY TERMINATED OLYDIMETHYLSILOXANE 73138-87-1; SiSiB® VF6030 VINYL TERMINATED POLYDIMETHYL SILOXANE 68083-19-2; and, SiSIB® HF2030 HYDROGEN TERMINATED POLYDIMETHYLSILOXANE FLUID 70900-21-9.

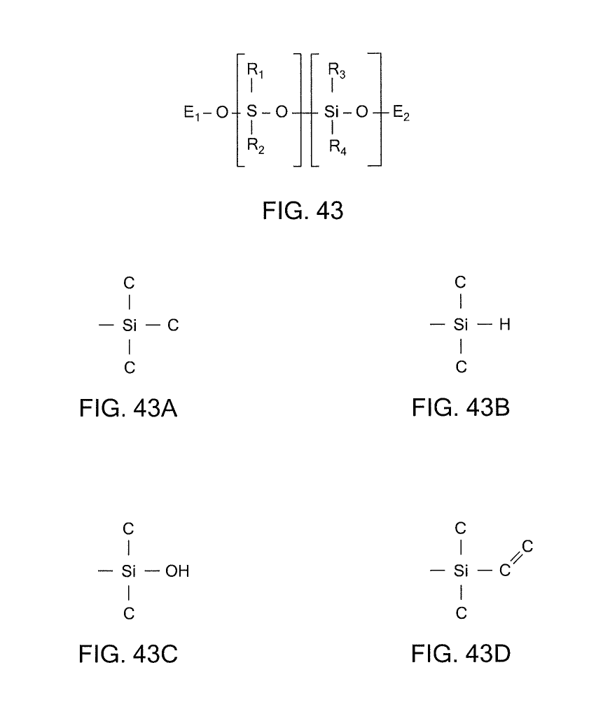

Thus, in additional to the forgoing specific precursors, it is contemplated that a precursor may be compound of the general formula of FIG. 43, wherein end cappers E₁ and E₂ are chosen from groups such as trimethyl silicon (SiC₃H₉) FIG. 43A, dimethyl silicon hydroxy (SiC₂OH₇) FIG. 43C, dimethyl silicon hydride (SiC₂H₇) FIG. 43B and dimethyl vinyl silicon (SiC₄H₉) FIG. 43D. The R groups R₁, R₂, R₃, and R₄ may all be different, or one or more may be the same, thus R2 is the same as R3 is the same as R₄, R₁ and R2 are different with R₃ and R₄ being the same, etc. The R groups are chosen from groups such as phenyl, vinyl, hydride, methyl, ethyl, allyl, phenylethyl, methoxy, and alkxoy.

In general, embodiments of formulations for polysilocarb formulations may for example have from about 0% to 50% MH, about 20% to about 99% MH, about 0% to about 30% siloxane backbone additives, about 1% to about 60% reactive monomers, about 30% to about 100% TV, and, about 0% to about 90% reaction products of a siloxane backbone additives with a silane modifier or an organic modifier reaction products.

In mixing the formulations a sufficient time to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should be kept below about 45 degrees C., and preferably about about 10 degrees C. (It is noted that these mixing conditions are for the pre-catalyzed formulations)

The Reaction Type Process

In the reaction type process, in general, a chemical reaction is used to combine one, two or more precursors, typically in the presence of a solvent, to form a precursor formulation that is essentially made up of a single polymer that can then be cured and if need be pyrolized. This process provides the ability to build custom precursor formulations that when cured can provide plastics having unique and desirable features such as high temperature, flame resistance and retardation, strength and other features. The cured materials can also be pyrolized to form ceramics having unique features. The reaction type process allows for the predetermined balancing of different types of functionality in the end product by selecting function groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

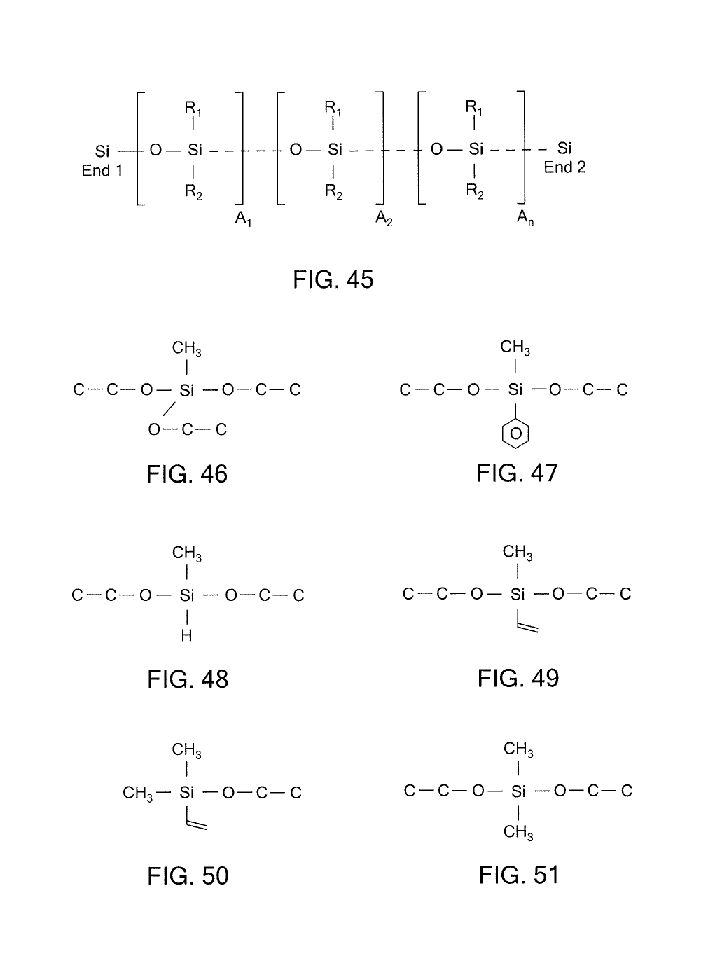

In general a custom polymer for use as a precursor formulation is made by reacting precursors in a condensation reaction to form the polymer precursor formulation. This precursor formulation is then cured into a preform through a hydrolysis reaction. The condensation reaction forms a polymer of the type shown in FIG. 45, where R₁ and R₂ in the polymeric units can be a H, a Methyl (Me)(—C), a vinyl (—C═C), alkyl (—R), a phenyl (Ph)(—C₆H₅), an ethoxy (—O—C—C), a siloxy, methoxy (—O—C), alkoxy, (—O—R), hydroxy, (—O—H), and phenylethyl (—C—C—C₆H₅). R₁ and R₂ may be the same or different. The custom precursor polymers can have several different polymeric units, e.g., A₁, A₂, Aₙ, and may include as many as 10, 20 or more units, or it may contain only a single unit. (For example, if methyl hydrogen fluid is made by the reaction process). The end units, Si End 1 and Si End 2, can come from the precursors of FIGS. 50, 52, 57, and 49. Additionally, if the polymerization process is properly controlled a hydroxy end cap can be obtained from the precursors used to provide the repeating units of the polymer.

In general, the precursors, e.g., FIGS. 46 to 59 are added to a vessel with ethanol (or other material to absorb heat, e.g., to provide thermal mass), an excess of water, and hydrochloric acid (or other proton source). This mixture is heated until it reaches its activation energy, after which the reaction is exothermic. In this reaction the water reacts with an ethoxy group of the silicon of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Control factors for determining chain length are: the monomers chosen (generally, the smaller the monomers the more that can be added before they begin to coil around and bond to themselves); the amount and point in the reaction where end cappers are introduced; and the amount of water and the rate of addition, among others. Thus, the chain lengths can be from about 180 mw (viscosity about 5 cps) to about 65,000 mw (viscosity of about 10,000 cps), greater than about 1000 mw, greater than about 10,000 mw, greater than about 50,000 mw and greater. Further, the polymerized precursor formulation may, and typically does, have polymers of different molecular weights, which can be predetermined to provide formulation, cured, and ceramic product performance features.

Upon completion of the polymerization reaction the material is transferred into a separation apparatus, e.g., a separation funnel, which has an amount of deionized water that is from about 1.2× to about 1.5× the mass of the material. This mixture is vigorously stirred for about less than 1 minute and preferably from about 5 to 30 sections. Once stirred the material is allowed to settle and separate, which may take from about 1 to 2 hours. The polymer is the higher density material and is removed from the vessel. This removed polymer is then dried by either warming in a shallow tray at 90 C for about two hours; or, preferably, is passed through a wiped film distillation apparatus, to remove any residual water and ethanol. Alternatively, sodium bicarbonate sufficient to buffer the aqueous layer to a pH of about 4 to about 7 is added. It is further understood that other, and commercial, manners of separating the polymer from the material may be employed.

Preferably a catalyst is used in the curing process of the polymer pressure formulations from the reaction type process. The same polymers as used for curing the formulation from the mixing type process can be used. It is noted that unlike the mixing type formulations, a catalyst is not necessarily required. However, if not used, reaction time and rates will be slower. The pyrolysis of the cured material is essentially the same as the cured material from the mixing process.

Curing and Pyrolysis and Conversion

The preform can be cured in a controlled atmosphere, such as an inert gas, or it can be cured in the atmosphere. The curing can be conducted in reduce pressure, e.g., vacuum, or in reduced pressure flowing gas (e.g., inert) streams. The cure conditions, e.g., temperature, time, rate, can be predetermined by the formulation to match, for example the size of the preform, the shape of the preform, or the mold holding the preform to prevent stress cracking, off gassing, or other problems associated with the curing process. Further, the curing conditions may be such as to take advantage of, in a controlled manner, what may have been previously perceived as problems associated with the curing process. Thus, for example, off gassing may be used to create a foam material having either open or closed structure. Further, the porosity of the material may be predetermined such that, for example, a particular pore size may be obtained, and in this manner a filter or ceramic screen having predetermined pore sizes, flow characteristic may be made.

Preferably, in making SiC, and materials for use in making SiC, the curing takes place at temperatures in the range of from about 20° C. to about 150° C., from about 75° C. to about 125° C. and from about 80° C. to 90° C. The curing is conducted over a time period that preferably results in a hard cured material. The curing can take place in air or an inert atmosphere, and preferably the curing takes place in an argon atmosphere at ambient pressure. Most preferably, for high purity materials, the furnace, containers, handling equipment, and other components of the curing apparatus are clean, essentially free from, and do not contribute any elements or materials, that would be considered impurities or contaminants, to the cured material. Methods for making SiC from SiOC precursors and materials are disclose in U.S. Patent Application Ser. No. 62/055,397, the entire disclosure of which is incorporated herein by reference.

The preforms, either unreinforced, neat, or reinforced, may be used as a stand alone product, an end product, a final product, or a preliminary product for which later machining or processing may be performed on. The preforms may also be subject to pyrolysis, which converts the preform material into a ceramic.

During the curing process some formulations may exhibit an exotherm, i.e., a self heating reaction, that can produce a small amount of heat to assist or drive the curing reaction, or they may produce a large amount of heat that may need to be managed and removed in order to avoid problems, such as stress fractures. During the cure off gassing typically occurs and results in a loss of material, which loss is defined generally by the amount of material remaining, e.g., cure yield. The formulations and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material shrinks, this shrinkage may be, depending upon the formulation and the nature of the preform shape, and whether the preform is reinforce, neat or unreinforced, from about 20%, less than 20%, less than about 15%, less than about 5%, less than about 1%, less than about 0.5%, less than about 0.25% and smaller.

In pyrolizing the preform, or cured structure or cured material, it is heated to above about 650° C. to about 1,200° C. At these temperatures typically all organic structures are either removed or combined with the inorganic constituents to form a ceramic. Typically at temperatures in the 650° C. to 1,200° C. range the material is an amorphous glassy ceramic. When heated above 1,200° C. the material may from nano crystalline structures, or micro crystalline structures, such as SiC, Si3N₄, SiCN, β SiC, and above 1,900° C. an α SiC structure may form, and at and above 2,200° C. α SiC is formed.

During pyrolysis material is loss through off gassing. The amount of material remaining at the end of a pyrolysis set is referred to as char yield (or pyrolysis yield). The formulations and polysilocarb precursor formulations of embodiments of the present inventions can have char yields for SiOC formation of at least about 60%, about 70%, about 80%, and at least about 90%, at least about 91% and greater. In fact, with air pyrolysis the materials may have cure yields well above 91%, which can approach 100%. In order to avoid the degradation of the material in an air pyrolysis (noting that typically pyrolysis is conducted in an inert atmospheres) specifically tailored formulations must be used, such as for example, formulations high in phenyl content (at least about 11%, and preferably at least about 20% by weight phenyls), formulations high in allyl content (at least about 15% to about 60%). Thus, there is provided formulations and polysilocarb precursor formulations that are capable of being air pyrolized to form a ceramic and to preferably do so at char yield in excess of at least about 80% and above 88%. The subsequent yields for SiOC derived SiC are generally from about 10% to 50%, typically from 30% to 40%, although higher and lower ranges may be obtained.

The initial or first pyrolysis step for SiOC formation generally yields a structure that is not very dense, and for example, has not reached the density required for its intended use. However, in some examples, such as the use of light weight spheres, the first pyrolysis may be sufficient. Thus, typically a reinfiltration process may be performed on the pyrolized material, to add in additional polysilocarb precursor formulation material, to fill in, or fill the voids and spaces in the structure. This reinfiltrated material is they repyrolized. This process of pyrolization, reinfiltration may be repeated, through one, two, three, and up to 10 or more times to obtain the desired density of the final product. Additionally, with formulations of embodiments of the present inventions, the viscosity of the formulation may be tailored to provide more efficient reinfiltrations, and thus, a different formulation may be used at later reinfiltration steps, as the voids or pores become smaller and more difficult to get the formulation material into it. The high char yields, and other features of embodiments of the present invention, enable the manufacture of completely closed structures, e.g., “helium tight” materials, with less than twelve reinfiltration steps, less than about 10 reinfiltrations steps and less than five reinfiltrations steps. Thus, by way of example, an initial inert gas pyrolysis may be performed with a high char yield formulation followed by four reinfiltration air pyrolysis steps.

Upon curing the polysilocarb precursor formulation a cross linking reaction takes place that provides a cross linked structure having, among other things, an —R₁—Si—C—C—Si—O—Si—C—C—Si—R₂— where R₁ and R₂ vary depending upon, and are based upon, the precursors used in the formulation.

Preferably, in making SiC, and materials for use in making SiC, the pyrolysis takes place at temperatures in the range of from about 800° C. to about 1300° C., from about 900° C. to about 1200° C. and from about 950° C. to 1150° C. The pyrolysis is conducted over a time period that preferably results in the complete pyrolysis of the preform. Preferably the pyrolysis takes place in inert gas, e.g., argon, and more preferably in flowing argon gas at or about at atmospheric pressure. The gas can flow from about 1,200 cc/min to about 200 cc/min, from about 800 cc/min to about 400 cc/min, and at about 500 cc/min. Preferably, an initial vacuum evacuation of the processing furnace is completed to a reduced pressure at least below 1 E-3 Torr and re-pressurized to greater than 100 Torr with inert gas, eg. Argon. More preferably, the vacuum evacuation is completed to a pressure below 1 E-5 Torr prior to re-pressurizing with inert gas. The vacuum evacuation process can be completed anywhere from zero to >4 times before proceeding. Most preferably, for high purity materials, the furnace, containers, handling equipment, and other components of the curing apparatus are clean, essentially free from, free from and do not contribute any elements or materials, that would be considered impurities or contaminants, to the cured material.

In embodiments were low N and O levels are required, the use of a vacuum, preferably a turbopump, to achieve 10E-6 Torr and backfilling with inert gas is preferable. This purging process can be done once, or multiple times, to achieve low levels. A constant flow rate of “sweeping” gas can help purge the furnace during volatile generation.

Preferably, in making SiC, the ceramic SiOC is converted to SiC in subsequent or continued pyrolysis or conversion steps. The conversion step from SiOC may be a part of, e.g., continuous with, the pyrolysis of the SiOC preform, or it may be an entirely separate step in time, location and both. Depending upon the type of SiC desired the convention step can be carried out from about 1,200° C. to about 2,550° C. and from about 1,300° C. to 1,700° C. Generally, at temperatures from about 1,600° C. to 1900 C, the formation of beta types is favored over time. At temperatures above 1900 C, the formation of alpha types is favored over time. Preferably the conversion takes place in an inert gas, e.g., argon, and more preferably in flowing argon gas at or about at atmospheric pressure. The gas can flow from about 600 cc/min to about 10 cc/min, from about 300 cc/min to about 50 cc/min, and at about 80 cc/min to about 40 cc/min. Most preferably, for high purity materials, the furnace, containers, handling equipment, and other components of the curing apparatus are clean, essentially free from, and do not contribute any elements or materials, that would be considered impurities or contaminants, to the SiC

Most preferably, when making high purity SiC, the activities associated with making, curing, pyrolizing and converting the material are conducted in, under, clean room conditions, e.g., under an ISO 14644-1 clean room standard of at least ISO 5, of at least ISO 4, of at least ISO 3, of at least ISO 2, and at least ISO 1. In an embodiment the material handling steps are conducted in the cleanroom of at least ISO 5, while a less clean area (ISO >5) is used for the pyrolysis and conversion steps.

Porosity and Pore Formation

By way of illustration, to develop controlled porosity on a micro and nano scale, certain polymer compositions may be preferred for creating these types of porosity.

Micro/mesoporous materials can be made using as substrates SiC and SiOC. These may have pores generated by the evolution of gas during curing or pyrolysis such as water vapor, methane, ethane, or vaporized organics such as polyethylene, polypropylene, and acrylic, among others. Thus, for example, a precursor formulation designed to produce water during the curing step can result in a highly controlled uniform porous structure. The size of the pores and the strength of the structure can be controlled by the precursor formulation composition, which would be adjusted to produce the proper amount of water vapor. Further, cycle times, processing temperatures, amount of catalysis and other factors may also play a part in the pore formation, size distribution and control of porosity and pore formation. Such precursor formulations can preferably have compositions utilizing primarily methyl, vinyl, hydride, and OH substitution. For example, the OH substitution can be used to control the water generation and hence the porosity and microstructure. The porosity and pore structure can also, in whole or in part with other factors, be modified by the use of the appropriate catalysts that bias the cure chemistry to selectively produce either water or hydrogen, both of which can be used to produce porosity.

Nano-Scale Porosity for Hydrogen Separation—For the effective separation of hydrogen from CO, CO₂ and other impurities, a very fine pore structure is preferred. One route to potentially generating such fine (nano-meter, and potentially smaller scale) pores would be to utilize a high carbon content polymer that would be pyrolized to create nano-size regions of graphite which would then be oxidized away to create the exceedingly small pores. For example, this would be accomplished by creating a polymer that would have sufficient excess carbon on pyrolysis that a proper heat treatment would create the graphite. The compositions would include but not be limited to using the following substitutional groups to add the excess carbon: phenyl groups, allyl groups, acetylene groups, ethinyl groups, propargyl groups, etc. In addition, other compounds such as styrene, dicyclopentadiene, butadiene, etc. could be reacted with chlorosilanes, ethoxy silanes or other silicon containing reactive precursors to produce a polymer or monomer that would cure and pyrolize to a ceramic with nano-scale carbon or graphite regions that could then be oxidized out to produce nano-porous materials.

Further, the cured polymeric material may have other sources of carbon, glass or other materials that can be removed during the curing, pyrolzing and both steps. These other sources can be mixed, blended or otherwise suspended in the liquid precursor material before the first curing step. Thus, and most preferably, these other sources will be substantially uniformly distributed throughout the material and maintain such distribution upon the cure to a solid, or semi solid material. These materials could be for example, fine fibers, nanotubes, and other similar types of materials.

The polysilocarb derived membranes, which include polysicocarb derived SiC membranes, can find many applications, can be of many types and combinations and variations of these. Thus, for example, embodiments of these membranes can be: symmetric and asymmetric; flat sheet, disc, tubular, multi-channel, honeycomb, hollow fiber, spiral wound; they can be used for gas separation, pervaporation, catalytic reactor, liquid separation, molecular sieve extraction, electrodialysis; they can be used for reverse osmosis (e.g., about 2 Å (angstroms) to about 9 Å); nanofiltration (e.g., about 7 Å to about 30 Å); ultrafiltration (e.g., about 20 Å to about 0.1 μm (micron)); microfiltration (e.g., about 0.1 μm to about 10 μm); and conventional filtration (e.g., from about 10 μm to about 100 μm); they can have pore morphologies that are macroporous (e.g., pore sizes of greater than 50 nm, which rely upon sieving as the filtration method), mesoporous (e.g., 2-50 nm pore size, which rely upon Knudsen diffusion as the filtration method), microporous (e.g. less than 2 nm pore size, which rely upon micropore diffusion as the filtration method), nanoporous, dense (essentially no porosity, which rely essentially solely on diffusion as the filtration method); they can have varying degrees of tortuosity and openness; and combinations and variations of these.

It being further understood that the pore size, and the effective pore size may be smaller, larger, or the same as the size of the material that is being filtered out, e.g., stopped by the membrane. They may further have there surface properties, and in particular the surface properties of their pores modified, enhanced and both. Such controlled pore surface features can be obtained by post processing of the polysilocarb derived membrane, during formation of the membrane, from the precursor formulation, and combinations and variations of these and other parameters.

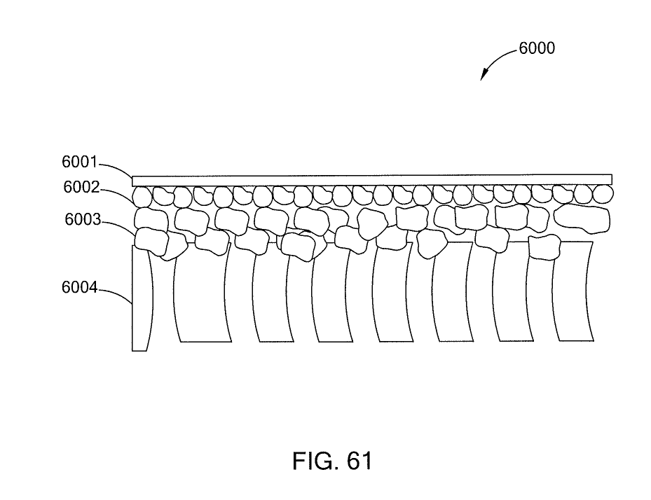

A filter, or membrane composite, may be made up of one or more layers (including two, three, four, five and more) of membranes having different pore sizes. All of these layers, one of these layers, some but not all of these layers can be made up of polysilocarb derived membrane material. Turing to FIG. 61 there is shown a schematic cross section of a membrane composite 6000 having a first dense layer 6001, a second separation layer 6002, a third intermediate layer 6003 and a porous support layer 6004.

The pore sizes of these layers in an embodiment of a membrane composite can be less than 2 nm for dense layer 6001, about 3-100 nm for the separation layer 6002, about 100-1500 nm for the intermediate layer 6003, and about 1-15 μm for the porous support layer 6004.

Embodiments of the present polysilocarb membranes and membrane configurations can find applications in energy fields, chemistry fields, pharmaceutical fields, medical fields, and environmental fields. In the energy field such applications would include gas separation (e.g., O₂, H₂, CH₄, CO and N₂), fuel cells, carbon capture and storage, biogas, pressure-retarded osmosis, and battery separators, to name a few. In the chemistry field such applications would include gas/vapor separation, membrane catalytic reactor, pervaporation, dehydration of bioethanol, dehydration of biobutanol, and filtration of aggressive media to name a few. In the environmental field such applications would include greenhouse gas separation (e.g., O₂, N₂O), high-strength industrial wastewater treatment, and membrane sensors to name a few. In the pharmaceutical field such applications would include down stream processing applications, to name a few. In the medical field such applications would include medical devices (e.g., dialysis), tissue engineering, and bio-cell reactors to name a few. thus, these applications can provide significant benefits for, among others, hydrogen purification and production, natural gas separation and purification, carbon capture and storage, fuel cells, and specialty chemicals and separation and purification.

The following examples are provided to illustrate various embodiments of, among other things, membranes and hydrogen separation processes utilizing these membranes, as well as, processes, precursors, polysilocarb batches, prepregs, cured preforms, and ceramics of the present inventions. These examples are for illustrative purposes, and should not be viewed as, and do not otherwise limit the scope of the present inventions. The percentages used in the examples, unless specified otherwise, are weight percent of the total batch, preform or structure.

### EXAMPLES

### Example 1

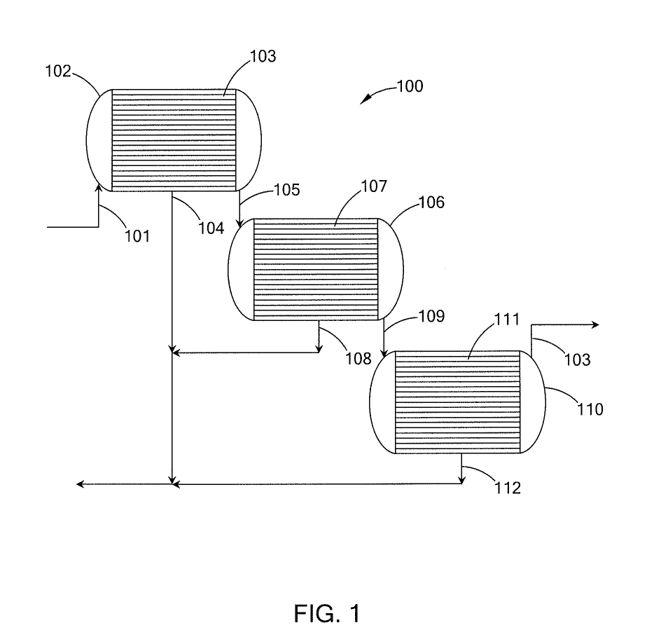

An embodiment of a hydrogen separation device (HSD) is shown in FIG. 1. The HSD 100 has three separation vessels 102, 106, 110 that are in series. Each vessel has membrane tube bundles, 103, 107, 111 of polysilocarb derived membranes. In operation, gas from inlet gas stream 101, which may be syngas having among other components H₂, CO₂, CO and H₂O, enters the first vessel 102 and enters the membrane tube bundles 103. An amount of the H₂ is separated by the polysilocarb membranes in the membrane tube bundle 103 and this separated H₂ is collected and leaves vessel 102 by line 104. The remaining inlet gas, which still contains H₂, leaves vessel 102 by transfer line 105 and enters the second vessel 106. An amount of the H₂ is separated by the polysilocarb membranes in the membrane tube bundle 107 and this separated H₂ is collected and leaves vessel 106 by line 108. The remaining inlet gas, which still contains H₂, leaves vessel 106 by transfer line 109 and enters the third vessel 110. An amount of the H₂ is separated by the polysilocarb membranes in the membrane tube bundle 111 and this separated H₂ is collected and leaves vessel 110 by line 112. The CO₂ rich retenate is then removed from the vessel 110 by line 103 for storage, disposal, use or sequestration. In this manner a H₂ rich permeate can be obtained and collected by lines 104, 108, 112 for storage and use. An embodiment of this polysilocarb membrane HSD can be operated under the following methodologies, conditions and parameters.

| | 761° C. HSD | 600° C. HSD | 300° C. HSD |
|---|---|---|---|
| Hydrogen Production | 35,205 lb/h | 35,903 lb/h | 36,564 lb/h |
| | 1402° F. | 1112° F. | 571° F. |
| Syngas Inlet Conditions | 684,000 lb/h | 684,000 lb/h | 684,000 lb/h |
| | 1000 psia, 956° F. | 1000 psia, 605° F. | 1000 psia, 404° F. |
| | 12,228 acfm | 10,382 acfm | 6,771 acfm |
| Minimum Membrane Area | 35,205 ft² | 35,903 ft² | 36,564 ft² |
| Minimum Membrane Area | 45,000 ft² | 45,000 ft² | 45,000 ft² |
| Increased by ~25% to | | | |
| Reach Design | | | |
| Vessel Diameter | 8 ft ID | 8 ft ID | 8 ft ID |
| Tube Dimensions | 0.625 inch OD | 0.625 inch OD | 0.625 inch OD |
| | 0.50 inch ID | 0.50 inch ID | 0.50 inch ID |
| Tubes per Vessel | 11,800 | 11,800 | 11,800 |
| Preliminary Tube Length | 29 ft | 29 ft | 29 ft |
| Gas Velocity through Tubes | 12.7 ft/sec | 10.8 ft/sec | 7.0 ft/sec |
| Gas Retention Time | 2.3 sec | 2.7 sec | 4.1 sec |
| Reynolds Number | ~19,000 | ~22,500 | ~28,000 |
| Number of Vessels and | 3 vessels | 3 vessels | 3 vessels |
| Configuration of Tube | 8 × 9.7 ft | 8 × 9.7 ft | 8 × 9.7 ft |
| Bundle | | | |
| Vessel Flow Arrangement | Series | Series | Series |

### Example 2

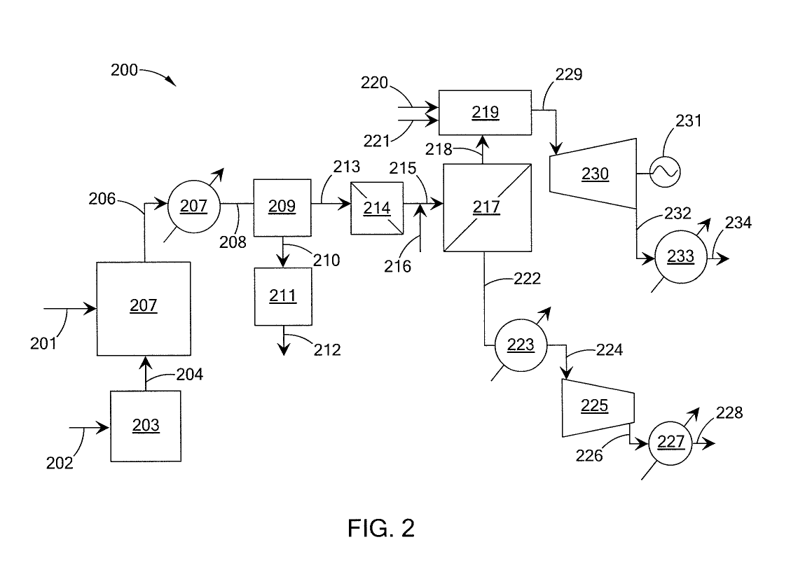

An embodiment of a hydrogen separation system, which can serve as a hydrogen fuel plant, is show in the schematic of FIG. 2, utilizing a hydrogen separation device having SiOC membranes.

Turning to FIG. 2 there is shown a schematic flow diagram of a hydrogen fuel plant 200. The fuel plant 200 has an inlet 201 for the inlet of source material, e.g., Pittsburgh #8 coal, and water, to an oxygen blown entrained bed gasifier 207. Air is provided into inlet 202 into an air separation unit (ASU) to provide Oxygen via line 204 to the gasifier 205. The gas stream leaving the gasifier 205 via line 206 is at about 1905° F. and about 1020 psia, and enter heat exchanger (HX) 207 where heat is recovered and the gas stream leaves via line 208 at about 1100° F. The gas stream in line 208 enters hot gas sulfur removal assembly 209, where sulfur is removed via line 210, to a sulfuric acid plant 211, and then discharged via line 212 as H₂SO₄ at 230 tons per day (TPD). After removal of sulfur the gas stream goes via line 213 (at about 1100° F.) to candle filter 214. The gas stream leaves candle filter 214 via line 215 where steam is injected into it via line 216. The gas-steam stream, at about 956° F., enters the hydrogen separation device (HSD) 217 (e.g., a system of the type of the embodiment of Example 1) utilizing polysilocarb derived membranes.

The CO₂ rich gas leaves the HSD 217 via line 218, at about 950 psia and 1402° F., and enters a gas turbine combustor 219, where oxygen 220 and quench water 221 are added. The combustor 219 converts CO and H₂ to CO₂ and H₂O. The gases leave the combustor 219 at about 902 psia and 2100° F. and enter a conventional expander 230, and can produce about 94 MW of electricity 231. The gases leaving the expander 230 via line 232 are at about 20 psia and 894° F., to heat recovery system generator (HRSG) 233 where CO₂ is produced at about 6,980 TPD.

The hydrogen rich gas leaves HSD 217 via line 222 at about 20 psia and 1402° F.; and enters HRSG 223. The hydrogen rich gas leaves HRGS 223 via line 224 to enter compressor 225; and then via line 226 to HRSG 227, where the hydrogen gas exits via line 228 at about 422 TPD, 346 psia, and greater than 99.5% purity.

### Example 3

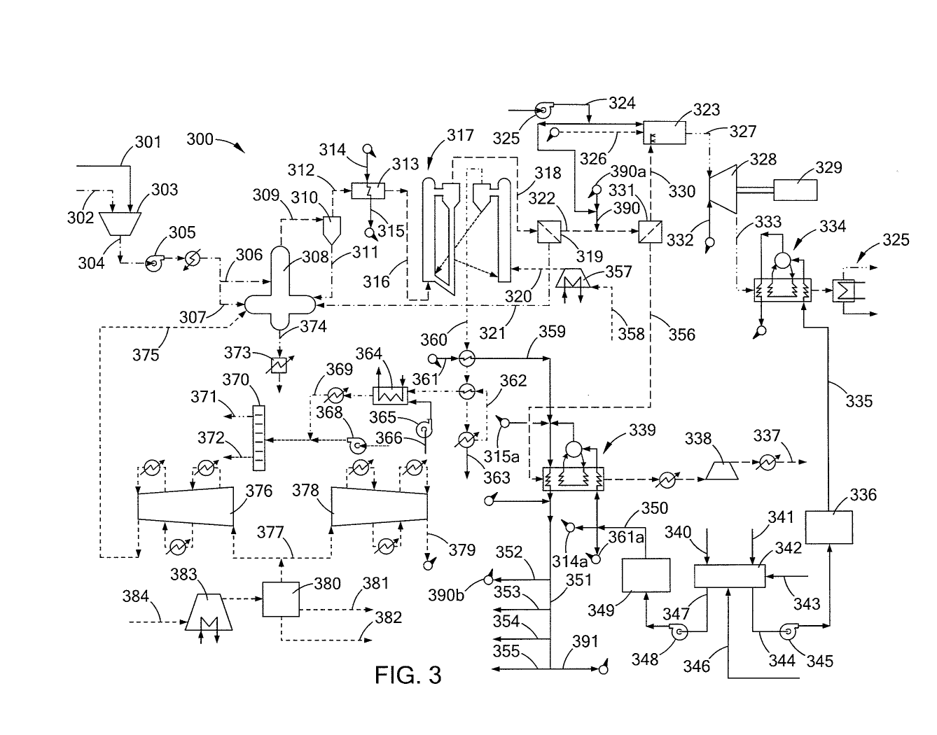

Turning to FIG. 3 there is shown a detailed schematic of an embodiment of a hydrogen separation system, using polysilocarb membranes. The hydrogen separation system 300 has water inlet 301 (94,825 lbs/hr) and coal inlet 301 (221,631 lbs/hr) in to vessel 303 where they are combined to 66% solids (by weight). Line 304 feeds pump 305 which pumps the mixture through a heat exchange, exiting at about 300° F. The stream is then split into two inlet lines, line 306 (about 22%) and line 307 (about 78%) into a gasifier 308. The gas exits the gasifier 308 via line 309 to a separator 310, where returns are feed back into the gasifier 308 via line 311. The gas stream exist the separator 310 via line 312 (1020 psia, 1905° F., 861 Btu/lb, 458,843 lbs/hr) and enters fire tube boiler 313, line 314 enters fire tube boiler 313 from line 350 (via path 314a-314). Line 315 exits boiler 313 to line 356 (via path 315-315a). The main gas stream exits boiler 313 via line 316 (1010 psia, 1100° F., 515 Btu/lb) and enters desulfurization system 317. The gas stream leaves the system 317 via line 318 (1000 psia, 1110° F., 527 Btu/lb, 455,640 lbs/hr) to candle filter 319. Rejects from candle filter 319 are handled by line 321 and returned to gasifier 308. Ambient air 358 (14.7 psia, 60° F., 14 Btu/lb, 42,054 lbs/hr) is feed into compressor 357 and into desulfurization system 317 via line 320 (1000 psia, 290° F.).

The gas stream leaves candle filter 319 via line 322, where steam is added via 390 (and path 390b-390a) and enters the hydrogen separation device (HSD) 331 at (1000 psia, 955° F., 813 Btu/lb, 683,799 lbs/hr). The HSD has polysilocarb membranes.

CO₂ rich gas leaves HSD 331 via line 330 (950 psia, 1112° F., 479 Btu/lb, 647,899 lbs/hr) to combustor 323. Combustion quench water (1000 psia, 100° F., 65 Btu/lb, 16,530 lbs/hr) is added by pump 325 and line 324. Oxygen is added via line 326 (975 psia, 303° F., 59 Btu/lb, 58,701 lbs/hr) to the combustor 323 from line 379. The stream leaves combustor 323 via line 327 (902 psia, 2100° F., 879 Btu/lb, 723,130 lbs/hr) and enters gas expander 328, which powers generator 329. Steam via path 391-332 may also enter expander 328. The stream leaves gas expander 329 via line 333 (20 psia, 905° F., 567 Btu/lb, 805,012 lbs/hr) and enters HRSG 334, where CO₂ is produced by system 325.

Condensates 340, 341 from an ASU 380, condensate returns from slurry heater 346, and returns 343 are added to condenser 342. Line 344 exits condenser 342 and is feed by pump 345 into low temperature process economizers 336 and then via line 335 to HRSG 334.

Line 347 exits condenser 347 and is pumped by pump 348 to low temperature process economizers 349 and via line 350 into HRSG 339. The line exiting HRSG 339 enters compressor 338 to produce hydrogen gas 337.

Hydrogen rich gas from the separator 331 is transported via line 356 (20 psia, 1112° F., 3500 Btu/lb, 35,903 lbs/hr) to HRSG 339. Line 351 carries steam to various steam delivery paths, path 352 to the HSD, path 353 to a slurry heater, path 354 for process steam, and path 355 to the ASU 380.

Line 360 carries high sulfur material, and line 361 takes a feed from line 361a through a collection of heat exchanges to SO₂ converter 364. Line 359 feeds HRSG 339. Lines 362, 363 and associated heat exchanges handle the condensate.

Air 366 is feed by pump 365 into SO₂ converter 364. Line 369 exits converter 364, where is diluted with water from pump 368 and feed into acid tower 379, with tailgas exit 371 and H₂SO₄ production 372.

Line 374 carries slag away to heat exchanger 373.

Line 384 provides ambient air (14.7 psia, 60° F., 14 Btu/lb) to compressor 383 which feeds ASU 380. Oxygen (95% pure) from the ASU 380 is feed via lines 377 to combustor oxidant compressors 376, 378. Compressor 379 provides oxygen via line 375 to gasifier 308. Compressor 378 provides oxygen to combustor 323 via line 379-326.

Nitrogen is vented from the ASU 380 via line 381; ASU 380 also has a molecular sieve vent 382.

### Example 4

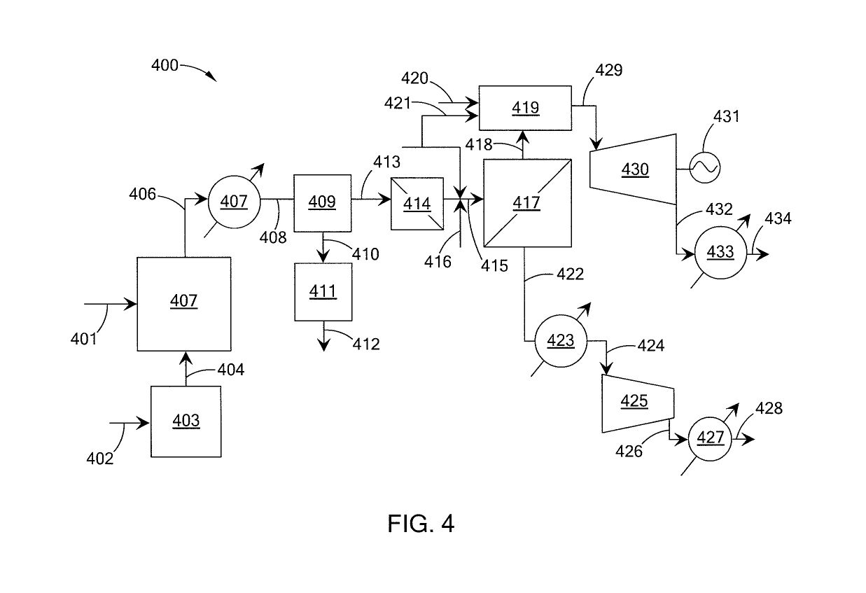

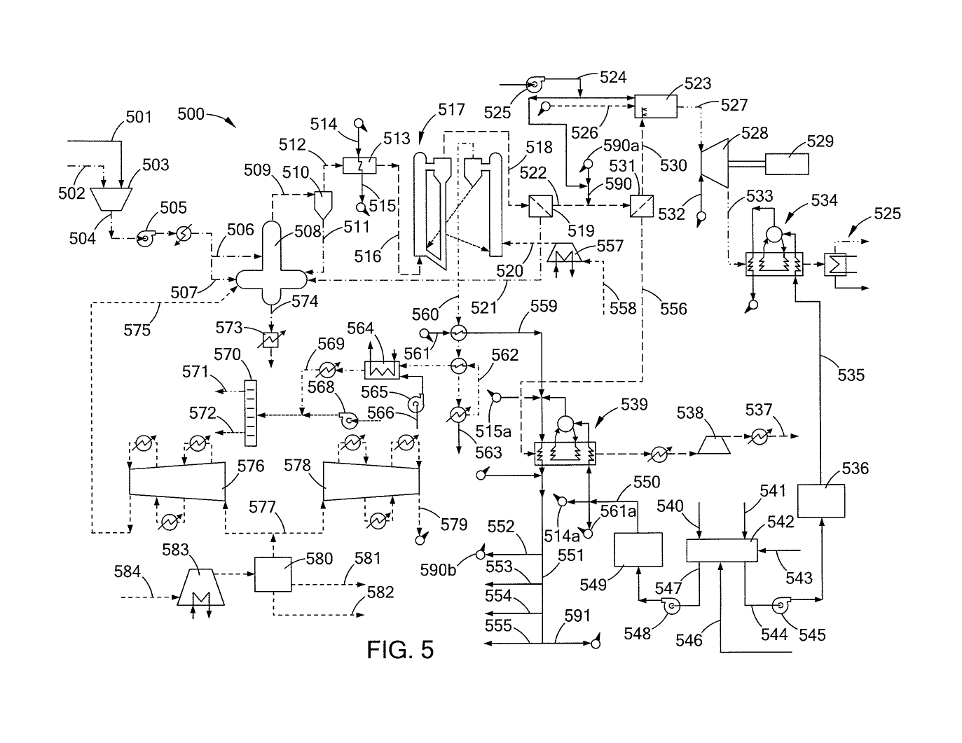

A hydrogen separation system, as show in the flow diagram of FIG. 4 and detailed schematic of FIG. 5, utilizing an HSD having polymer derived SiC membranes, can be operated under the following methodologies, conditions and parameters, with a temperature and pressure at the inlet side of the HSD of 950 psia, 1112° F. (600° C.).

| | |
|---|---|
| Coal Feed | Pittsburgh No. 8, <10% ash |
| Limestone Sorbent | None |
| Gasifier | Oxygen-blown Destec with second stage |
| | adjusted for 1905° F. output |
| Hot Gas Temperature | 1905° F. |
| Gasifier Outlet Pressure | 1000 psia |
| Ambient Conditions | 14.7 psia, 60° F. |
| Hot Gas Desulfurization | Yes, 1100° F. |
| Sulfur Recovery | Sulfuric acid |
| Ceramic Candle Filter | Before HSD |
| Hydrogen Separation | H₂ separation device |
| | Shell and tube configuration |
| | 95% separation |
| | 99.5% pure H₂ |
| | Zero sulfur |
| | 20 psia hydrogen compressed to 346 psia |
| Separated Gas | CO shifted to 1112° F. equilibrium |
| | 5% of fuel value in gas |
| | 950 psia |
| Separated Gas Utilization | Combustion with oxygen |
| | Steam injection conventional turbine |
| | expander |
| CO₂ Product Pressure | 19.4 psia |
| Hydrogen Utilization | 346 psia offsite |
| Auxiliary Power Block | Conventional turbine expander |
| Plant Size | Maximum H₂ production from 2,500 tpd dry |
| | gasifier |
| | Excess power sold offsite |

Turning to FIG. 4 there is shown a schematic flow diagram of a hydrogen fuel plant 400. The fuel plant 400 has an inlet 401 for the inlet of source material, e.g., Pittsburgh #8 coal, and water, to an oxygen blown entrained bed gasifier 407. Air is provided into inlet 402 into an air separation unit (ASU) to provide Oxygen via line 404 to the gasifier 405. The gas stream leaving the gasifier 405 via line 406, and enter heat exchanger (HX) 407 where heat is recovered and the gas stream leaves via line 408. The gas stream in line 408 enters hot gas sulfur removal assembly 409, where sulfur is removed via line 410, to a sulfuric acid plant 411, and then discharged via line 412 as H₂SO₄. After removal of sulfur the gas stream goes via line 413 to candle filter 414. The gas stream leaves candle filter 414 via line 415 where steam is injected into it via line 416. The gas-steam stream enters the hydrogen separation device (HSD) 417 (e.g., a system of the type of the embodiment of Example 1) utilizing polysilocarb derived membranes.

The CO₂ rich gas leaves the HSD 417 via line 418, and enters a gas turbine combustor 419, where oxygen 420 and quench water 441 are added. The combustor 419 converts CO and H₂ to CO₂ and H₂O. The gases leave the combustor 419 and enter a conventional expander 430, and can produce about 120 MW of electricity 431. The gases leaving the expander 430 via line 432, to heat recovery system generator (HRSG) 433 where CO₂ is produced.

The hydrogen rich gas leaves HSD 417 via line 422 and enters HRSG 423. The hydrogen rich gas leaves HRGS 443 via line 424 to enter compressor 425; and then via line 426 to HRSG 427, where the hydrogen gas exits via line 428 at greater than 99.9% purity.

Turning to FIG. 5 there is shown a detailed schematic of an embodiment of a hydrogen separation system, using polysilocarb membranes. The hydrogen separation system 500 has water inlet 501 and coal inlet 501 in to vessel 503 where they are combined to 66% solids (by weight). Line 504 feeds pump 505 which pumps the mixture through a heat exchange, exiting at about 300° F. The stream is then split into two inlet lines, line 506 and line 507 into a gasifier 508. The gas exits the gasifier 508 via line 509 to a separator 510, where returns are feed back into the gasifier 508 via line 511. The gas stream exist the separator 510 via line 512 and enters fire tube boiler 513, line 514 enters fire tube boiler 513 from line 550 (via path 514a-514). Line 515 exits boiler 513 to line 556 (via path 515-515a). The main gas stream exits boiler 513 via line 516 and enters desulfurization system 517. The gas stream leaves the system 517 via line 518 to candle filter 519. Rejects from candle filter 519 are handled by line 521 and returned to gasifier 508. Ambient air 558 is feed into compressor 557 and into desulfurization system 517 via line 520.

The gas stream leaves candle filter 519 via line 522, where steam is added via 590 (and path 590b-590a) and enters the hydrogen separation device (HSD) 531. The HSD has polysilocarb membranes.

CO₂ rich gas leaves HSD 531 via line 530 to combustor 523. Combustion quench water is added by pump 525 and line 524. Oxygen is added via line 526 to the combustor 523 from line 579. The stream leaves combustor 523 via line 527 and enters gas expander 528, which powers generator 529. Steam via path 591-532 may also enter expander 528. The stream leaves gas expander 529 via line 533 and enters HRSG 534, where CO₂ is produced by system 525.

Condensates 540, 541 from an ASU 580, condensate returns from slurry heater 546, and returns 543 are added to condenser 542. Line 544 exits condenser 542 and is feed by pump 545 into low temperature process economizers 536 and then via line 535 to HRSG 534.

Line 547 exits condenser 547 and is pumped by pump 548 to low temperature process economizers 549 and via line 550 into HRSG 539. The line exiting HRSG 539 enters compressor 538 to produce hydrogen gas 537.

Hydrogen rich gas from the separator 531 is transported via line 556 to HRSG 539. Line 551 carries steam to various steam delivery paths, path 552 to the HSD, path 553 to a slurry heater, path 554 for process steam, and path 555 to the ASU 580.

Line 560 carries high sulfur material, and line 561 takes a feed from line 561a through a collection of heat exchanges to SO₂ converter 564. Line 559 feeds HRSG 539. Lines 562, 563 and associated heat exchanges handle the condensate.

Air 566 is feed by pump 565 into SO₂ converter 564. Line 569 exits converter 564, where is diluted with water from pump 568 and feed into acid tower 579, with tailgas exit 571 and H₂SO₄ production 572.

Line 574 carries slag away to heat exchanger 573.

Line 584 provides ambient air to compressor 583, which feeds ASU 580. Oxygen (95% pure) from the ASU 580 is feed via lines 577 to combustor oxidant compressors 576, 578. Compressor 579 provides oxygen via line 575 to gasifier 508. Compressor 578 provides oxygen to combustor 523 via line 579-526.

Nitrogen is vented from the ASU 580 via line 581; ASU 580 also has a molecular sieve vent 582.

### Example 5

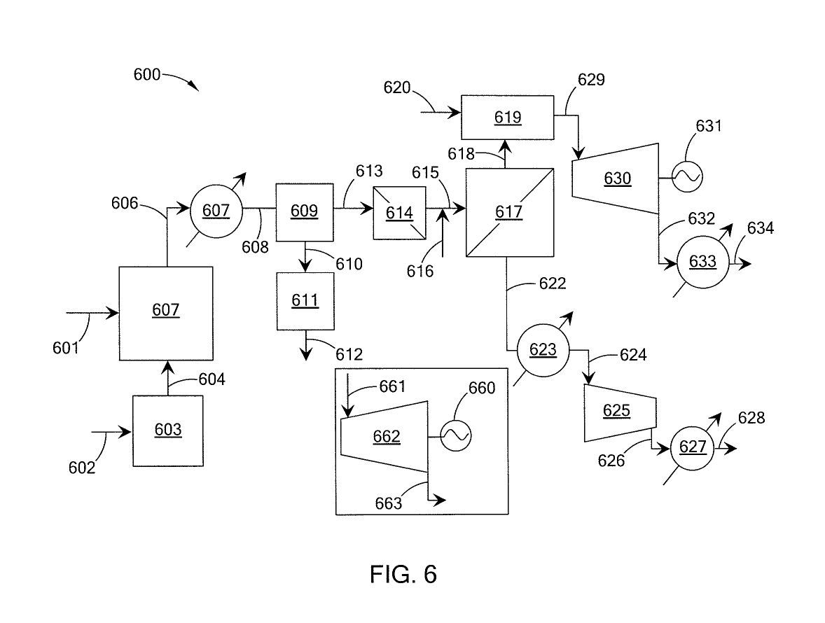

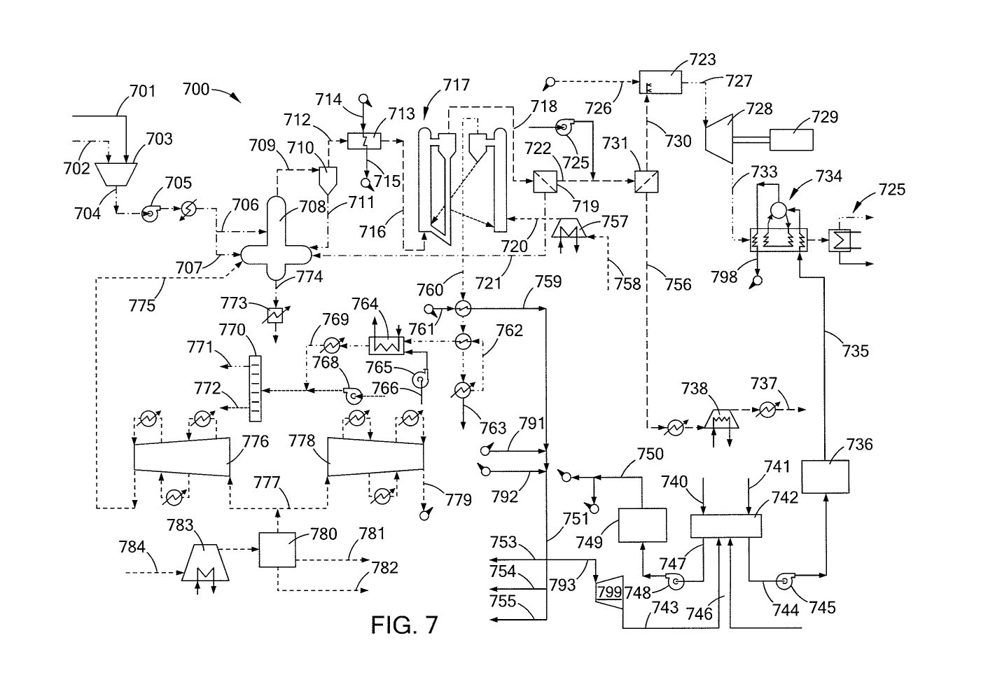

A hydrogen separation system, as show in the schematic of FIG. 6 and detailed flow diagram of FIG. 7, utilizing an HSD having polymer derived ceramic membranes, can be operated under the following methodologies, conditions and parameters, with a temperature and pressure at the inlet side of the HSD of 950 psia, 571 F (300 C).

| | |
|---|---|
| Coal Feed | Pittsburgh No. 8, <10% ash |
| Limestone Sorbent | None |
| Gasifier | Oxygen-blown Destec with second stage |
| | adjusted for 1905° F. output |
| Hot Gas Temperature | 1905° F. |
| Gasifier Outlet Pressure | 1000 psia |
| Ambient Conditions | 14.7 psia, 60° F. |
| Hot Gas Desulfurization | Yes, 1100° F. |
| Sulfur Recovery | Sulfuric acid |
| Ceramic Candle Filter | Before HSD |
| Hydrogen Separation | H₂ separation device |
| | Shell and tube configuration |
| | 95% separation |
| | 99.5% pure H₂ |
| | Zero sulfur |
| | 20 psia hydrogen compressed to 346 psia |
| Separated Gas | CO shifted to 572° F. equilibrium |
| | 5% of fuel value in gas |
| | 950 psia |
| Separated Gas Utilization | Combustion with oxygen |
| | Steam injection conventional turbine |
| | expander |
| CO₂ Product Pressure | 19.4 psia |
| Hydrogen Utilization | 346 psia offsite |
| Auxiliary Power Block | Conventional turbine expander |
| Plant Size | Maximum H₂ production from 2,500 tpd |
| | dry gasifier |

Turning to FIG. 6 these is shown a schematic flow diagram of a hydrogen fuel plant 600. The fuel plant 600 has an inlet 601 for the inlet of source material, e.g., Pittsburgh #8 coal, and water, to an oxygen blown entrained bed gasifier 607. Air is provided into inlet 602 into an air separation unit (ASU) to provide Oxygen via line 604 to the gasifier 605. The gas stream leaving the gasifier 605 via line 606 is at about 1905° F. and about 1020 psia, and enter heat exchanger (HX) 607 where heat is recovered and the gas stream leaves via line 608 at about 1100° F. The gas stream in line 608 enters hot gas sulfur removal assembly 609, where sulfur is removed via line 610, to a sulfuric acid plant 611, and then discharged via line 612 as H₂SO₄ at 230 tons per day (TPD). After removal of sulfur the gas stream goes via line 613 (at about 1100° F.) to candle filter 614. The gas stream leaves candle filter 614 via line 615 where steam is injected into it via line 616. The gas-steam stream, at about 956° F., enters the hydrogen separation device (HSD) 617 (e.g., a system of the type of the embodiment of Example 1) utilizing polysilocarb derived membranes.

The CO₂ rich gas leaves the HSD 617 via line 618, at about 950 psia and 571° F., and enters a gas turbine combustor 619, where oxygen 620 is added. The combustor 619 converts CO and H₂ to CO₂ and H₂O. The gases leave the combustor 619 at about 902 psia and 1672° F. and enter a conventional expander 630, and can produce about 59 MW of electricity 631. The gases leaving the expander 630 via line 632 are at about 20 psia and 894° F., to heat recovery system generator (HRSG) 633 where CO₂ is produced at about 7,027 TPD.

The hydrogen rich gas leaves HSD 617 via line 622 at about 20 psia and 571° F.; and enters HRSG 623. The hydrogen rich gas leaves HRGS 643 via line 624 to enter compressor 625; and then via line 626 to HRSG 627, where the hydrogen gas exits via line 628 at about 422 TPD, 346 psia, and greater than 99.5% purity.

This system has excess steam 661, which is delivered to a steam turbine 662 that generates electricity 660, about 11 MW. The turbine 662 has an exit line 663.

Turning to FIG. 7 there is shown a detailed schematic of an embodiment of a hydrogen separation system, using polysilocarb membranes. The hydrogen separation system 700 has water inlet 701 (94,000 lbs/hr) and coal inlet 701 (221,631 lbs/hr) in to vessel 703 where they are combined to 66% solids (by weight). Line 704 feeds pump 705 which pumps the mixture through a heat exchange, exiting at about 300° F. The stream is then split into two inlet lines, line 706 (about 22%) and line 707 (about 78%) into a gasifier 708. The gas exits the gasifier 708 via line 709 to a separator 710, where returns are feed back into the gasifier 708 via line 711. The gas stream exist the separator 710 via line 712 (1020 psia, 1905° F., 861 Btu/lb, 458,843 lbs/hr) and enters fire tube boiler 713, line 714 enters fire tube boiler 713 from line 750. Line 715 exits boiler 713 to line 792. The main gas stream exits boiler 713 via line 716 (1010 psia, 1100° F., 515 Btu/lb) and enters desulfurization system 717. The gas stream leaves the system 717 via line 718 (1000 psia, 1110° F., 526 Btu/lb, 455,640 lbs/hr) to candle filter 719. Rejects from candle filter 719 are handled by line 721 and returned to gasifier 708. Ambient air 758 (14.7 psia, 60° F., 14 Btu/lb, 42,054 lbs/hr) is feed into compressor 757 and into desulfurization system 717 via line 720 (1000 psia, 290° F.).

The gas stream leaves candle filter 719 via line 722, where water is added by pump 725 and enters the hydrogen separation device (HSD) 731 at (1000 psia, 403° F., 398 Btu/lb, 683,799 lbs/hr). The HSD has SiOC membranes.

CO₂ rich gas leaves HSD 731 via line 730 (950 psia, 570° F., 296 Btu/lb, 647,899 lbs/hr) to combustor 723. Oxygen is added via line 726 (975 psia, 303° F., 59 Btu/lb, 52,839 lbs/hr) to the combustor 723 from line 779. The stream leaves combustor 723 via line 727 (902 psia, 1672° F., 686 Btu/lb, 700,075 lbs/hr) and enters gas expander 728, which powers generator 729. The stream leaves gas expander 729 via line 733 (20 psia, 781° F., 393 Btu/lb, 700,075 lbs/hr) and enters HRSG 734, where CO₂ is produced by system 725.

Condensates 740, 741 from an ASU 780, condensate returns from slurry heater 746, and returns 743 from turbine 799 are added to condenser 742. Line 744 exits condenser 742 and is feed by pump 745 into low temperature process economizers 736 and then via line 735 to HRSG 734.

Line 747 exits condenser 747 and is pumped by pump 748 to low temperature process economizers 749 and via line 750 into HRSG 739. The line exiting HRSG 739 enters compressor 738 to produce hydrogen gas 737.

Hydrogen rich gas from the separator 731 is transported via line 756 (20 psia, 570° F., 1737 Btu/lb, 36,565 lbs/hr) to compressor 738 where hydrogen 737 is produced (346 psia, 1170° F., 272 Btu/lb, 36,565 lbs/hr) for storage and use.

Path 753 delivers steam to a slurry heater, Path 754 delivers process steam, and path 755 delivers steam to the ASU 780.

Line 760 carries high sulfur material, and line 761 takes a feed from line 750 and adds it to this material through a series of heat exchanges 762 to SO₂ converter 764. Line 759 feeds various other lines associated with it. Line 792 feeds line 759 with material from line 715. Line 791 feeds line 759 with material from line 798.

Air 766 is feed by pump 765 into SO₂ converter 764. Line 769 exits converter 764, where is diluted with water from pump 768 and feed into acid tower 779, with tailgas exit 771 and H₂SO₄ production 772.

Line 774 carries slag away to heat exchanger 773.

Line 784 provides ambient air (14.7 psia, 60° F., 14 Btu/lb) to compressor 783 which feeds ASU 780. Oxygen (95% pure) from the ASU 780 is feed via lines 777 to combustor oxidant compressors 776, 778. Compressor 779 provides oxygen via line 775 to gasifier 708. Compressor 778 provides oxygen to combustor 723 via line 779-726.

Nitrogen is vented from the ASU 780 via line 781; ASU 780 also has a molecular sieve vent 782.

### Example 6

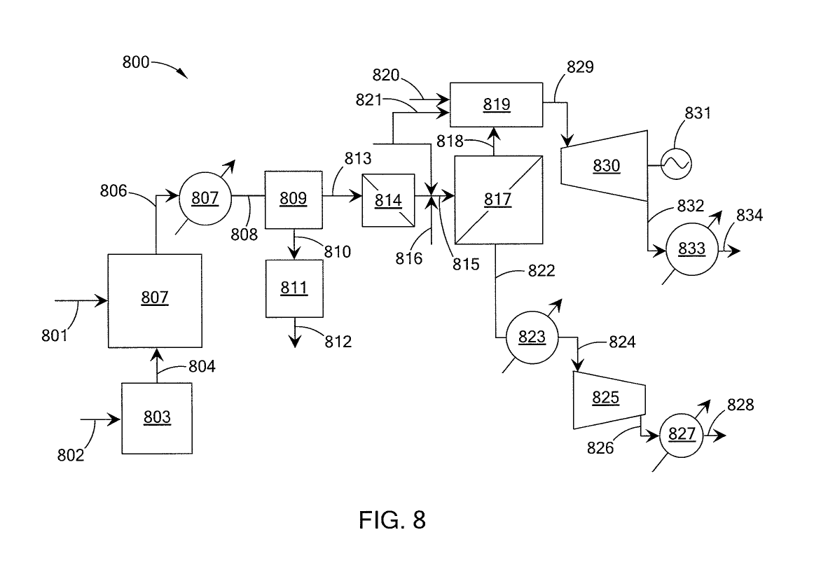

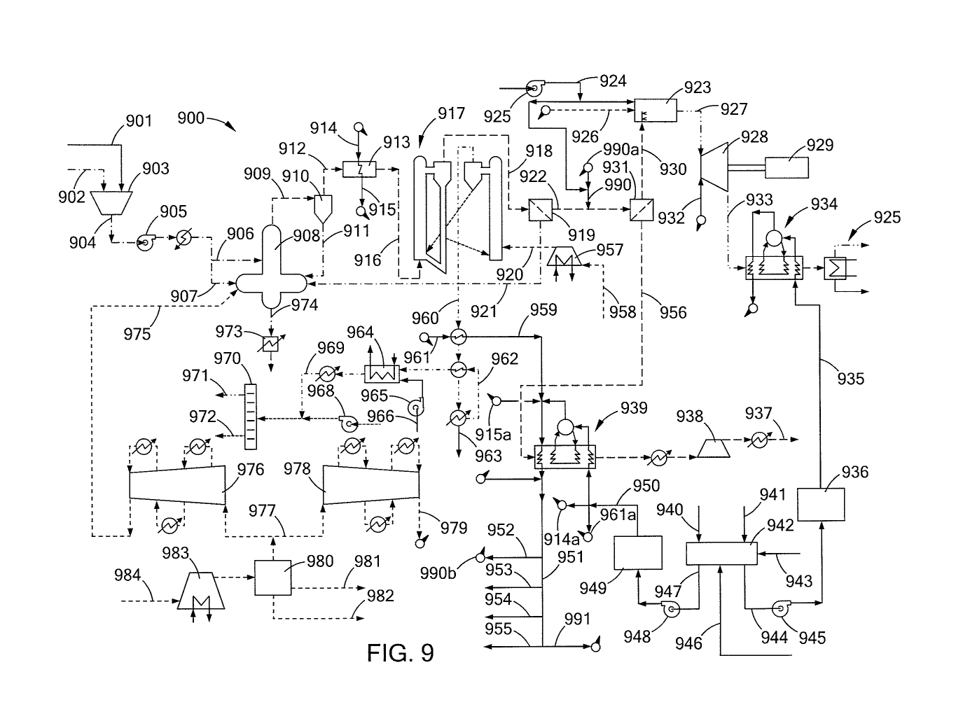

A hydrogen separation system, as show in the flow diagram of FIG. 8 and detailed schematic diagram of FIG. 9, utilizing an HSD having polymer derived ceramic membranes, can be operated under the following, methodologies, conditions and parameters, with a temperature and pressure at the inlet side of the HSD of 950 psia, 1112 F (600 C).

| | |
|---|---|
| Coal Feed | Pittsburgh No. 8, <10% ash |
| Limestone Sorbent | None |
| Gasifier | Oxygen-blown Destec with second stage |
| | adjusted for 1905° F. output |
| Hot Gas Temperature | 1905° F. |
| Gasifier Outlet Pressure | 1000 psia |
| Ambient Conditions | 14.7 psia, 60° F. |
| Hot Gas Desulfurization | Yes, 1100° F. |
| Sulfur Recovery | Sulfuric acid |
| Ceramic Candle Filter | Before HSD |
| Hydrogen Separation | H₂ separation device |
| | Shell and tube configuration |
| | 95% separation × 0.8 |
| | 99.5% pure H₂ |
| | Zero sulfur |
| | 20 psia hydrogen compressed to 346 psia |
| Separated Gas | CO shifted to 572° F. equilibrium |
| | ~1.2 × 5% of fuel value in gas |
| | 950 psia |
| Separated Gas Utilization | Combustion with oxygen |
| | Steam injection conventional turbine |
| | expander |
| CO₂ Product Pressure | 19.4 psia |
| Hydrogen Utilization | 346 psia offsite |
| Auxiliary Power Block | Conventional turbine expander |
| Plant Size | Maximum H₂ production from 2,500 tpd dry |
| | gasifier |

Turning to FIG. 8 there is shown a schematic flow diagram of a hydrogen fuel plant 800. The fuel plant 800 has an inlet 801 for the inlet of source material, e.g., Pittsburgh #8 coal, and water, to an oxygen blown entrained bed gasifier 807. Air is provided into inlet 802 into an air separation unit (ASU) to provide Oxygen via line 804 to the gasifier 805. The gas stream leaving the gasifier 805 via line 806, and enter heat exchanger (HX) 807 where heat is recovered and the gas stream leaves via line 808. The gas stream in line 808 enters hot gas sulfur removal assembly 809, where sulfur is removed via line 810, to a sulfuric acid plant 811, and then discharged via line 812 as H₂SO₄. After removal of sulfur the gas stream goes via line 813 to candle filter 818. The gas stream leaves candle filter 814 via line 815 where steam is injected into it via line 816. The gas-steam stream enters the hydrogen separation device (HSD) 817 (e.g., a system of the type of the embodiment of Example 1) utilizing polysilocarb derived membranes.

The CO₂ rich gas leaves the HSD 817 via line 818, and enters a gas turbine combustor 819, where oxygen 820 and quench water 841 are added. The combustor 819 converts CO and H₂ to CO₂ and H₂O. The gases leave the combustor 819 and enter a conventional expander 830, and can produce about 120 MW of electricity 831. The gases leaving the expander 830 via line 832, to heat recovery system generator (HRSG) 833 where CO₂ is produced.

The hydrogen rich gas leaves HSD 817 via line 822 and enters HRSG 823. The hydrogen rich gas leaves HRGS 843 via line 824 to enter compressor 825; and then via line 826 to HRSG 827, where the hydrogen gas exits via line 828 at greater than 99.9% purity.

Turning to FIG. 9 there is shown a detailed schematic of an embodiment of a hydrogen separation system, using polysilocarb membranes. The hydrogen separation system 900 has water inlet 901 and coal inlet 901 in to vessel 903 where they are combined to 66% solids (by weight). Line 904 feeds pump 905 which pumps the mixture through a heat exchange, exiting at about 300° F. The stream is then split into two inlet lines, line 906 and line 907 into a gasifier 908. The gas exits the gasifier 908 via line 909 to a separator 910, where returns are feed back into the gasifier 908 via line 911. The gas stream exist the separator 910 via line 912 and enters fire tube boiler 913, line 914 enters fire tube boiler 913 from line 950 (via path 914a-914). Line 915 exits boiler 913 to line 956 (via path 915-915a). The main gas stream exits boiler 913 via line 916 and enters desulfurization system 917. The gas stream leaves the system 917 via line 918 to candle filter 919. Rejects from candle filter 919 are handled by line 921 and returned to gasifier 908. Ambient air 958 is feed into compressor 957 and into desulfurization system 917 via line 920.

The gas stream leaves candle filter 919 via line 922, where steam is added via 990 (and path 990b-990a) and enters the hydrogen separation device (HSD) 931. The HSD has polysilocarb membranes.

CO₂ rich gas leaves HSD 931 via line 930 to combustor 923. Combustion quench water is added by pump 925 and line 924. Oxygen is added via line 926 to the combustor 923 from line 979. The stream leaves combustor 923 via line 927 and enters gas expander 928, which powers generator 929. Steam via path 991-932 may also enter expander 928. The stream leaves gas expander 929 via line 933 and enters HRSG 934, where CO₂ is produced by system 925.

Condensates 940, 941 from an ASU 980, condensate returns from slurry heater 946, and returns 943 are added to condenser 942. Line 944 exits condenser 942 and is feed by pump 945 into low temperature process economizers 936 and then via line 935 to HRSG 934.

Line 947 exits condenser 947 and is pumped by pump 948 to low temperature process economizers 949 and via line 950 into HRSG 939. The line exiting HRSG 939 enters compressor 938 to produce hydrogen gas 937.

Hydrogen rich gas from the separator 931 is transported via line 956 to HRSG 939. Line 951 carries steam to various steam delivery paths, path 952 to the HSD, path 953 to a slurry heater, path 954 for process steam, and path 955 to the ASU 980.

Line 960 carries high sulfur material, and line 961 takes a feed from line 961a through a collection of heat exchanges to SO₂ converter 964. Line 959 feeds HRSG 939. Lines 962, 963 and associated heat exchanges handle the condensate.

Air 966 is feed by pump 965 into SO₂ converter 964. Line 969 exits converter 964, where is diluted with water from pump 968 and feed into acid tower 979, with tailgas exit 971 and H₂SO₄ production 972.

Line 974 carries slag away to heat exchanger 973.

Line 984 provides ambient air to compressor 983, which feeds ASU 980. Oxygen (95% pure) from the ASU 980 is feed via lines 977 to combustor oxidant compressors 976, 978. Compressor 979 provides oxygen via line 975 to gasifier 908. Compressor 978 provides oxygen to combustor 923 via line 979-926.

Nitrogen is vented from the ASU 980 via line 981; ASU 980 also has a molecular sieve vent 982.

### Example 7

A polymer derived ceramic membrane can operate at temperatures up to 500° C., pressures up to 50 bar (˜725 psi), have high permselectivity of H₂ to CO₂—greater than 100, high flux—greater than 200 scft/ft² h, and superior hydrothermal stability.

### Example 8

A polymer derived ceramic membrane can operate at temperatures up to 800° C., pressures up to 100 bar (˜1,450 psi), have high permselectivity of H₂ to CO₂—greater than 100, high flux—greater than 300 scft/ft² h, and superior hydrothermal stability.

### Example 9

A polysilocarb formulation using the mixing type method is formulated. The formulation is made by mixing together at room temperature 95% MHF AND 5% TV.

### Example 10

A polysilocarb formulation using the mixing type method is formulated. The formulation is made by mixing together at room temperature 50% styrene precursor of the formula of FIG. 25 (having 20% X) and 50% TV 95% MHF.

### Example 11

A polysilocarb formulation using the mixing type method is formulated. The formulation is made by mixing together at room temperature 54% styrene precursor of the formula of FIG. 25 (having 25% X) and 46% TV.

### Example 12

A polysilocarb formulation using the mixing type method is formulated. The formulation is made by mixing together at room temperature 57% styrene precursor of the formula of FIG. 25 (having 30% X) and 43% TV.

### Example 13

A polysilocarb batch having 70% of the MH precursor (molecular weight of about 800) and 30% of the TV precursor are mixed together in a vessel and put in storage for later use. The polysilocarb batch has good shelf life and room temperature and the precursors have not, and do not react with each other. The polysilocarb batch has a viscosity of about 15 cps. 28% of an about 80 micron to about 325 mesh SiC filler is added to the batch to make a filled polysilocarb batch, which can be kept for later use. Just prior to forming and curing 10 ppm of a platinum catalyst is added to each of the polysilocarb batches and this catalyzed batch is formed into a membrane.

### Example 14

A polysilocarb batch having 70% of the MH precursor (molecular weight of about 800) and 30% of the TV precursor are mixed together in a vessel and put in storage for later use. The polysilocarb batch has good shelf life and room temperature and the precursors have not, and do not react with each other. The polysilocarb batch has a viscosity of about 15 cps. 21% of a silica fume (about 325 mesh) are added to the batch to make a filled polysilocarb batch, which can be kept for later use. Just prior to forming into a membrane, 10 ppm of a platinum catalyst is added to the polysilocarb batch and these catalyzed batches are formed into a membrane.

### Example 15

A polysilocarb batch having 75% of the MH precursor (molecular weight of about 800) and 25% of the TV precursor are mixed together in a vessel and put in storage for later use. The polysilocarb batch has good shelf life and room temperature and the precursors have not, and do not react with each other. The polysilocarb batch has a viscosity of about 18 cps. 40% of a silica fume to about 325 mesh silica filler is added to the batch to make a filled polysilocarb batch, which can be kept for later use. Prior to forming and curing 10 ppm of a platinum catalyst is added to each of the polysilocarb batch and this batch is formed into membranes.

### Example 16

A polysilocarb batch having 10% of the MH precursor (molecular weight of about 800), 73% of the STY (FIG. 10 and having 10% X, molecular weight of about 1,000), and 16% of the TV precursor, and 1% of the OH terminated precursor of the formula of FIG. 16, having a molecular weight of about 1,000 are mixed together in a vessel and put in storage for later use. The polysilocarb batch has good shelf life and room temperature and the precursors have not, and do not react with each other. The polysilocarb batch has a viscosity of about 72 cps. 10 ppm of a platinum catalyst is added to the polysilocarb batch prior to curing.

### Example 17

A polysilocarb batch having about 70% MH, 20% TV precursor, 10% VT (molecular weight of about 6000), and 1% of the OH terminated precursor of the formula of FIG. 16, having a molecular weight of about 800 are mixed together in a vessel and put in storage for later use. The polysilocarb batch has good shelf life and room temperature and the precursors have not, and do not react with each other. The polysilocarb batch has a viscosity of about 55 cps. Prior to forming the preform materials 10 ppm of a platinum and peroxide catalyst mixture is added to the polysilocarb batch.

### Example 18

A polysilocarb batch having 70% of the MH and 30% of the VT having a molecular weight of about 500 and about 42% of a submicron and a 325 mesh silica are mixed together in a vessel and put in storage for later use. The polysilocarb batch has good shelf life and room temperature and the precursors have not, and do not react with each other. The polysilocarb batch has a viscosity of about 300 cps.

### Example 19

A polysilocarb batch having 70% of the MH precursor of the formula of FIG. 10 and a molecular weight of about 800 and 30% of the vinyl terminated precursor of the formula of FIG. 14 having a molecular weight of about 500 are mixed together in a vessel and put in storage for later use. The polysilocarb batch has good shelf life and room temperature and the precursors have not, and do not react with each other. The polysilocarb batch has a viscosity of about 12 cps.

### Example 20

A polysilocarb batch having 60% of the MH precursor of the formula of FIG. 10 and a molecular weight of about 800 and 40% of the vinyl terminated precursor of the formula of FIG. 14 having a molecular weight of about 9,400 are mixed together in a vessel and put in storage for later use. The polysilocarb batch has good shelf life and room temperature and the precursors have not, and do not react with each other. The polysilocarb batch has a viscosity of about 200 cps.

### Example 21

A polysilocarb batch having 50% of the MH precursor of the formula of FIG. 10 and a molecular weight of about 800 and 50% of the vinyl terminated precursor of the formula of FIG. 14 having a molecular weight of about 800 are mixed together in a vessel and put in storage for later use. The polysilocarb batch has good shelf life and room temperature and the precursors have not, and do not react with each other. The polysilocarb batch has a viscosity of about 55 cps.

### Example 22

A polysilocarb batch having 40% of the MH precursor of the formula of FIG. 10 and a molecular weight of about 1,000 and 60% of the vinyl terminated precursor of the formula of FIG. 14 having a molecular weight of about 500 are mixed together in a vessel and put in storage for later use. The polysilocarb batch has good shelf life and room temperature and the precursors have not, and do not react with each other. The polysilocarb batch has a viscosity of about 25 cps.

### Example 23

A polysilocarb batch having 30% of the MH precursor of the formula of FIG. 10 and a molecular weight of about 800 and 70% of the vinyl terminated precursor of the formula of FIG. 14 having a molecular weight of about 500 are mixed together in a vessel and put in storage for later use. The polysilocarb batch has good shelf life and room temperature and the precursors have not, and do not react with each other. The polysilocarb batch has a viscosity of about 10 cps.

### Example 24

The polysilocarb batch of Examples 19-22 has 40% of an about 80 micron to about 325 mesh SiC filler added to the batch to make a filled polysilocarb batch, which can be kept for later use.

### Example 25

The polysilocarb batch of Example 19-22 has 30% of an about 80 micron to about 325 mesh SiC filler added to the batch to make a filled polysilocarb batch, which can be kept for later use.

### Example 26

A polysilocarb batch having 70% of the MH precursor of the formula of FIG. 10 and a molecular weight of about 800 and 30% of the TV precursor of the formula of FIG. 26 are mixed together in a vessel and put in storage for later use. The polysilocarb batch has good shelf life and room temperature and the precursors have not, and do not react with each other. The polysilocarb batch has a viscosity of about 15 cps.

### Example 27

A polysilocarb batch having 75% of the MH precursor of the formula of FIG. 10 and a molecular weight of about 800 and 25% of the TV precursor of the formula of FIG. 26 are mixed together in a vessel and put in storage for later use. The polysilocarb batch has good shelf life and room temperature and the precursors have not, and do not react with each other. The polysilocarb batch has a viscosity of about 18 cps.

### Example 28

A polysilocarb batch having 10% of the MH precursor of the formula of FIG. 10 and a molecular weight of about 800 and 73% of the styrene precursor of the formula of FIG. 25 (having 10% X) and a molecular weight of about 1,000, and 16% of the TV precursor of the formula of FIG. 26, and 1% of the OH terminated precursor of the formula of FIG. 16, having a molecular weight of about 1,000 are mixed together in a vessel and put in storage for later use. The polysilocarb batch has good shelf life and room temperature and the precursors have not, and do not react with each other. The polysilocarb batch has a viscosity of about 72 cps.

### Example 29

A polysilocarb batch having about 70% of the MH precursor of the formula of FIG. 10 and a molecular weight of about 800, and about 20% of the TV precursor of the formula of FIG. 26, and 10% of the vinyl terminated precursor of the formula of FIG. 14 having a molecular weight of about 6000 and 1% of the OH terminated precursor of the formula of FIG. 16, having a molecular weight of about 800 are mixed together in a vessel and put in storage for later use. The polysilocarb batch has good shelf life and room temperature and the precursors have not, and do not react with each other. The polysilocarb batch has a viscosity of about 55 cps.

### Example 30

A polysilocarb batch having 75% of the MH precursor of the formula of FIG. 10 and a molecular weight of about 800, and 15% of the TV precursor of the formula of FIG. 26, and 10% of the vinyl terminated precursor of the formula of FIG. 5 having a molecular weight of about 6000 are mixed together in a vessel and put in storage for later use. The polysilocarb batch has good shelf life and room temperature and the precursors have not, and do not react with each other. The polysilocarb batch has a viscosity of about 65 cps.

### Example 31

A polysilocarb batch having 0-90% of the MH precursor of the formula of FIG. 10 and a molecular weight of about 800, and 0-90% of the styrene precursor of the formula of FIG. 25 (having 10% X) and a molecular weight of about 1000, and 0-30% of the TV precursor of the formula of FIG. 26, and 0-30% of the vinyl terminated precursor of the formula of FIG. 14 having a molecular weight of about 9400 and 0-20% of the OH terminated precursor of the formula of FIG. 16, having a molecular weight of about 800 are mixed together in a vessel and put in storage for later use. The polysilocarb batch has good shelf life and room temperature and the precursors have not, and do not react with each other. The polysilocarb batch has a viscosity of about 100 cps.

### Example 32

A polysilocarb batch having 70% of the MH precursor of the formula of FIG. 10 and 30% of the vinyl terminated precursor of the formula of FIG. 14 having a molecular weight of about 500 and about 42% of a submicron and a 325 mesh silica are mixed together in a vessel and put in storage for later use. The polysilocarb batch has good shelf life and room temperature and the precursors have not, and do not react with each other. The polysilocarb batch has a viscosity of about 300 cps.

### Example 33

A polysilocarb batch having 20-80% of the MH precursor of the formula of FIG. 10 and a molecular weight of about 800, and 0-10% of the TV precursor of the formula of FIG. 26, and 5-80% of the vinyl terminated precursor of the formula of FIG. 14 having a molecular weight of about and about 500 of submicron, 325 mesh, and 8 micron SiC are mixed together in a vessel and put in storage for later use. The polysilocarb batch has good shelf life and room temperature and the precursors have not, and do not react with each other. The polysilocarb batch has a viscosity of about 300 cps.

### Example 34

A polysilocarb formulation using the mixing type method is formulated. The formulation is made by mixing together 30% of the MHF precursor of the formula of FIG. 10 and a molecular weight of about 800 and 70% of the TV precursor of the formula of FIG. 14 having a molecular weight of about 500 are mixed together in a vessel and put in storage for later use for making SiOC and SiC. The polysilocarb formulation has good shelf life and room temperature and the precursors have not, and do not react with each other. The polysilocarb formulation has a viscosity of about 10 cps.

### Example 35

A polysilocarb formulation using the mixing type method is formulated. The formulation is made by mixing together 10% of the MHF precursor of the formula of FIG. 10 and a molecular weight of about 800 and 73% of the styrene (phenylethyl) precursor of the formula of FIG. 25 (having 10% X) and a molecular weight of about 1,000, and 16% of the TV precursor of the formula of FIG. 26, and 1% of the OH terminated precursor of the formula of FIG. 16, having a molecular weight of about 1,000 are mixed together in a vessel and put in storage for later use in making SiOC and SiC. The polysilocarb formulation has good shelf life and room temperature and the precursors have not, and do not react with each other. The polysilocarb formulation has a viscosity of about 18 cps.

### Example 36

A polysilocarb formulation using the mixing type method is formulated. The formulation is made by mixing together 0-90% of the MH precursor of the formula of FIG. 10 and a molecular weight of about 800, and 0-90% of the styrene precursor of the formula of FIG. 25 (having 10% X) and a molecular weight of about 1000, and 0-30% of the TV precursor of the formula of FIG. 26, and 0-30% of the vinyl terminated precursor of the formula of FIG. 14 having a molecular weight of about 9400 and 0-20% of the OH terminated precursor of the formula of FIG. 16, having a molecular weight of about 800 are mixed together in a vessel and put in storage for later use in forming SiOC and SiC. The polysilocarb formulation has good shelf life and room temperature and the precursors have not, and do not react with each other. The polysilocarb formulation has a viscosity of about 100 cps.

### Example 37

A polysilocarb formulation using the mixing type method is formulated. The formulation is made by mixing together 20-80% of the MH precursor of the formula of FIG. 10 and a molecular weight of about 800, and 0-10% of the TV precursor of the formula of FIG. 25, and 5-80% of the vinyl terminated precursor of the formula of FIG. 14 having a molecular weight of about are mixed together in a vessel and put in storage for later use to make SiOC and SiC. The polysilocarb formulation has good shelf life and room temperature and the precursors have not, and do not react with each other. The polysilocarb formulation has a viscosity of about 300 cps.

### Example 38

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Methyltriethoxysilane | 120.00 | 19.5% | 178.30 | 0.67 | 47.43% | 0.67 | 2.02 |
| (FIG. 46) | | | | | | | |
| Phenylmethyldiethoxysilane | 0.00 | 0.0% | 210.35 | — | 0.00% | — | — |
| (FIG. 47) | | | | | | | |
| Dimethyldiethoxysilane | 70.00 | 11.4% | 148.28 | 0.47 | 33.27% | 0.47 | 0.94 |
| (FIG. 51) | | | | | | | |
| Methyldiethoxysilane | 20.00 | 3.3% | 134.25 | 0.15 | 10.50% | 0.15 | 0.30 |
| (FIG. 48) | | | | | | | |
| Vinylmethyldiethoxysilane | 20.00 | 3.3% | 160.29 | 0.12 | 8.79% | 0.12 | 0.25 |
| (FIG. 49) | | | | | | | |
| Trimethyethoxysilane | 0.00 | 0.0% | 118.25 | — | 0.00% | — | — |
| (FIG. 57) | | | | | | | |
| Hexane in hydrolyzer | 0.00 | 0.0% | 86.18 | — | | | |
| Acetone in hydrolyzer | 320.00 | 52.0% | 58.08 | 5.51 | | | |
| Ethanol in hydrolyzer | 0.00 | 0.0% | 46.07 | — | | | |
| Water in hydrolyzer | 64.00 | 10.4% | 18.00 | 3.56 | | | |
| HCl | 0.36 | 0.1% | 36.00 | 0.01 | | | |
| Sodium bicarbonate | 0.84 | 0.1% | 84.00 | 0.01 | | | |

### Example 39

Using the reaction type process a precursor formulation was made using the following formulation. The temperature of the reaction was maintained at 72° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 234.00 | 32.0% | 240.37 | 0.97 | 54.34% | 0.97 | 2.92 |
| (FIG. 54) | | | | | | | |
| Phenylmethyldiethoxysilane | 90.00 | 12.3% | 210.35 | 0.43 | 23.88% | 0.43 | 0.86 |
| (FIG. 47) | | | | | | | |
| Dimethyldiethoxysilane | 0.00 | 0.0% | 148.28 | — | 0.00% | — | — |
| (FIG. 51) | | | | | | | |
| Methyldiethoxysilane | 28.50 | 3.9% | 134.25 | 0.21 | 11.85% | 0.21 | 0.42 |
| (FIG. 48) | | | | | | | |
| Vinylmethyldiethoxysilane | 28.50 | 3.9% | 160.29 | 0.18 | 9.93% | 0.18 | 0.36 |
| (FIG. 49) | | | | | | | |
| Trimethyethoxysilane | 0.00 | 0.0% | 118.25 | — | 0.00% | — | — |
| (FIG. 57) | | | | | | | |
| Acetone in hydrolyzer | 0.00 | 0.0% | 58.08 | — | | | |
| Ethanol in hydrolyzer | 265.00 | 36.3% | 46.07 | 5.75 | | | |
| Water in hydrolyzer | 83.00 | 11.4% | 18.00 | 4.61 | | | |
| HCl | 0.36 | 0.0% | 36.00 | 0.01 | | | |
| Sodium bicarbonate | 0.84 | 0.1% | 84.00 | 0.01 | | | |

### Example 40

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 142.00 | 21.1% | 240.37 | 0.59 | 37.84% | 0.59 | 1.77 |
| (FIG. 54) | | | | | | | |
| Phenylmethyldiethoxysilane | 135.00 | 20.1% | 210.35 | 0.64 | 41.11% | 0.64 | 1.28 |
| (FIG. 47) | | | | | | | |
| Dimethyldiethoxysilane | 0.00 | 0.0% | 148.28 | — | 0.00% | — | — |
| (FIG. 51) | | | | | | | |
| Methyldiethoxysilane | 24.00 | 3.6% | 134.25 | 0.18 | 11.45% | 0.18 | 0.36 |
| (FIG. 48) | | | | | | | |
| Vinylmethyldiethoxysilane | 24.00 | 3.6% | 160.29 | 0.15 | 9.59% | 0.15 | 0.30 |
| (FIG. 49) | | | | | | | |
| Trimethyethoxysilane | 0.00 | 0.0% | 118.25 | — | 0.00% | — | — |
| (FIG. 57) | | | | | | | |
| Acetone in hydrolyzer | 278.00 | 41.3% | 58.08 | 4.79 | | | |
| Ethanol in hydrolyzer | 0.00 | 0.0% | 46.07 | — | | | |
| Water in hydrolyzer | 69.00 | 10.2% | 18.00 | 3.83 | | | |
| HCl | 0.36 | 0.1% | 36.00 | 0.01 | | | |
| Sodium bicarbonate | 0.84 | 0.1% | 84.00 | 0.01 | | | |

### Example 41

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 198.00 | 26.6% | 240.37 | 0.82 | 52.84% | 0.82 | 2.47 |
| (FIG. 54) | | | | | | | |
| Phenylmethyldiethoxysilane | 0.00 | 0.0% | 210.35 | — | 0.00% | — | — |
| (FIG. 47) | | | | | | | |
| Dimethyldiethoxysilane | 109.00 | 14.6% | 148.28 | 0.74 | 47.16% | 0.74 | 1.47 |
| (FIG. 51) | | | | | | | |
| Methyldiethoxysilane | 0.00 | 0.0% | 134.25 | — | 0.00% | — | — |
| (FIG. 48) | | | | | | | |
| Vinylmethyldiethoxysilane | 0.00 | 0.0% | 160.29 | — | 0.00% | — | — |
| (FIG. 49) | | | | | | | |
| Trimethyethoxysilane | 0.00 | 0.0% | 118.25 | — | 0.00% | — | — |
| (FIG. 57) | | | | | | | |
| Acetone in hydrolyzer | 365.00 | 49.0% | 58.08 | 6.28 | | | |
| Ethanol in hydrolyzer | 0.00 | 0.0% | 46.07 | — | | | |
| Water in hydrolyzer | 72.00 | 9.7% | 18.00 | 4.00 | | | |
| HCl | 0.36 | 0.0% | 36.00 | 0.01 | | | |
| Sodium bicarbonate | 0.84 | 0.1% | 84.00 | 0.01 | | | |

### Example 42

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 0.00 | 0.0% | 240.37 | — | 0.00% | — | — |
| (FIG. 54) | | | | | | | |
| Phenylmethyldiethoxysilane | 0.00 | 0.0% | 210.35 | — | 0.00% | — | — |
| (FIG. 47) | | | | | | | |
| Dimethyldiethoxysilane | 140.00 | 17.9% | 148.28 | 0.94 | 58.38% | 0.94 | 1.89 |
| (FIG. 51) | | | | | | | |
| Methyldiethoxysilane | 0.00 | 0.0% | 134.25 | — | 0.00% | — | — |
| (FIG. 48) | | | | | | | |
| Vinylmethyldiethoxysilane | 0.00 | 0.0% | 160.29 | — | 0.00% | — | — |
| (FIG. 49) | | | | | | | |
| TES 40 (FIG. 44) | 140.00 | 17.9% | 208.00 | 0.67 | 41.62% | 0.67 | 2.69 |
| Hexane in hydrolyzer | 0.00 | 0.0% | 86.18 | — | | | |
| Acetone in hydrolyzer | 420.00 | 53.6% | 58.08 | 7.23 | | | |
| Ethanol in hydrolyzer | 0.00 | 0.0% | 46.07 | — | | | |
| Water in hydrolyzer | 84.00 | 10.7% | 18.00 | 4.67 | | | |

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of formulations, batches, materials, compositions, devices, systems, apparatus, operations activities and methods set forth in this specification may be used in the various fields where membrane technology and separation systems find applicability, as well as, in other fields, where membranes and separations systems have hereto for been unable to perform in a viable manner (either cost, environment, performance or combinations of these). Additionally, these various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A hydrogen separation device, the device comprising:
a. a pressure vessel having a gas inlet and a gas outlet;
b. the pressure vessel defining a chamber, in fluid communication with the gas inlet and gas outlet; and,
c. the chamber containing a porous polymeric derived ceramic media.

2. The hydrogen separation device of claim 1 wherein, the porous polymeric derived ceramic media comprises a material resulting from the pyrolysis of a polymeric precursor comprising a backbone having the formula-R₁—Si—C—C—Si—O—Si—C—C—Si—R₂—, where R₁ and R₂ comprise materials selected from the group consisting of methyl, hydroxyl, vinyl and allyl.

3. The hydrogen separation device of claim 1 wherein, the porous polymeric derived ceramic media comprises a filler selected from the group consisting of metal powders, carbide pellets, nanostructures, silica fume, silica, fumed silica, fly ash, cenospheres, aluminum oxide (Al₂O₃), SiC, and polymer derived ceramics.

4. The hydrogen separation device of claim 2 wherein, the porous polymeric derived ceramic media comprises a filler selected from the group consisting of metal powders, carbide pellets, nanostructures, silica fume, silica, fumed silica, fly ash, cenospheres, aluminum oxide (Al₂O₃), SiC, and polymer derived ceramics.

5. The hydrogen separation device of claim 1 wherein, the porous polymeric derived ceramic media is made from a polysilocarb batch comprising a precursor selected from the group consisting of methyl hydrogen, siloxane backbone additive, vinyl substituted and vinyl terminated polydimethyl siloxane, vinyl substituted and hydrogen terminated polydimethyl siloxane, allyl terminated polydimethyl siloxane, silanol terminated polydimethyl siloxane, hydrogen terminated polydimethyl siloxane, vinyl terminated diphenyl dimethyl polysiloxane, hydroxyl terminated diphenyl dimethyl polysiloxane, hydride terminated diphenyl dimethyl polysiloxane, styrene vinyl benzene dimethyl polysiloxane, and tetramethyltetravinylcyclotetrasiloxane.

6. The hydrogen separation device of claim 1 wherein, the porous polymeric derived ceramic media is made from a condensation reaction of functionalized monomers.

7. The hydrogen separation device of claim 6, wherein the functionalized monomers are selected from the group consisting of triethoxy methyl, diethoxy methyl phenyl silane, diethoxy methyl hydride silane, diethoxy methyl vinyl silane, dimethyl ethoxy vinyl silane, diethoxy dimethyl silane, ethoxy dimethyl phenyl silane, diethoxy dihydride silane, triethoxy phenyl silane, diethoxy hydride trimethyl siloxane, diethoxy methyl trimethyl siloxane, trimethyl ethoxy silane, diphenyl diethoxy silane, and dimethyl ethoxy hydride siloxane.

8. The hydrogen separation device of claim 1 wherein, the porous polymer derived ceramic media is made from a precursor comprising a means for creating a porosity.

9. The hydrogen separation device of claim 2 wherein, the porous polymer derived ceramic media is made from a precursor comprising a means for creating a porosity.

10. The hydrogen separation device of claim 3 wherein, the porous polymer derived ceramic media is made from a precursor comprising a means for creating a porosity.

11. The hydrogen separation device of claim 4 wherein, the porous polymer derived ceramic media is made from a precursor comprising a means for creating a porosity.

12. The hydrogen separation device of claim 5 wherein, the porous polymer derived ceramic media is made from a precursor comprising a means for creating a porosity.

13. The hydrogen separation device of claim 6 wherein, the porous polymer derived ceramic media is made from a precursor comprising a means for creating a porosity.

14. The hydrogen separation device of claim 7 wherein, the porous polymer derived ceramic media is made from a precursor comprising a means for creating a porosity.

15. The hydrogen separation device of claim 8, 9 10 or 12 wherein, the means for creating a porosity comprises a precursor comprising a material having functional groups selected from the group consisting of methyl, vinyl, hydride, and OH substitution, whereby the functional group at least in part determines a porosity characteristic of the media.

16. The hydrogen separation device of claim 8, 9, 10 or 13 wherein, the means for creating a porosity comprises a gas generation means.

17. The hydrogen separation device of claim 8, 9, or 10 wherein, the means for creating a porosity comprises a gas generation means, whereby a gas selected from the group consisting water vapor, methane, and ethane is generated during a curing process.

18. The hydrogen separation device of claim 8, 9, or 10 wherein, the means for creating a porosity comprises a gas generation means, whereby a gas selected from the group consisting water vapor, methane, and ethane is generated during a pyrolysis process.

19. The hydrogen separation device of claim 8 wherein, the means for creating a porosity comprises a gas generation means, whereby a gas selected from the group consisting water vapor, methane, and ethane is generated during a curing and pyrolysis processes.

20. The hydrogen separation device of claim 8, 9 or 10 wherein, the means for creating a porosity comprises a gas generation means, whereby a vaporized organic is generated during a curing process.

21. The hydrogen separation device of claim 8 wherein, the means for creating a porosity comprises a gas generation means, whereby a vaporized organic is generated during a pyrolysis process.

22. The hydrogen separation device of claim 8 wherein, the means for creating a porosity comprises a gas generation means, whereby a vaporized organic is generated during a curing and pyrolysis processes.

23. The hydrogen separation device of claim 8 wherein, the means for creating a porosity comprises a material for the generation of a gas, whereby a vaporized organic selected from the group consisting of polyethylene, polypropylene, and acrylic is generated during a curing process.

24. The hydrogen separation device of claim 8 wherein, the means for creating a porosity comprises a material for the generation of a gas, whereby a vaporized organic selected from the group consisting of polyethylene, polypropylene, and acrylic is generated during a pyrolysis process.

25. The hydrogen separation device of claim 9 wherein, the means for creating a porosity comprises a material for the generation of a gas, whereby a vaporized organic selected from the group consisting of polyethylene, polypropylene, and acrylic is generated during a curing and pyrolysis processes.

26. The hydrogen separation device of claim 8 wherein, the means for creating a porosity comprises a high carbon content polymer, whereby regions of graphite are oxidized away to create small pores.

27. The hydrogen separation device of claim 26, wherein the regions are less than about 10 nanometers³

28. The hydrogen separation device of claim 26, wherein the regions are less than about 5 nanometers³

29. The hydrogen separation device of claim 26, wherein the regions are less than about 1 nanometers³

30. The hydrogen separation device of claim 26, 27 or 29 wherein the high carbon content polymer is made from a material having a substitutional group selected from the group consisting of phenyl groups, allyl groups, acetylene groups, ethynyl groups, and propargyl groups.

31. The hydrogen separation device of claim 26, 27 or 29 wherein the high carbon content polymer contains is made from a material selected from the group consisting of styrene, dicyclopentadiene, butatiene, chlorsilanes, ethoxy silanes and silicon containing reactive precursors.

32. A porous polymeric derived ceramic material comprising a ceramized polymer derived from a precursor, and having an open pour structure having a pour size of less than about 1 nanometer.

33. A porous polymeric derived ceramic material comprising a ceramized polymer derived from a precursor, and having an open pour structure having a pour size of less than about 0.5 nanometers.

34. A porous polymeric derived ceramic material comprising a ceramized polymer derived from a precursor, and having an open pour structure having a pour size of less than about 0.4 nanometers.

35. A porous polymeric derived ceramic material comprising a ceramized polymer derived from a precursor, and having an open pour structure having a pour size of less than about 0.3 nanometers.

36. A porous polymeric derived ceramic material comprising a ceramized polymer derived from a precursor, and having an open pour structure having a pour size of less than about 0.33 nanometers.

37. The porous polymeric derived ceramic materials of claim 32, 33, 34, 35 or 36 wherein the material is hydrogen selective.

38. The porous polymeric derived ceramic materials of claim 32, wherein the material is nitrogen selective.

39. The porous polymeric derived ceramic materials of claim 32, wherein the material is carbon dioxide selective.

40. A porous polymeric derived ceramic material comprising a ceramized polymer derived from a precursor, and having an open pour structure having a pour size of less than about 1 nanometer and the ceramized polymer comprises a material resulting from the pyrolysis of a polymeric precursor comprising a backbone having the formula-R₁—Si—C—C—Si—O—Si—C—C—Si—R₂—, where R₁ and R₂ comprise materials selected from the group consisting of methyl, hydroxyl, vinyl and allyl.

41. The porous polymeric derived ceramic material of claim 40, wherein the pour size of less than about 0.8 nanometer.

42. The porous polymeric derived ceramic material of claim 40, wherein the pour size is less than about 0.5 nanometers.

43. The porous polymeric derived ceramic material of claim 40, wherein the pour size is less than about 0.4 nanometers.

44. The porous polymeric derived ceramic material of claim 40, wherein the pour size is less than about 0.3 nanometers.

45. The porous polymeric derived ceramic material of claim 40, wherein the pour size is less than about 0.33 nanometers.

46. The porous polymeric derived ceramic material of claim 40, wherein material is hydrogen selective.

47. The porous polymeric derived ceramic material of claim 40, wherein material, is nitrogen selective.

48. The porous polymeric derived ceramic material of claim 40, wherein material is carbon dioxide selective.

49. The porous polymeric derived ceramic material of claim 40, comprising a means for creating porosity.

50. The porous polymeric derived ceramic material of claim 40, comprising a means for creating porosity, wherein the means is present before pyrolysis and absent after pyrolysis.

51. The porous polymeric derived ceramic material of claim 40, comprising a means for creating porosity, wherein the means is present before pyrolysis and after pyrolysis.

52. The porous polymeric derived ceramic material of claim 46, comprising a means for creating porosity.

53. The porous polymeric derived ceramic material of claim 52, wherein the precursor comprises the means for creating a porosity.

54. The porous polymeric derived ceramic material of claim 52, wherein the means for creating a porosity comprises a precursor comprising a material having functional groups selected from the group consisting of methyl, vinyl, hydride, and OH substitution, whereby the functional group at least in part determines a porosity characteristic of the media.

55. The porous polymeric derived ceramic material of claim 52, wherein the means for creating a porosity comprises a gas generation means.

56. The porous polymeric derived ceramic material of claim 52, wherein the means for creating a porosity comprises a gas generation means, whereby a gas selected from the group consisting water vapor, methane, and ethane is generated during the curing process.

57. The porous polymeric derived ceramic material of claim 52, wherein the means for creating a porosity comprises a gas generation means, whereby a gas selected from the group consisting water vapor, methane, and ethane is generated during the pyrolysis process.

58. The porous polymeric derived ceramic material of claim 52, wherein the means for creating a porosity comprises a gas generation means, whereby a gas selected from the group consisting water vapor, methane, and ethane is generated during the curing and pyrolysis processes.

59. The porous polymeric derived ceramic material of claim 52, wherein the means for creating a porosity comprises a gas generation means, whereby a vaporized organic is generated during the curing process.

60. The porous polymeric derived ceramic material of claim 52, wherein the means for creating a porosity comprises a gas generation means, whereby a vaporized organic is generated during the pyrolysis process.

61. The porous polymeric derived ceramic material of claim 52, wherein the means for creating a porosity comprises a gas generation means, whereby a vaporized organic is generated during the curing and pyrolysis processes.

62. The porous polymeric derived ceramic material of claim 52, wherein the means for creating a porosity comprises a material for the generation of a gas, whereby a vaporized organic selected from the group consisting of polyethylene, polypropylene, and acrylic is generated during the curing process.

63. The porous polymeric derived ceramic material of claim 52, wherein the means for creating a porosity comprises a material for the generation of a gas, whereby a vaporized organic selected from the group consisting of polyethylene, polypropylene, and acrylic is generated during the pyrolysis process.

64. The porous polymeric derived ceramic material of claim 52, wherein the means for creating a porosity comprises a material for the generation of a gas, whereby a vaporized organic selected from the group consisting of polyethylene, polypropylene, and acrylic is generated during the curing and pyrolysis processes.

65. The porous polymeric derived ceramic material of claim 52, wherein the means for creating a porosity comprises a high carbon content polymer, whereby regions of graphite are oxidized away to create small pores.

66. The porous polymeric derived ceramic material of claim 65, wherein wherein the regions are less than about 10 nanometers³

67. The porous polymeric derived ceramic material of claim 65, wherein the regions are less than about 5 nanometers³

68. The porous polymeric derived ceramic material of claim 65, wherein the regions are less than about 1 nanometers³

69. The porous polymeric derived ceramic material of claim 65, wherein the regions are less than about 0.5 nanometers³

70. The porous polymeric derived ceramic material of claim 65, wherein the regions are less than about 0.3 nanometers³

71. The porous polymeric derived ceramic material of claim 65, wherein the regions are less than about 0.2 nanometers³

72. The porous polymeric derived ceramic material of claim 65, wherein the high carbon content polymer is made from a material having a substitutional group selected from the group consisting of phenyl groups, allyl groups, acetylene groups, ethynyl groups, and propargyl groups.

73. The porous polymeric derived ceramic material of claim 65, wherein the high carbon content polymer contains is made from a material selected from the group consisting of styrene, dicyclopentadiene, butatiene, chlorsilanes, ethoxy silanes and silicon containing reactive precursors.

74. A porous polymeric derived ceramic material comprising a ceramized polymer derived from a precursor, and having an open pour structure having a pour size of less than about 0.5 nanometers and wherein the precursor is selected from the group consisting of methyl hydrogen, siloxane backbone additive, vinyl substituted and vinyl terminated polydimethyl siloxane, vinyl substituted and hydrogen terminated polydimethyl siloxane, allyl terminated polydimethyl siloxane, silanol terminated polydimethyl siloxane, hydrogen terminated polydimethyl siloxane, vinyl terminated diphenyl dimethyl polysiloxane, hydroxyl terminated diphenyl dimethyl polysiloxane, hydride terminated diphenyl dimethyl polysiloxane, styrene vinyl benzene dimethyl polysiloxane, and tetramethyltetravinylcyclotetrasiloxane.

75. A porous polymeric derived ceramic material comprising a ceramized polymer derived from a precursor, and having an open pour structure having a pour size of less than about 0.5 nanometers and the precursor comprising a material having the formula: 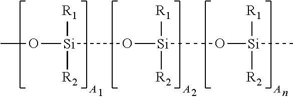
wherein A₁, is about 0% to about 100% of the total chain, wherein A₂ is about 0% to about 100% of the total chain, and wherein Aₙ is about 0% to about 100% of the total chain, and wherein n is an integer from 0 to 15, and wherein A₁, A₂ and Aₙ, and Aₙ₊₁ are different structures, and wherein R₁ and R₂ are selected from the group consisting of triethoxy methyl, diethoxy methyl phenyl silane, diethoxy methyl hydride silane, diethoxy methyl vinyl silane, dimethyl ethoxy vinyl silane, diethoxy dimethyl silane, ethoxy dimethyl phenyl silane, diethoxy dihydride silane, triethoxy phenyl silane, diethoxy hydride trimethyl siloxane, diethoxy methyl trimethyl siloxane, trimethyl ethoxy silane, diphenyl diethoxy silane, and dimethyl ethoxy hydride siloxane.

76. The porous polymeric derived ceramic material of claim 75, wherein the pour size of less than about 0.8 nanometer.

77. The porous polymeric derived ceramic material of claim 75, wherein the pour size is less than about 0.5 nanometers.

78. The porous polymeric derived ceramic material of claim 75, wherein the pour size is less than about 0.4 nanometers.

79. The porous polymeric derived ceramic material of claim 75, wherein the pour size is less than about 0.3 nanometers.

80. The porous polymeric derived ceramic material of claim 75, wherein the pour size is less than about 0.33 nanometers.

81. The porous polymeric derived ceramic material of claim 75, wherein material is hydrogen selective.

82. The porous polymeric derived ceramic material of claim 75, wherein material, is nitrogen selective.

83. The porous polymeric derived ceramic material of claim 75, wherein material is carbon dioxide selective.

84. The porous polymeric derived ceramic material of claim 75, comprising a means for creating porosity.

85. The porous polymeric derived ceramic material of claim 75, comprising a means for creating porosity, wherein the means is present before pyrolysis and absent after pyrolysis.

86. The porous polymeric derived ceramic material of claim 75, comprising a means for creating porosity, wherein the means is present before pyrolysis and after pyrolysis.

87. The porous polymeric derived ceramic material of claim 81, comprising a means for creating porosity.

88. The porous polymeric derived ceramic material of claim 87, wherein the precursor comprises the means for creating a porosity.

89. The porous polymeric derived ceramic material of claim 87, wherein the means for creating a porosity comprises a material having functional groups selected from the group consisting of methyl, vinyl, hydride, and OH substitution, whereby the functional group at least in part determines a porosity characteristic of the media.

90. The porous polymeric derived ceramic material of claim 87, wherein the means for creating a porosity comprises a gas generation means.

91. The porous polymeric derived ceramic material of claim 87, wherein the means for creating a porosity comprises a gas generation means, whereby a gas selected from the group consisting water vapor, methane, and ethane is generated during the curing process.

92. The porous polymeric derived ceramic material of claim 87, wherein the means for creating a porosity comprises a gas generation means, whereby a gas selected from the group consisting water vapor, methane, and ethane is generated during the pyrolysis process.

93. The porous polymeric derived ceramic material of claim 87, wherein the means for creating a porosity comprises a gas generation means, whereby a gas selected from the group consisting water vapor, methane, and ethane is generated during the curing and pyrolysis processes.

94. The porous polymeric derived ceramic material of claim 87, wherein the means for creating a porosity comprises a gas generation means, whereby a vaporized organic is generated during the curing process.

95. The porous polymeric derived ceramic material of claim 87, wherein the means for creating a porosity comprises a gas generation means, whereby a vaporized organic is generated during the pyrolysis process.

96. The porous polymeric derived ceramic material of claim 87, wherein the means for creating a porosity comprises a gas generation means, whereby a vaporized organic is generated during the curing and pyrolysis processes.

97. The porous polymeric derived ceramic material of claim 87, wherein the means for creating a porosity comprises a material for the generation of a gas, whereby a vaporized organic selected from the group consisting of polyethylene, polypropylene, and acrylic is generated during the curing process.

98. The porous polymeric derived ceramic material of claim 87, wherein the means for creating a porosity comprises a material for the generation of a gas, whereby a vaporized organic selected from the group consisting of polyethylene, polypropylene, and acrylic is generated during the pyrolysis process.

99. The porous polymeric derived ceramic material of claim 87, wherein the means for creating a porosity comprises a material for the generation of a gas, whereby a vaporized organic selected from the group consisting of polyethylene, polypropylene, and acrylic is generated during the curing and pyrolysis processes.

100. A method of separating a predetermined gas from a mixture of gases, the method comprising passing the mixture of gases at a temperature and at a pressure through a membrane selected from the group consisting of the materials of claim thirty two, claim forty, claim sixty five, claim seventy four, claim seventy five and claim seventy six.

101. The method of claim 100, wherein the temperature is at least about 500° C.

102. The method of claim 100, wherein the temperature is at least about 600° C.

103. The method of claim 100, wherein the temperature is at least about 700° C.

104. The method of claim 100, wherein the temperature is at least about 800° C.

105. The method of claim 100, wherein the pressure is at least about 500 psi.

106. The method of claim 100, wherein the pressure is at least about 600 psi.

107. The method of claim 100, wherein the pressure is at least about 800 psi.

108. The method of claim 100, wherein the pressure is at least about 1000 psi.

109. The method of claim 101, wherein the pressure is at least about 500 psi.

110. The method of claim 102, wherein the pressure is at least about 600 psi.

111. The method of claim 103, wherein the pressure is at least about 800 psi.

112. The method of claim 101, wherein the pressure is at least about 1000 psi.

113. The method of claim 100, wherein the flux is at least about 200 scft/ft² h.

114. The method of claim 101, wherein the flux is at least about 200 scft/ft² h.

115. The method of claim 102, wherein the flux is at least about 200 scft/ft² h.

116. The method of claim 103, wherein the flux is at least about 200 scft/ft² h.

117. The method of claim 104, wherein the flux is at least about 100 scft/ft² h.

118. The method of claim 105, wherein the flux is at least about 150 scft/ft² h.

119. The method of claim 106, wherein the flux is at least about 200 scft/ft² h.

120. The method of claim 109, wherein the flux is at least about 250 scft/ft² h.

121. The method of claim 109, wherein the flux is at least about 300 scft/ft² h.

122. The method of claim 109, wherein the flux is at least about 400 scft/ft² h.

123. The methods of claim 100, wherein the predetermined gas is hydrogen.

124. The methods of claim 100, wherein the predetermined gas is nitrogen.

125. The methods of claim 100, wherein the predetermined gas is carbon dioxide.

126. The methods of claim 100, wherein the mixture comprises steam.

127. A method of separating a hydrogen gas from a mixture of gases, the method comprising passing the mixture of gases at an inlet temperature and at an inlet pressure through a hydrogen separation device selected from the group consisting of the devices of claim one, claim two, claim three, claim five, claim fourteen, claim seventeen and claim twenty seven.

128. The method of claim 127 wherein the predetermined gas is hydrogen.

129. The method of claim 127 wherein the mixture comprises steam.

130. The method of claim 127, wherein the inlet temperature is at least about 500° C.

131. The method of claim 128, wherein the inlet temperature is at least about 600° C.

132. The method of claim 127, wherein the inlet temperature is at least about 700° C.

133. The method of claim 128, wherein the inlet temperature is at least about 800° C.

134. The method of claim 127, wherein the inlet pressure is at least about 500 psi.

135. The method of claim 128, wherein the inlet pressure is at least about 600 psi.

136. The method of claim 127, wherein the inlet pressure is at least about 800 psi.

137. The method of claim 127, wherein the inlet pressure is at least about 1000 psi.

138. The method of claim 128, wherein the pressure is at least about 500 psi.

139. The method of claim 127, wherein the pressure is at least about 600 psi.

140. The method of claim 127, wherein the flux is at least about 200 scft/ft² h.

141. The method of claim 128, wherein the flux is at least about 200 scft/ft² h.

142. The method of claim 133, wherein the flux is at least about 200 scft/ft² h.

143. The method of claim 135, wherein the flux is at least about 200 scft/ft² h.

144. The method of claim 136, wherein the flux is at least about 100 scft/ft² h.

145. The method of claim 127, wherein the flux is at least about 300 scft/ft² h.

146. The method of claim 128, wherein the flux is at least about 400 scft/ft² h.

147. A gas separation system comprising a membrane comprising a material selected from the group consisting of:
a. a porous polymeric derived ceramic material comprising a ceramized polymer derived from a precursor, and having an open pour structure having a pour size of less than about 1 nanometer;
b. a porous polymeric derived ceramic material comprising a ceramized polymer derived from a precursor, and having an open pour structure having a pour size of less than about 0.5 nanometers;
c. a porous polymeric derived ceramic material comprising a ceramized polymer derived from a precursor, and having an open pour structure having a pour size of less than about 0.4 nanometers;
d. a porous polymeric derived ceramic material comprising a ceramized polymer derived from a precursor, and having an open pour structure having a pour size of less than about 0.3 nanometers;
e. a porous polymeric derived ceramic material comprising a ceramized polymer derived from a precursor, and having an open pour structure having a pour size of less than about 0.33 nanometers;
f. a hydrogen selective porous polymeric derived ceramic material;
g. a nitrogen selective porous polymeric derived ceramic material;
h. a carbon dioxide selective porous polymeric derived ceramic material;
i. a porous polymeric derived ceramic material comprising a ceramized polymer derived from a precursor, and having an open pour structure having a pour size of less than about 1 nanometer and the ceramized polymer comprises a material resulting from the pyrolysis of a polymeric precursor comprising a backbone having the formula-R₁—Si—C—C—Si—O—Si—C—C—Si—R₂—, where R₁ and R₂ comprise materials selected from the group consisting of methyl, hydroxyl, vinyl and allyl;
j. a porous polymeric derived ceramic wherein the pour size is less than about 0.8 nanometer;
k. a porous polymeric derived ceramic, wherein the pour size is less than about 0.5 nanometers;
l. a porous polymeric derived ceramic material, wherein the pour size is less than about 0.4 nanometers;
m. a porous polymeric derived ceramic material, wherein the pour size is less than about 0.3 nanometers;
n. a porous polymeric derived ceramic material, wherein the pour size is less than about 0.33 nanometers;
o. a porous polymeric derived ceramic material comprising a means for creating porosity;
p. a porous polymeric derived ceramic material, comprising a means for creating porosity, wherein the means is present before pyrolysis and absent after pyrolysis;
q. a porous polymeric derived ceramic material, comprising a means for creating porosity, wherein the means is present before pyrolysis and after pyrolysis;
r. a porous polymeric derived ceramic material comprising a means for creating a porosity, wherein the means for creating a porosity comprises a precursor comprising a material having functional groups selected from the group consisting of methyl, vinyl, hydride, and OH substitution, whereby the functional group at least in part determines a porosity characteristic of the media;
s. a porous polymeric derived ceramic material comprising a means for creating a porosity, wherein the means for creating a porosity comprises a gas generation means;
t. a porous polymeric derived ceramic comprising a means for creating a porosity, wherein the means for creating a porosity comprises a material for the generation of a gas, whereby a vaporized organic selected from the group consisting of polyethylene, polypropylene, and acrylic is generated during the pyrolysis process;
u. a porous polymeric derived ceramic material comprising a means for creating a porosity, wherein the means for creating a porosity comprises a material for the generation of a gas, whereby a vaporized organic selected from the group consisting of polyethylene, polypropylene, and acrylic is generated during the curing and pyrolysis processes;
v. a porous polymeric derived ceramic material comprising a means for creating a porosity, wherein the means for creating a porosity comprises a high carbon content polymer, whereby regions of graphite are oxidized away to create small pores.
w. a porous polymeric derived ceramic material comprising a ceramized polymer derived from a precursor, and having an open pour structure having a pour size of less than about 0.5 nanometers and wherein the precursor is selected from the group consisting of methyl hydrogen, siloxane backbone additive, vinyl substituted and vinyl terminated polydimethyl siloxane, vinyl substituted and hydrogen terminated polydimethyl siloxane, allyl terminated polydimethyl siloxane, silanol terminated polydimethyl siloxane, hydrogen terminated polydimethyl siloxane, vinyl terminated diphenyl dimethyl polysiloxane, hydroxyl terminated diphenyl dimethyl polysiloxane, hydride terminated diphenyl dimethyl polysiloxane, styrene vinyl benzene dimethyl polysiloxane, and tetramethyltetravinylcyclotetrasiloxane; and,
x. a porous polymeric derived ceramic material comprising a ceramized polymer derived from a precursor, and having an open pour structure having a pour size of less than about 0.5 nanometers and the precursor comprising a material having the formula: 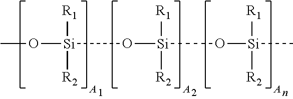
wherein A₁, is about 0% to about 100% of the total chain, wherein A₂ is about 0% to about 100% of the total chain, and wherein Aₙ is about 0% to about 100% of the total chain, and wherein n is an integer from 0 to 15, and wherein A₁, A₂ and Aₙ, and Aₙ₊₁ are different structures, and wherein R₁ and R₂ are selected from the group consisting of triethoxy methyl, diethoxy methyl phenyl silane, diethoxy methyl hydride silane, diethoxy methyl vinyl silane, dimethyl ethoxy vinyl silane, diethoxy dimethyl silane, ethoxy dimethyl phenyl silane, diethoxy dihydride silane, triethoxy phenyl silane, diethoxy hydride trimethyl siloxane, diethoxy methyl trimethyl siloxane, trimethyl ethoxy silane, diphenyl diethoxy silane, and dimethyl ethoxy hydride siloxane.
